(19) United States
(12) Patent Application Publication
(10) Pub. No.: US 2016/0147976 A1
(43) Pub. Date: May 26, 2016

(54) Medication Identification, Tracking And Adherence Management

(71) Applicant: RxAdvance Corporation, Southborough, MA (US)

(72) Inventors: Yogendra K. Jain, Wellesley, MA (US); Paul Ducey, Sudbury, MA (US); Ravi V. Ika, Southborough, MA (US); Anand M. Tati, Westborough, MA (US); Srinivas Venkata Naga Gopaladasu, Shrewsbury, MA (US); Prakash Surya Tallabattula, Northborough, MA (US)

(73) Assignee: RxAdvance Corporation

(21) Appl. No.: 14/800,689

(22) Filed: Jul. 15, 2015

Related U.S. Application Data
(63) Continuation-in-part of application No. 14/555,560, filed on Nov. 26, 2014.

(51) Int. Cl. G06F 19/00

(52) U.S. Cl. CPC G06F 19/3456; G06F 19/322

(57) ABSTRACT

A method and a wellness adherence tracking system (WATS) for tracking wellness adherence of a healthcare recipient are provided. An identifier code or an existing code is positioned on a medical implement, for example, a medication bin, a parenteral device, a fitness device, etc. The WATS accessible on a user device scans, decodes, and validates the identifier code, and obtains medical information associated with the medical implement and/or an activity, for example, an exercise activity, a diet activity, etc., associated with the medical implement from the decoded and validated identifier code. The WATS renders the medical information and multiple wellness adherence options on a graphical user interface and receives inputs for the wellness adherence options from the user device. The WATS logs the received inputs in association with the wellness adherence criteria in the user device and/or one or more databases to track the wellness adherence of the healthcare recipient.

### CROSS-REFERENCE TO RELATED APPLICATIONS

This application is a continuation-in-part application of non-provisional patent application Ser. No. 14/555,560 titled “Medication Organizer Tray Apparatus”, filed in the United States Patent and Trademark Office on Nov. 26, 2014. The specification of the above referenced patent application is incorporated herein by reference in its entirety.

### BACKGROUND

Poor compliance with a healthcare provider or physician-prescribed medication regimen is a significant cause of disease related morbidity and mortality. Poor medication adherence is estimated to cause about 125,000 deaths and about 33% to about 69% of medication related hospital admissions annually. The aggregate cost of hospital admissions related to medication non-adherence alone is estimated to be about $100 billion per year and medication non-adherence accounts for about 10% of overall hospital admissions. Currently, about 50% of prescribed medications are not taken as directed. Noncompliance with prescribed medications leads to a deterioration of the medical condition, hospitalization, and irreversible loss of function, resulting in significant human and financial costs. A growing problem, both among young people and the elderly, is overuse or abuse of certain medications, for example, pain relievers and tranquilizers. Among the elderly, about 90% of healthcare recipients make medication errors, resulting in about 40% of hospital admissions for this growing segment of the American population. Cognition also generally declines with age. Consequently, elderly healthcare recipients may experience difficulty in acquiring, organizing, and remembering to take their medications as prescribed.

Many healthcare recipients with chronic conditions, for example, elderly patients on multiple medications have difficulty adhering to prescribed therapies. Such healthcare recipients typically consume about 2 medications to about 20 medications per day. In general, when more medications have to be taken and the more times each day the healthcare recipient must use various therapies, the more likely is the probability of medication errors. Often, healthcare recipients have co-morbid conditions that interfere with their adherence to medication regimens. These conditions may include, for example, diabetes and associated complications such as blindness or a lack of mobility, various neurological conditions and dementia, arthritis and associated difficulties in manipulating devices, and other debilitating conditions. In addition to pills, healthcare recipients take other medications, for example, parenterals such as injections, inhalers, eye drops, etc., and adherence to these medications is also very low. At times, healthcare recipients do not have access to transportation or a caregiver to collect their medications. Moreover, many medications are sensitive to certain environmental conditions, for example, heat, humidity, light, or cold. Over exposure of medications to these environmental conditions can reduce the potency or efficacy of the medications.

The New England Healthcare Institute (NEHI) estimates that eliminating prescription non-adherence can save $290 billion annually by avoiding additional visits to a doctor, emergency room (ER) visits, hospital admissions, and additional medications. Studies have shown a total annual per capita savings of about $7,823 for congestive heart failure, about $3,908 for hypertension, about $3,757 for diabetes, and about $1,259 for dyslipidemia in adherent healthcare recipients. To improve adherence, healthcare recipients need easy access to all of their medications on a regular basis and not have to handle multiple pill bottles which expire at different times, and need to go to a pharmacy as few times as possible for their medications or refills. Various previously proposed devices for testing compliance of healthcare recipients with prescribed medication regimens are unsatisfactory in that they are relatively cumbersome, not accurate, and do not adequately cover extended time spans for which many prescribed dosing regimens must be maintained. Hence, there is a need for an improved device, for example, a pre-filled medication tray that accurately and conveniently packages individual doses of medication, in various forms such as a liquid form or a tablet form, which are more easily manageable in a safe and convenient manner, can be easily dispatched to healthcare recipients, and which measures the compliance of healthcare recipients with prescribed medication regimens.

Although a pre-filled medication tray ensures that the right medications are loaded and that a healthcare recipient has easy access to the medications, many healthcare recipients are still non-adherent. For example, when a healthcare recipient travels or is out for a day or is on vacation, the healthcare recipient may forget to carry his/her pre-filled medication trays. Moreover, a health plan, pharmacy benefit manager (PBM), or an at risk hospital system requires healthcare recipient adherent information on a dose by dose basis, and not only on a monthly basis. Furthermore, there is a potential for tampering with the pre-filled medication tray when the pre-filled medication tray contains high priced medications and opioids. High priced and/or abusable medications, for example, pain killers, opioids, etc., are typically securely packaged in the pre-filled medication tray to preclude tampering and removal of the high priced and/or abusable medications from the pre-filled medication tray. However, these medications can be removed from the pre-filled medication tray by creating an incision or a cut on front surfaces, rear surfaces, side surfaces, and/or undersides of containers in the pre-filled medication tray.

Furthermore, a healthcare recipient may remove bins containing one or more medications from the pre-filled medication tray, when the healthcare recipient travels, goes out for a day, or when the medications in the bins need to be refrigerated. When the healthcare recipient does not have the pre-filled medication tray, has medications placed in a refrigerator, or has medications, for example, injections, inhalers, patches, eye drops, etc., that do not fit in the pre-filled medication tray, there is a need to measure compliance of healthcare recipients with prescribed medication regimens in order to ensure that the healthcare recipient consumes the right medication at the right time and from the right bin if the medication is stored in a bin. Typically, based on a health plan's service level agreement between a healthcare recipient and a healthcare provider, the healthcare recipient and/or the healthcare provider may arrange for a phone call to be made to remind the healthcare recipient about consumption of a medication. However, having to place multiple phone calls at different intervals for different healthcare recipients is time consuming and difficult and cannot ensure compliance, if the healthcare recipients are unavailable to receive the phone calls. Furthermore, conventional methods for testing compliance of healthcare recipients with prescribed medication regimens are typically focused on consumption of the medications and fail to test compliance to auxiliary wellness activities comprising, for example, exercise, diet, health checkups, wound care, etc.

Conventionally, a healthcare recipient has multiple options to notify healthcare providers about adherence to prescribed medication regimens. For example, notifying the healthcare providers about a consumed medication by updating information regarding the consumed medication on a website, speaking to an interactive voice response (IVR) system via a telephonic call, calling and notifying the healthcare provider about the consumed medication, etc. However, these options require significant effort from the healthcare recipient and the healthcare providers to concur at a given time. Another option for notifying a healthcare provider regarding consumption of a medication is to send an adherence confirmation message to the healthcare provider via a video that the healthcare recipient records while consuming the medication. Moreover, medications such as pills or tablets configured with a small radio can transmit the adherence confirmation message to the healthcare provider when the healthcare recipient consumes the medication. However, the video logging solution is intrusive and configuring each medication with a radio is expensive. Some conventional methods provide parenteral devices, for example, inhalers with one dimensional (1D) codes such as barcodes that can be scanned for extracting information about parenteral devices, patient details, etc. However, the amount of information that a barcode can store is considerably less than the amount of information that can be stored in a quick response (QR) code, and is not used for securely and interactively tracking wellness adherence of a healthcare recipient.

Hence, there is a long felt but unresolved need for a secure, enhanced pre-filled medication organizer tray apparatus that increases adherence to medications with minimal cost and support by efficiently organizing the medications, providing medical information associated with the medications, providing enhanced access to the medications, continuously monitoring medication adherence by a healthcare recipient, and transmitting alerts to healthcare providers and the healthcare recipient for reducing hospitalizations, readmissions, emergency room (ER) visits, home health visits, nurse support, etc. Moreover, there is a need for a pre-filled medication organizer tray apparatus that can be easily dispatched to healthcare recipients, and that detects tampering, theft, diversion, or abuse of high priced medications and opioids. Furthermore, there is a need for a method and a wellness adherence tracking system that provide two-dimensional identifier codes that can store a substantial amount of information for tracking a healthcare recipient's wellness adherence to medication regimens that prescribe medication consumption and performance of auxiliary wellness activities. Furthermore, there is a need for a method and a wellness adherence tracking system that validates identifier codes and medical information contained in the identifier codes to provide security and privacy to a healthcare recipient.

### SUMMARY OF THE INVENTION

This summary is provided to introduce a selection of concepts in a simplified form that are further disclosed in the detailed description of the invention. This summary is not intended to identify key or essential inventive concepts of the claimed subject matter, nor is it intended for determining the scope of the claimed subject matter.

The medication organizer tray apparatus disclosed herein address the above stated need for increasing adherence to medications with minimal cost and support by efficiently organizing the medications, providing medical information associated with the medications, providing enhanced access to the medications, continuously monitoring medication adherence by a healthcare recipient, and transmitting alerts to healthcare providers and the healthcare recipient for reducing hospitalizations, readmissions, emergency room (ER) visits, home health visits, nurse support, etc. Furthermore the medication organizer tray apparatus disclosed herein detects tampering, theft, diversion, or abuse of high priced medications and opioids. Furthermore, the medication organizer tray apparatus disclosed herein can be easily dispatched to healthcare recipients. The medication organizer tray apparatus disclosed herein comprises a support frame, multiple medication bins, a bin cover layer, and a conductive circuit layer. The support frame comprises multiple apertures positioned at predefined intervals from each other. The medication bins are adapted for placement into the apertures of the support frame. The medication bins accommodate multiple medications. The medication bins are configured to be removed from the support frame. The bin cover layer is removably attached to an upper surface of the support frame. The bin cover layer comprises multiple customized bin labels removably configured therewithin. The customized bin labels comprise medical information printed thereon and are configured to seal openings of the medication bins. The conductive circuit layer comprises multiple conductive lines running along one or more of a lower surface of the bin cover layer, around each medication bin, and a lower surface of each medication bin. The conductive circuit layer electrically communicates with a receptacle base to enable detection of removal of each medication bin from the support frame and detection of tampering of the medication bins, by detecting a break in the conductive lines of the conductive circuit layer.

Also, disclosed herein are a method and a wellness adherence tracking system comprising a wellness adherence tracking application deployed on a healthcare recipient's user device for tracking wellness adherence of a healthcare recipient. The method and the wellness adherence tracking system disclosed herein increase adherence to different types of medications and adherence to activities such as exercise, wound care, etc. The method and the wellness adherence tracking system disclosed herein address the above stated need for providing two-dimensional identifier codes that can store a substantial amount of information for tracking the healthcare recipient's wellness adherence to medication regimens that prescribe medication consumption and performance of auxiliary wellness activities. The method and the wellness adherence tracking system disclosed herein also validate identifier codes and medical information contained in the identifier codes to provide security and privacy to the healthcare recipient. In the method disclosed herein, an identifier code, for example, a quick response (QR) code is positioned on a medical implement, for example, a medication bin configured to store one or more medications, a parenteral device, a fitness device, a medical identification card, a medical wellness plan, etc., to identify the medical implement. The wellness adherence tracking system scans the identifier code of the medical implement via a graphical user interface provided by the wellness adherence tracking system accessible on the healthcare recipient's user device. The wellness adherence tracking system comprises at least one processor configured to execute computer program instructions for tracking wellness adherence of the healthcare recipient. The wellness adherence tracking system decodes and validates the scanned identifier code and obtains medical information associated with the medical implement and/or an activity, for example, administration of medications, an exercise activity, etc., associated with the medical implement from the decoded and validated identifier code, and wellness adherence criteria.

The wellness adherence tracking system obtains the medical information by directly extracting the medical information from the decoded and validated identifier code. In an embodiment, the wellness adherence tracking system obtains the medical information by transmitting the decoded and validated identifier code to one or more databases via a network and retrieving the medical information and the wellness adherence criteria from the databases. In another embodiment, the wellness adherence tracking system receives the medical information and the wellness adherence criteria from the healthcare recipient's user device, for example, via the graphical user interface. The wellness adherence tracking system renders the medical information and multiple wellness adherence options, for example, indicators that define administration and non-administration of the medications, performance and non-performance of the activity, etc., that are configured, in an embodiment, in accordance with the wellness adherence criteria on the graphical user interface. The wellness adherence tracking system receives inputs for one or more of the rendered wellness adherence options from the user device. The wellness adherence tracking system logs the received inputs in association with the wellness adherence criteria in the user device and/or one or more databases to track the wellness adherence of the healthcare recipient.

In one or more embodiments, related systems comprise circuitry and/or programming for effecting the methods disclosed herein; the circuitry and/or programming can be any combination of hardware, software, and/or firmware configured to effect the methods disclosed herein depending upon the design choices of a system designer. Also, various structural elements may be employed depending on the design choices of the system designer.

### BRIEF DESCRIPTION OF THE DRAWINGS

The foregoing summary, as well as the following detailed description of the invention, is better understood when read in conjunction with the appended drawings. For the purpose of illustrating the invention, exemplary constructions of the invention are shown in the drawings. However, the invention is not limited to the specific methods, structures, and components disclosed herein. The description of a method step or a structure or a component referenced by a numeral in a drawing is applicable to the description of that method step or structure or component shown by that same numeral in any subsequent drawing herein.

FIG. 1A exemplarily illustrates a top plan view of a medication organizer tray apparatus for organizing medications.

FIG. 1B exemplarily illustrates a bottom view of the medication organizer tray apparatus for organizing medications.

FIG. 1C exemplarily illustrates a front elevation view of the medication organizer tray apparatus.

FIGS. 2A-2B exemplarily illustrate top plan views of different embodiments of the medication organizer tray apparatus for organizing medications.

FIG. 3 exemplarily illustrates different component layers of the medication organizer tray apparatus.

FIG. 4A exemplarily illustrates a top plan view of a support frame of the medication organizer tray apparatus.

FIG. 4B exemplarily illustrates a side elevation view of the support frame of the medication organizer tray apparatus, showing medication bins.

FIG. 5 exemplarily illustrates a top plan view of an embodiment of the support frame of the medication organizer tray apparatus.

FIG. 6 exemplarily illustrates a top plan view of an embodiment of the support frame of the medication organizer tray apparatus, showing medication bins of different shapes and sizes for accommodating medications of different types.

FIG. 7 exemplarily illustrates a coated layer of the medication organizer tray apparatus configured to be removably attached to an upper surface of the support frame.

FIG. 8 exemplarily illustrates a top perspective view of a medication bin of the medication organizer tray apparatus for accommodating medications.

FIG. 9 exemplarily illustrates a perspective view of a medication bin of the medication organizer tray apparatus removed from a support frame of the medication organizer tray apparatus.

FIG. 10 exemplarily illustrates a side perspective view of a medication bin of the medication organizer tray apparatus, showing a raised bump front edge.

FIGS. 11A-11B exemplarily illustrate different views of embodiments of a medication bin of the medication organizer tray apparatus, showing conductive sensor circuit lines.

FIG. 12 exemplarily illustrates a top plan view of an embodiment of a medication bin of the medication organizer tray apparatus.

FIG. 13 exemplarily illustrates a perspective view of an embodiment of the medication bin, showing conductive sensor circuit lines running along a front surface of the medication bin, a rear surface of the medication bin, a lower surface of the medication bin, and a lower surface of a lip of the medication bin.

FIGS. 14A-14D exemplarily illustrate top plan views of different embodiments of a bin cover layer of the medication organizer tray apparatus, showing customized bin labels removably configured within the bin cover layer.

FIGS. 15A-15B exemplarily illustrate different types of identifier codes configured to be printed on the bin cover layer of the medication organizer tray apparatus.

FIG. 16A exemplarily illustrates a conductive circuit layer of the medication organizer tray apparatus, showing conductive lines and conductive pads.

FIG. 16B exemplarily illustrates an embodiment of the conductive circuit layer of the medication organizer tray apparatus, showing conductive sensor circuit lines of different patterns.

FIG. 16C exemplarily illustrates communication between the conductive circuit layer of the medication organizer tray apparatus and detection circuitry of a receptacle base.

FIGS. 17A-17B exemplarily illustrate embodiments of an electronic identification component of the medication organizer tray apparatus.

FIG. 18A exemplarily illustrates an adhesive protective paper layer removably attached to a lower surface of the bin cover layer of the medication organizer tray apparatus.

FIG. 18B exemplarily illustrates removal of the adhesive protective paper layer from the lower surface of the bin cover layer to allow attachment of the lower surface of the bin cover layer to an upper surface of a support frame.

FIGS. 19A-19D exemplarily illustrate different configurations for organizing medications in the medication organizer tray apparatus.

FIGS. 20A-20B exemplarily illustrate different views of a cover jacket configured to cover and accommodate the medication organizer tray apparatus.

FIG. 20C exemplarily illustrates the medication organizer tray apparatus accommodated within the cover jacket.

FIGS. 21A-21B exemplarily illustrate different views showing the medication organizer tray apparatus inserted into a receptacle base.

FIG. 22 exemplarily illustrates a top plan view of an embodiment of a receptacle base accommodating the medication organizer tray apparatus.

FIG. 23 illustrates a method for organizing medications and collecting medication adherence information.

FIG. 24 exemplarily illustrates a side perspective view of a medication dispensing system for filling the medication organizer tray apparatus with medications.

FIG. 25 exemplarily illustrates communication between the medication organizer tray apparatus inserted in a receptacle base, a backend server, and a user device via a network.

FIG. 26 exemplarily illustrates a screenshot of an image of the medication organizer tray apparatus filled with medications, displayed on a graphical user interface provided by a pill station manager application on a user device.

FIG. 27 illustrates a method for tracking wellness adherence of a healthcare recipient.

FIG. 28 exemplarily illustrates a flowchart comprising the steps performed by a wellness adherence tracking system for dynamically analyzing medical information.

FIG. 29 exemplarily illustrates the wellness adherence tracking system for tracking wellness adherence of a healthcare recipient.

FIG. 30 exemplarily illustrates the hardware architecture of the wellness adherence tracking system for tracking wellness adherence of a healthcare recipient.

FIG. 31 exemplarily illustrates a tracker card with identifier codes and stickers containing multiple identifier codes that can be positioned on a medical implement for tracking wellness adherence of a healthcare recipient.

FIG. 32 exemplarily illustrates a tabular representation of data size allocation in an identifier code.

FIGS. 33A-33D exemplarily illustrate identifier codes positioned on different medical implements.

FIGS. 34A-34E exemplarily illustrate screenshots of a graphical user interface provided by a wellness adherence tracking application of the wellness adherence tracking system for tracking wellness adherence of a healthcare recipient.

### DETAILED DESCRIPTION OF THE INVENTION

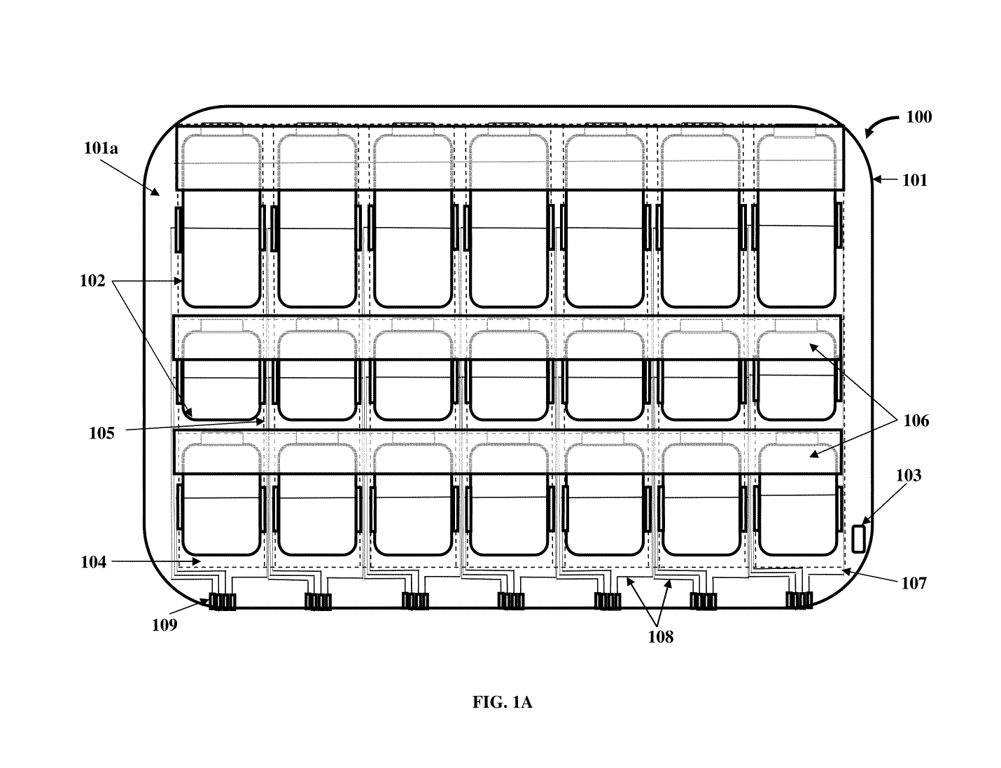

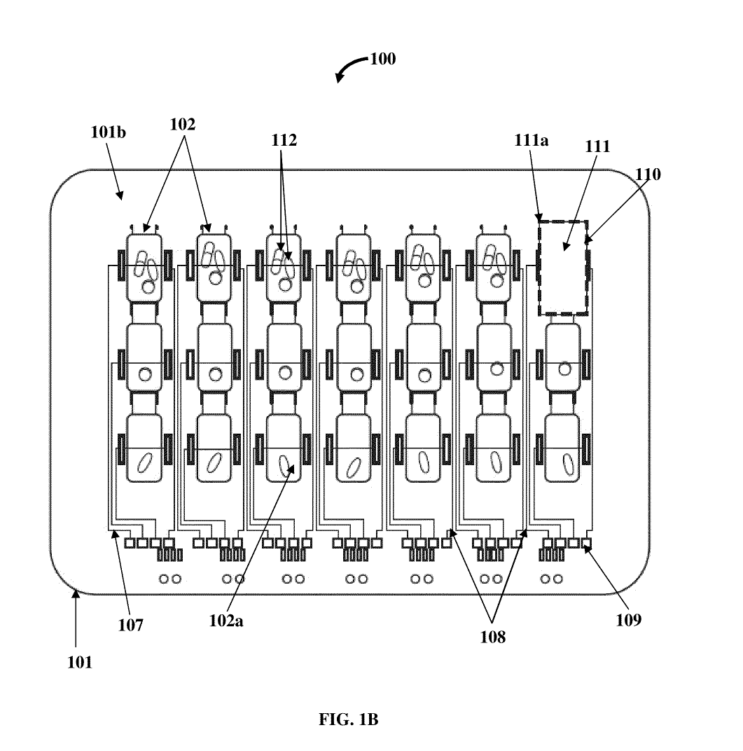

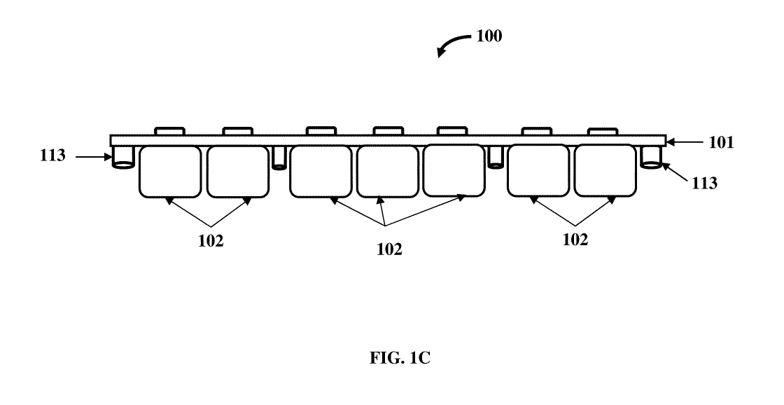

FIGS. 1A-1C exemplarily illustrate different views of a medication organizer tray apparatus 100 for organizing medications 112 exemplarily illustrated in FIG. 1B. The medication organizer tray apparatus 100 disclosed herein is a medication tray, for example, a thermoform based pill tray or a thermoform plastic tray with sensitive circuitry that electronically alerts healthcare providers on whether medication bins 102 containing medications 112 are opened correctly and at the right time. As used herein, “healthcare provider” refers to a person or an entity, for example, a medical practitioner, a medical specialist, a health specialist, a physician, a doctor, a dentist, a surgeon, a nurse, a therapist, a nutritionist, a pharmacist, a clinical trial professional, a clinical study professional, a healthcare institution such as a hospital, a clinic, etc., a health insurance company, a health maintenance organization, a caregiver, etc., that provides healthcare services, for example, medical treatment, dental treatment, medications 112, health insurance, etc., to a healthcare recipient. Also, as used herein, “healthcare recipient” refers to a person or an entity, for example, a patient who receives healthcare services from a healthcare provider.

The medication organizer tray apparatus 100 disclosed herein supports a polymer filling and facilitates intact shipping of the medication organizer tray apparatus 100, and handling of the medication organizer tray apparatus 100 by healthcare recipients, for example, elderly and sick patients. The medication organizer tray apparatus 100 disclosed herein can be used by healthcare recipients of all ages and can be shipped to healthcare recipients at any location, for example, a home location, an office location, assisted living facilities, nursing homes, etc. The medication organizer tray apparatus 100 provides accurate medications 112 based on prescriptions and provides guaranteed medications 112 to healthcare recipients with medication synchronization. The medication organizer tray apparatus 100 eliminates the need for a healthcare recipient such as a patient or a healthcare provider such as a caregiver to manually fill the medication organizer tray apparatus 100.

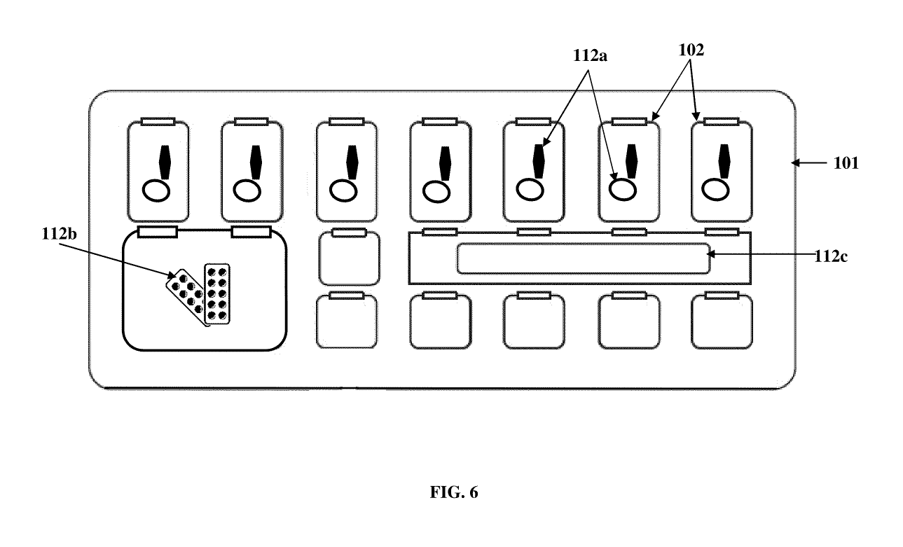

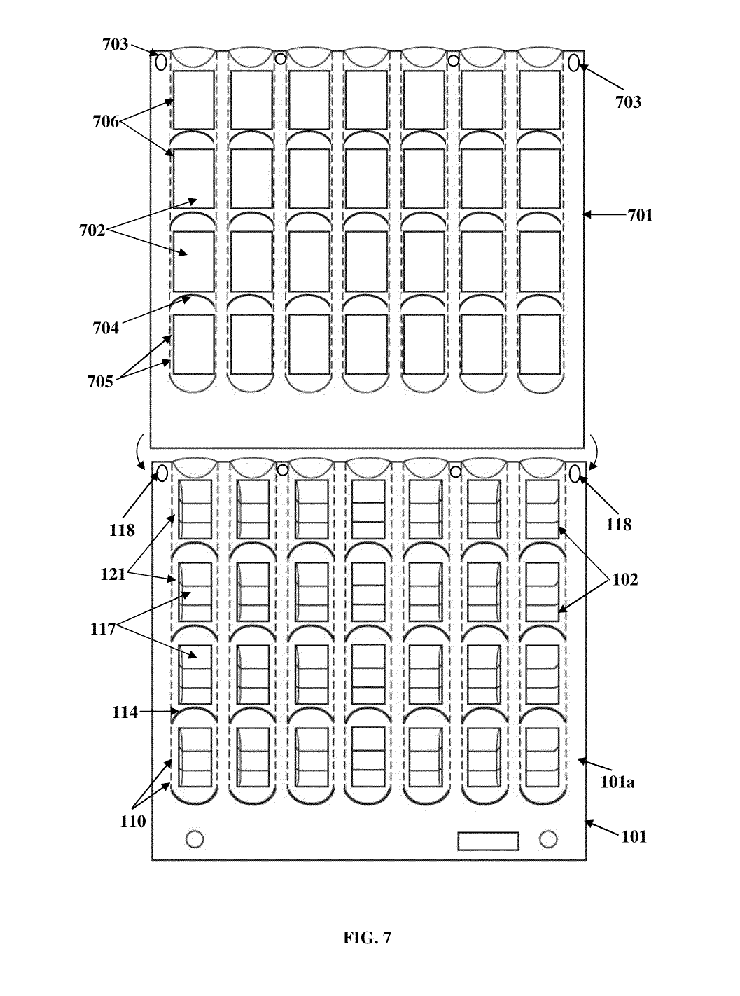

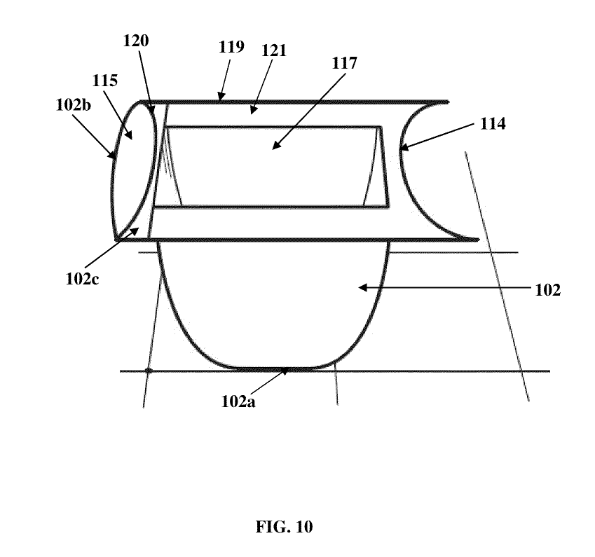

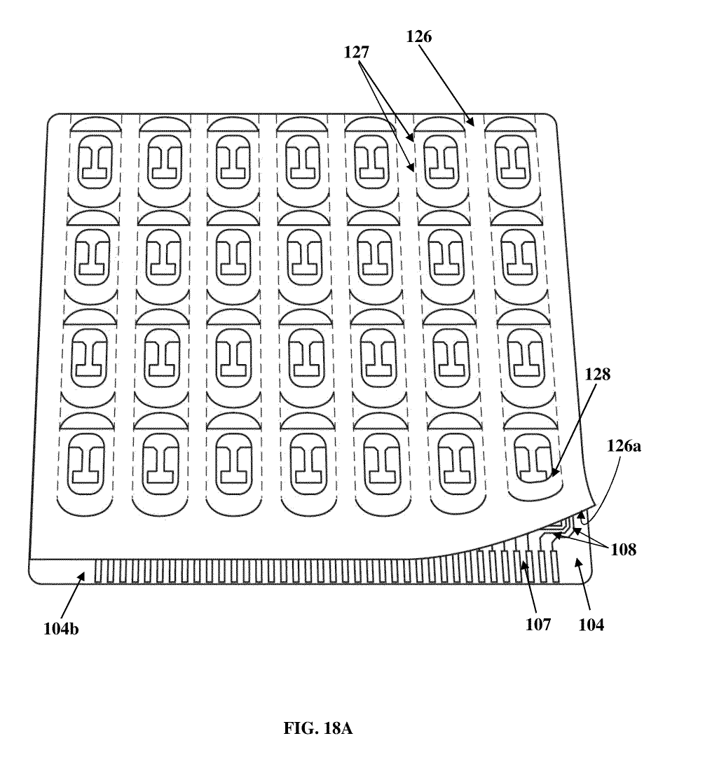

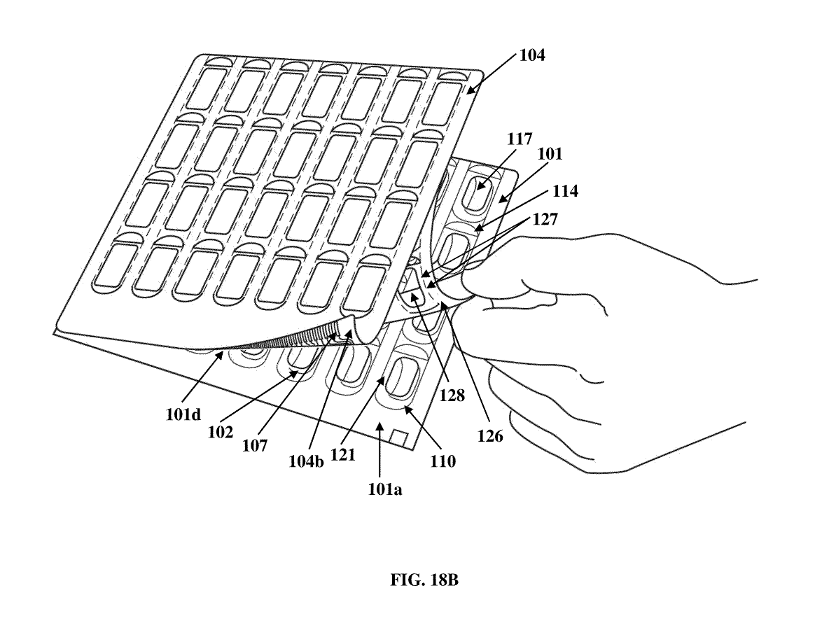

FIG. 1A exemplarily illustrates a top plan view of the medication organizer tray apparatus 100 for organizing medications 112. The medication organizer tray apparatus 100 disclosed herein comprises a support frame 101, multiple medication bins 102, a bin cover layer 104, and a conductive circuit layer 107. The support frame 101 comprises apertures 111 configured as wells positioned at predefined intervals from each other. FIG. 1B exemplarily illustrates an aperture 111 of the support frame 101 after removal of a medication bin 102 from the support frame 101. The medication bins 102 accommodate multiple medications 112 as exemplarily illustrated in FIG. 1B. The bin cover layer 104 is removably attached to an upper surface 101a of the support frame 101. The bin cover layer 104 comprises multiple customized bin labels 106 removably configured within the bin cover layer 104. The customized bin labels 106 are configured to seal openings 117 of the medication bins 102 exemplarily illustrated in FIG. 7 and FIG. 10. The bin cover layer 104 comprises perforations 105 positioned at predefined areas on the bin cover layer 104 as exemplarily illustrated in FIG. 1A, to match perforations 110 positioned proximal to outer edges 111a of the apertures 111 of the support frame 101 as exemplarily illustrated in FIG. 1B. In an embodiment, electrically conductive material, for example, conductive ink is applied on the perforations 105, 110, etc., of the medication organizer tray apparatus 100 exemplarily illustrated in FIGS. 1A-1B, for ensuring continuity around the perforations 105, 110, etc., and connectivity with conductive lines 108 of the conductive circuit layer 107 around the perforations 105, 110, etc. The conductive circuit layer 107 comprises multiple conductive lines 108 running along one or more of a lower surface 104b of the bin cover layer 104 as exemplarily illustrated in FIG. 18A, around each medication bin 102, and a lower surface 102a of each medication bin 102.

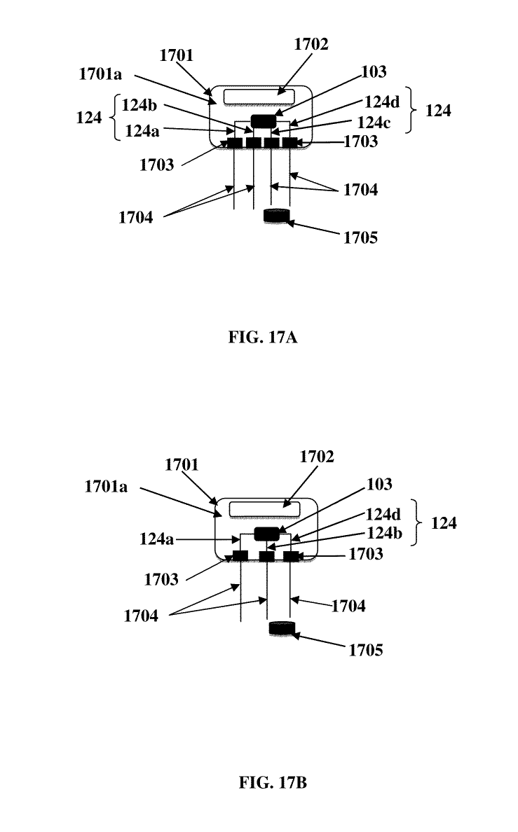

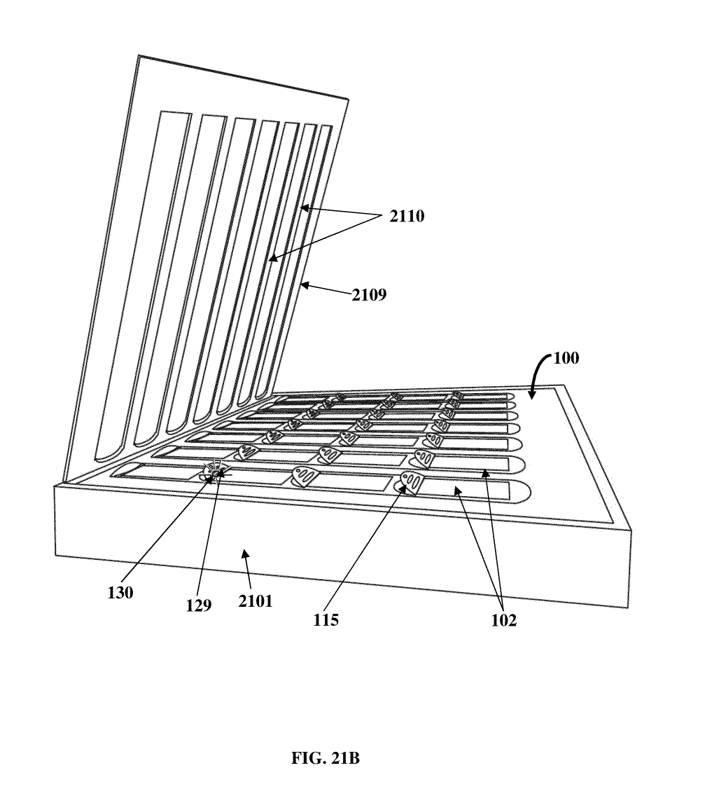

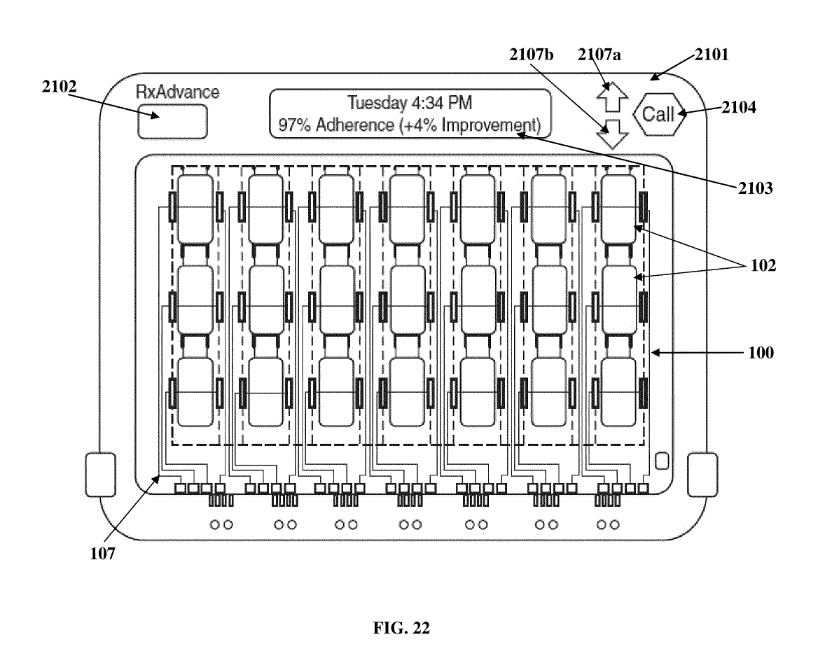

The medication organizer tray apparatus 100 disclosed herein further comprises an electronic identification component 103 embedded into the support frame 101 as exemplarily illustrated in FIG. 1A. The electronic identification component 103 is configured to electrically communicate with a receptacle base 2101 exemplarily illustrated in FIGS. 21A-21B and FIG. 22. The electronic identification component 103 is further configured to identify the medication organizer tray apparatus 100, and store and exchange medication adherence information with the receptacle base 2101 as disclosed in the detailed description of FIGS. 17A-17B.

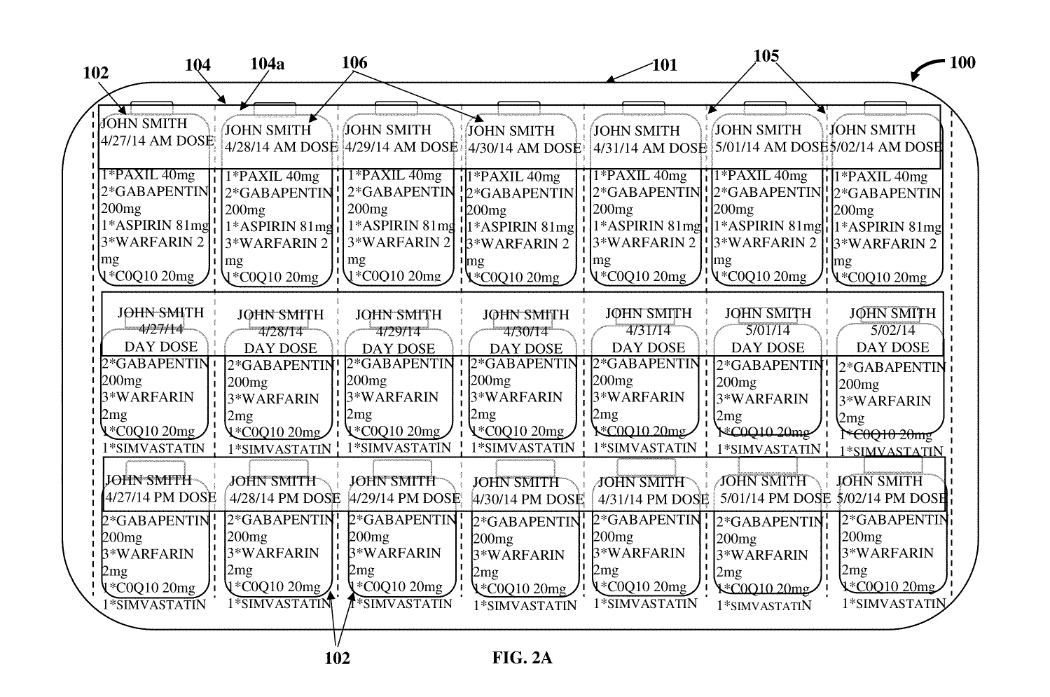

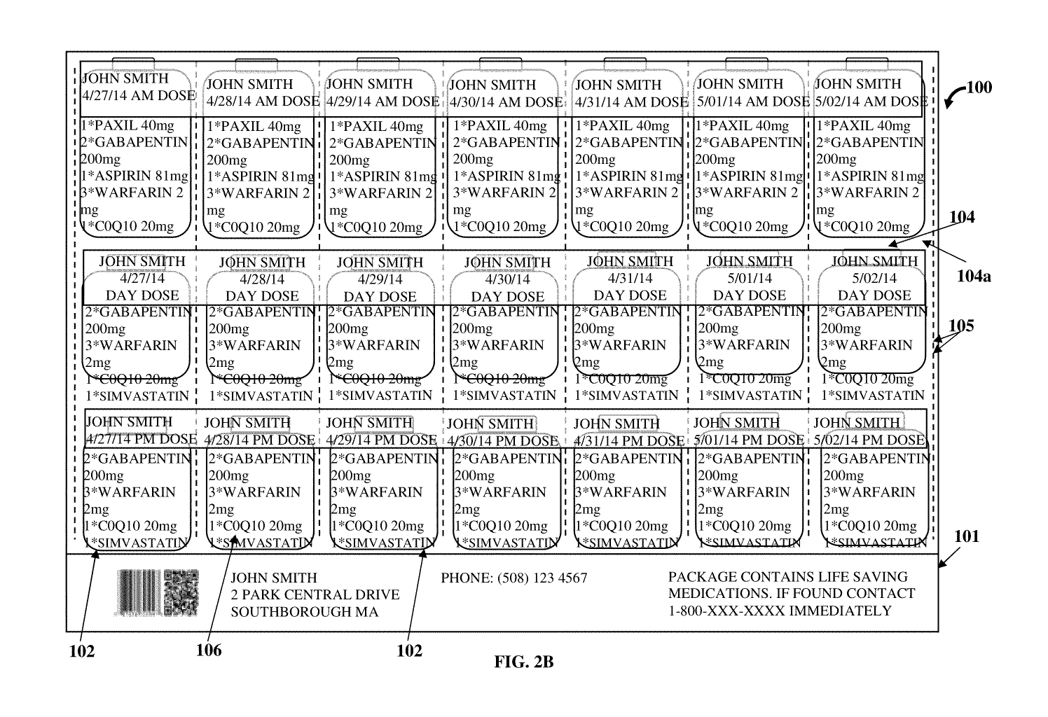

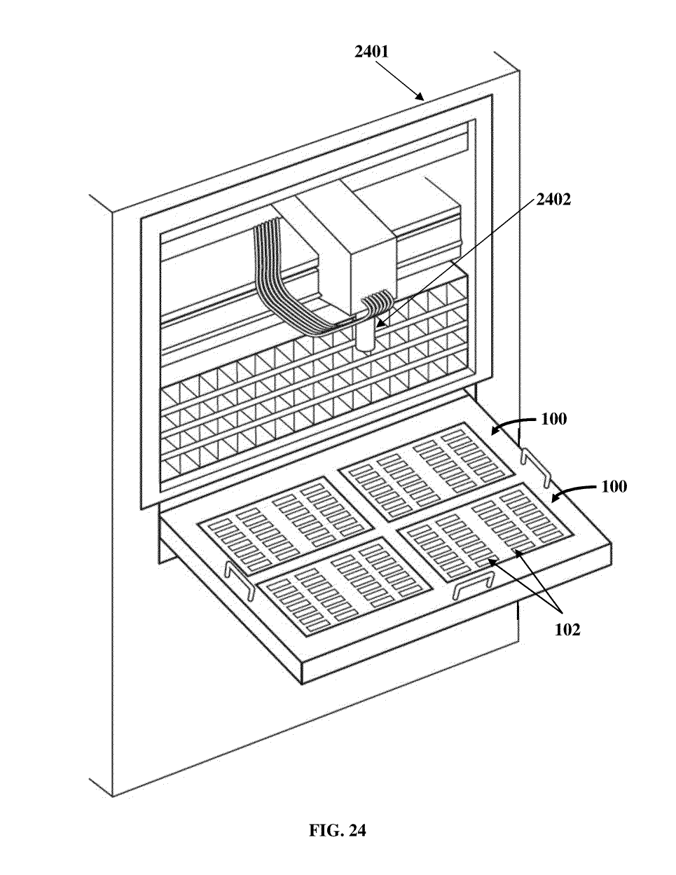

FIG. 1B exemplarily illustrates a bottom view of the medication organizer tray apparatus 100 for organizing medications 112. The medication bins 102 are adapted for placement in the apertures 111 of the support frame 101. The medication bins 102 are configured in one of multiple sizes and shapes as exemplarily illustrated in FIGS. 2A-2B, FIG. 6, and FIG. 14A, for accommodating medications 112 of different types. In an embodiment, each medication bin 102 is configured as a removable cup or a cup well containing medications 112, for example, sufficient for a day's use, and is easy to use. The medication bin 102 is, for example, made of plastic. The medications 112 comprise, for example, oral medications, parenterals, blister packed medications, individual doses of medications, pills, etc., or any combinations thereof. The parenterals comprise, for example, injections, insulin vials, syringes, inhalers, eye drops, etc. The blister packed medications have individual or multiple doses of medications 112 contained in a form of plastic packaging. In an embodiment, the medication bins 102 that accommodate oral medications 112 are of a standard size. As exemplarily illustrated in FIG. 1B, a lower surface 102a of each medication bin 102 is transparent to create a clear optical surface for facilitating imaging of the medications 112 accommodated in each medication bin 102 in the medication organizer tray apparatus 100, for example, by a camera embedded in the receptacle base 2101 exemplarily illustrated in FIGS. 21A-21B and FIG. 22, or in a medication dispensing system 2401 exemplarily illustrated in FIG. 24.

In an embodiment, the medication bins 102 are configured to be removed from the support frame 101. When the medication bins 102 are removed from the support frame 101, the medications 112 accommodated in the medication bins 102 are removed along with the medication bins 102. Healthcare recipients can remove the medication bins 102 from the support frame 101 and take medications 112 prescribed for a day from the medication bins 102. When the medication bins 102 are removed from the support frame 101, the customized bin labels 106 positioned on the medication bins 102 exemplarily illustrated in FIG. 1A, remain in contact with the medication bins 102 and are removed along with the medication bins 102 to maintain structural integrity of the medication organizer tray apparatus 100. In another embodiment, the medication bins 102 are retained in the support frame 101, and the customized bin labels 106 that seal the medication bins 102 can be removed to access the medications 112 in the medication bins 102.

Multiple conductive lines 108 and conductive pads 109 of the conductive circuit layer 107 of the medication organizer tray apparatus 100 are exemplarily illustrated in FIGS. 1A-1B. The conductive circuit layer 107 electrically communicates with the receptacle base 2101 to enable detection of removal of each medication bin 102 from the support frame 101 and detection of tampering of the medication bins 102. The conductive lines 108 of the conductive circuit layer 107 are configured in a multi-layer conductive circuit that trips when one or more medication bins 102 are removed from the support frame 101.

In an embodiment, the medication organizer tray apparatus 100 is free from the support frame 101, and is configured, for example, with a thermoform bottom. The medication organizer tray apparatus 100 is configured using existing prefilled medication trays, for example, with a thermoform design, plastic pill trays, or other types of medication trays of different shapes and sizes. In this embodiment, the bin cover layer 104 with the customized bin labels 106 and the conductive circuit layer 107 are built as a single unit and placed, pasted, and affixed onto the existing prefilled medication tray.

FIG. 1C exemplarily illustrates a front elevation view of the medication organizer tray apparatus 100. In an embodiment, the support frame 101 of the medication organizer tray apparatus 100 comprises one or more depressed button heads 113, for example, thermoform buttons based on the size of the medication organizer tray apparatus 100. The depressed button heads 113 attach the medication organizer tray apparatus 100 to the receptacle base 2101 exemplarily illustrated in FIGS. 21A-21B and FIG. 22.

FIGS. 2A-2B exemplarily illustrate top plan views of different embodiments of the medication organizer tray apparatus 100 for organizing medications 112 exemplarily illustrated in FIG. 1B. The medication organizer tray apparatus 100 comprises medication bins 102 of different sizes as exemplarily illustrated in FIGS. 2A-2B. As exemplarily illustrated in FIGS. 2A-2B, the first row of medication bins 102 is of a large size, while the second row of medication bins 102 and the third row of medication bins 102 are of a smaller size than the first row of medication bins 102. The customized bin labels 106 of the bin cover layer 104 are customized adhesive backed printouts comprising medical information printed thereon as exemplarily illustrated in FIGS. 2A-2B. The medical information printed on the customized bin labels 106 comprises, for example, one or more of a list of medications 112 in each medication bin 102, dosage information, color coding of dosage times, a time of day for administering the medications 112, drug names, directions to follow, name of a prescriber, date of preparation, description of contents of each medication bin 102, a personalized website link configured to link to a secure online interface comprising healthcare recipient information, a healthcare recipient identifier, etc. The medical information is printed on the customized bin labels 106 at a refill location and is configured to meet, for example, the United States Pharmacopeia (USP) standards. In an embodiment, the customized bin labels 106 comprise an updated medication list with images of the medications 112 inside each medication bin 102. FIGS. 2A-2B also show the perforations 105 of the bin cover layer 104.

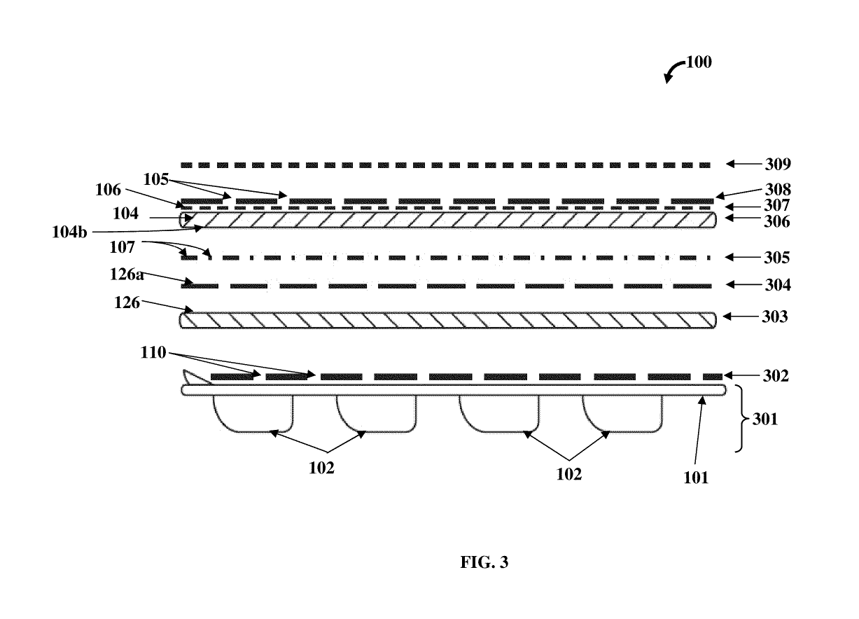

FIG. 3 exemplarily illustrates different component layers 301 to 309 of the medication organizer tray apparatus 100. In an embodiment as exemplarily illustrated in FIG. 3, the medication organizer tray apparatus 100 comprises nine component layers 301 to 309. The first component layer 301 comprises the support frame 101, for example, a thermoform tray with apertures 111 exemplarily illustrated in FIG. 1B, and medication bins 102 placed in the apertures 111 of the support frame 101. The medication bins 102 hold the medications 112 as exemplarily illustrated in FIG. 1B and as disclosed in the detailed description of FIG. 1B. The second component layer 302 is a perforated layer comprising perforations 110 of the support frame 101. The perforations 110 of the support frame 101 are positioned proximal to the outer edges 111a of the apertures 111 of the support frame 101 exemplarily illustrated in FIG. 1B, to facilitate removal of the medication bins 102 from the support frame 101. The third component layer 303 is an adhesive protective paper layer 126 exemplarily illustrated in FIGS. 18A-18B and disclosed in the detailed description of FIGS. 18A-18B. The fourth component layer 304 represents a selectively applied adhesive 126a of the adhesive protective paper layer 126 configured to match the surface 101d exemplarily illustrated in FIG. 18B, surrounding the outer edges 111a of the apertures 111 of the support frame 101 and a lip 121 of each medication bin 102 exemplarily illustrated in FIG. 10 and FIGS. 12-13. The fifth component layer 305 is the conductive circuit layer 107 comprising etched circuitry that electrically communicates with the receptacle base 2101 exemplarily illustrated in FIGS. 21A-21B and FIG. 22 and disclosed in the detailed description of FIGS. 21A-21B and FIG. 22, for enabling detection of a break in continuity of the conductive lines 108 exemplarily illustrated in FIGS. 1A-1B, when the medication bins 102 are removed from the support frame 101 of the medication organizer tray apparatus 100.

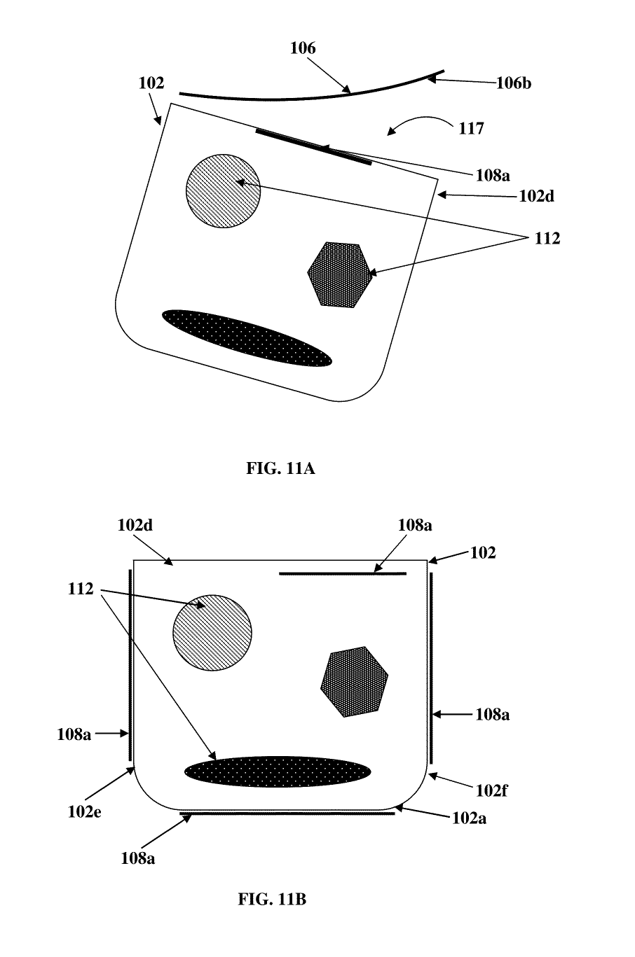

The sixth component layer 306 is the bin cover layer 104. The bin cover layer 104 is, for example, a paper layer or a cardboard stock layer of thick stock. In an embodiment, the bin cover layer 104 is composed of a coated paper that allows conductive ink or other conductive circuitry applications to be registered in fine line thickness thereon. In another embodiment, the sixth component layer 306 comprises additional information printed thereon for the healthcare recipients. In this embodiment, the additional information is viewable in and/or around the conductive circuit layer 107. When a healthcare recipient removes the medication bin 102 from the support frame 101 and then peels the customized bin label 106 of the bin cover layer 104 exemplarily illustrated in FIGS. 2A-2B, to access the medications 112, a bottom surface 106b of each customized bin label 106 exemplarily illustrated in FIG. 11A, displays the additional information printed thereon. This additional information comprises, for example, wellness information, reminders, incentives for medication adherence such as award points, lottery tickets, gaming information such as bingo numbers, quotes such as motivational and religious quotes or a quote of the day, pictures of family members, etc. In an embodiment, a bingo card or another game card can be supplied to a healthcare recipient, and as the healthcare recipient takes his/her medications 112 and fills the bingo card, he/she can win prizes. A healthcare recipient can read the additional information printed on the bottom surface 106b of the peeled customized bin label 106 when he or she removes and opens the medication bins 102. There is minimal to no bleeding of Food and Drug Administration (FDA) approved food grade ink printing on the lower surface 104b of the bin cover layer 104. The bin cover layer 104 allows etching of complex circuits on the lower surface 104b of the bin cover layer 104 without short circuiting issues.

The customized bin labels 106 exemplarily illustrated in FIG. 1A and FIGS. 2A-2B, on the upper surface 104a of the bin cover layer 104 constitute the seventh component layer 307. The seventh component layer 307 comprises generic information comprising, for example, color coded dosage times for days of the week, medication bins of the day, a company name, contact details, other contact information, etc., printed thereon. The eighth component layer 308 is a layer of perforations 105 on the bin cover layer 104 as exemplarily illustrated in FIG. 1A, which match the perforations 110 on the support frame 101 exemplarily illustrated in FIG. 1B. The ninth component layer 309 is a final layer comprising personalized printing for healthcare recipients provided on the upper surface 104a of the bin cover layer 104. The ninth component layer 309 represents the printing of healthcare recipient specific medication information and other healthcare recipient information printed on the customized bin labels 106. The printing of the customized bin labels 106 is performed at one or more of multiple refill stations. The medication organizer tray apparatus 100 is created by attaching the component layers 309, 308, 307, 306, 305, 304, and 303 in the arrangement order shown in FIG. 3 to the component layers 302 and 301 in the arrangement order shown in FIG. 3.

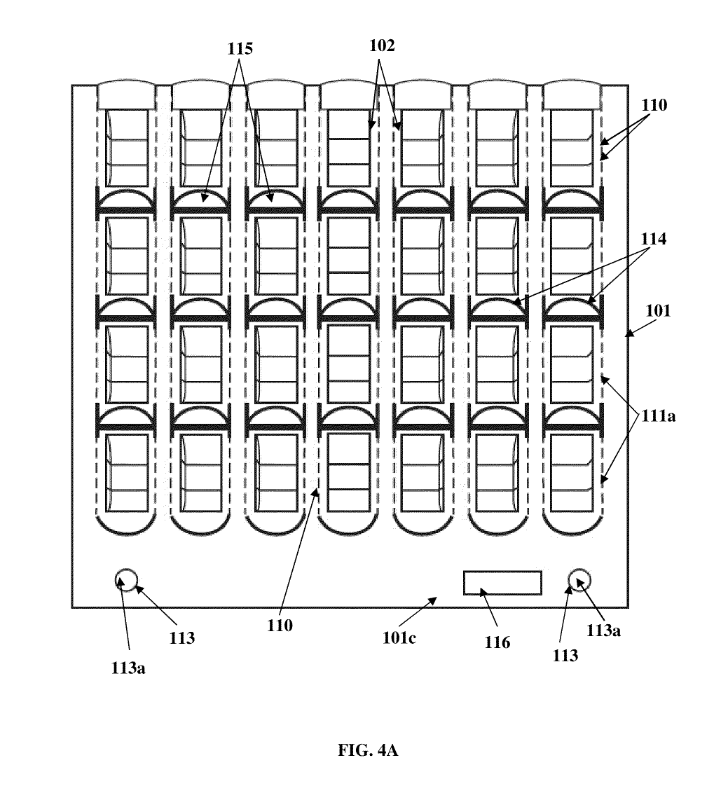

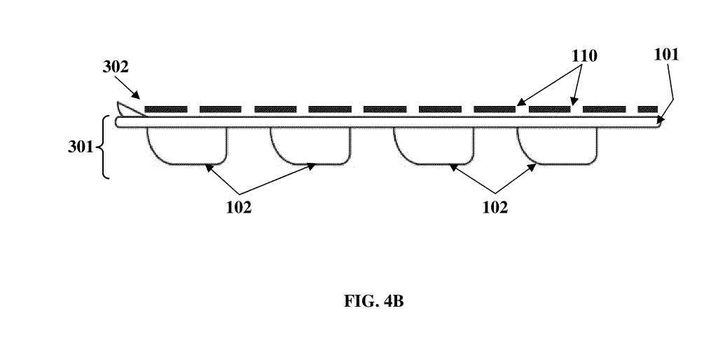

FIG. 4A exemplarily illustrates a top plan view of the support frame 101 of the medication organizer tray apparatus 100 exemplarily illustrated in FIGS. 1A-1C and FIGS. 2A-2B. The support frame 101 is configured as a support base for supporting the other component layers, for example, 303, 304, 305, 306, 307, 308, and 309 exemplarily illustrated in FIG. 3. The support frame 101 comprises multiple apertures 111 exemplarily illustrated in FIG. 1B, positioned at predefined intervals from each other. The apertures 111 of the support frame 101 are configured to house the medication bins 102. FIG. 4A also shows the perforations 110 positioned proximal to the outer edges 111a of the apertures 111 of the support frame 101. The perforations 110 on the support frame 101 are rigid and of a predefined shape to facilitate removal of the medication bins 102 from the support frame 101 without damaging the integrity of the support frame 101. The perforations 110 on the support frame 101 are configured in a shape that maintains the integrity of the medication organizer tray apparatus 100, when a majority of the medication bins 102 are removed from the support frame 101. The support frame 101 further comprises cut edges 114 for facilitating removal of the medication bins 102 from the apertures 111 of the support frame 101. Each cut edge 114 allows easy removal of a specific medication bin 102. In an embodiment, each of the medication bins 102 comprises a raised bump front edge 115 for facilitating easy removal of each of the medication bins 102 from the support frame 101. A healthcare recipient can remove a medication bin 102 from the support frame 101 by pulling the raised bump front edge 115 of the medication bin 102.

As exemplarily illustrated in FIG. 4A, the medication organizer tray apparatus 100 further comprises a receptacle 116 positioned, for example, proximal to a lower end 101c of the support frame 101 for accommodating an electronic identification component 103 exemplarily illustrated in FIGS. 17A-17B. In an embodiment, the electronic identification component 103 is placed face down in the receptacle 116 of the support frame 101 and embedded into the support frame 101. The support frame 101 further comprises one or more depressed button heads 113 exemplarily illustrated in FIG. 1C, for facilitating attachment and alignment of the medication organizer tray apparatus 100 to the receptacle base 2101 as exemplarily illustrated in FIGS. 21A-21B and FIG. 22. FIG. 4A exemplarily illustrates an upper portion 113a of each depressed button head 113. The medication organizer tray apparatus 100 is aligned with the receptacle base 2101 via the depressed button heads 113 of the support frame 101 to ensure that proper electrical contact is established between the medication organizer tray apparatus 100 and the receptacle base 2101.

FIG. 4B exemplarily illustrates a side elevation view of the support frame 101 of the medication organizer tray apparatus 100 exemplarily illustrated in FIGS. 1A-1C and FIGS. 2A-2B, showing medication bins 102. The support frame 101 exemplarily illustrated in FIG. 4B, is configured by combining the first component layer 301 and the second component layer 302 of the medication organizer tray apparatus 100 as disclosed in the detailed description of FIG. 3. The first component layer 301 of the medication organizer tray apparatus 100 comprises the support frame 101 with the medication bins 102 placed in the apertures 111 of the support frame 101 exemplarily illustrated in FIG. 1B, while the second component layer 302 comprises perforations 110 of the support frame 101 exemplarily illustrated in FIG. 3 and FIGS. 4A-4B. Each medication bin 102 is removed from the support frame 101 by pulling the medication bin 102 along with matching portions of the other component layers comprising 303, 304, 305, 306, 307, 308, and 309 exemplarily illustrated in FIG. 3, in a substantially upward direction with respect to the support frame 101 along the perforations 110 of the support frame 101 exemplarily illustrated in FIG. 4A. Each of the detached medication bins 102 is of a generally cup shaped configuration as exemplarily illustrated in FIGS. 9-13.

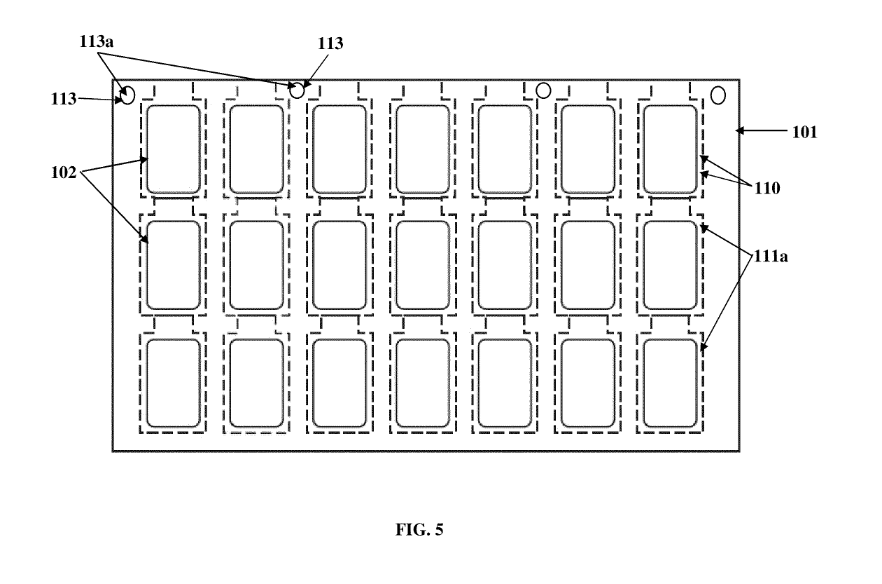

FIG. 5 exemplarily illustrates a top plan view of an embodiment of the support frame 101 of the medication organizer tray apparatus 100 exemplarily illustrated in FIGS. 1A-1C and FIGS. 2A-2B. FIG. 5 shows the support frame 101 housing the medication bins 102 in the apertures 111 exemplarily illustrated in FIG. 1B, the perforations 110 positioned proximal to the outer edges 111a of the apertures 111 of the support frame 101, and the upper portion 113a of each depressed button head 113 exemplarily illustrated in FIG. 1C. In this embodiment, the medication bins 102 are of the same size as exemplarily illustrated in FIG. 5.

FIG. 6 exemplarily illustrates a top plan view of an embodiment of the support frame 101 of the medication organizer tray apparatus 100 exemplarily illustrated in FIGS. 1A-1C and FIGS. 2A-2B, showing medication bins 102 of different shapes and sizes for accommodating medications, for example, 112a, 112b, and 112c of different types. In this embodiment, the support frame 101 houses medication bins 102 of different shapes. The medication bins 102 are shaped to accommodate medications, for example, pills 112a, blister packed medications 112b in the form of cards or as individual doses, parenterals 112c such as insulin vials, syringes, inhalers, small tubes or containers containing ointments, injection vials, etc. In an embodiment, the medication bins 102 are configured as vials. In another embodiment, the medication bins 102 are configured as thermoform cups.

FIG. 7 exemplarily illustrates a coated layer 701 of the medication organizer tray apparatus 100 exemplarily illustrated in FIGS. 1A-1C and FIGS. 2A-2B, configured to be removably attached to the upper surface 101a of the support frame 101. The medication bins 102 housed in the support frame 101 accommodate medications 112 exemplarily illustrated in FIG. 1B, comprising, for example, parenterals 112c exemplarily illustrated in FIG. 6, that have a significant weight. The weight of the medications 112 can be, for example, about 50 grams. The range of the weight of the medications 112 varies based on a type of a container used to contain the medications 112. In such situations, the support frame 101 requires additional support to maintain the integrity of the medication organizer tray apparatus 100. For accommodating medications 112 of substantially high weight, the medication organizer tray apparatus 100 is constructed, for example, in a sandwich board configuration that provides a stronger structure. For such a configuration of the medication organizer tray apparatus 100, the coated layer 701, for example, a cardboard cover is provided with openings 702 and lip sections 706 that mirror openings 117 of the medication bins 102 and the adjacent lips 121 of the medication bins 102 respectively. In an embodiment, the coated layer 701 made, for example, of paper is attached to the support frame 101 using an adhesive. In another embodiment, the coated layer 701 is attached to the support frame 101 using a clamp (not shown) on two sides of the support frame 101 to securely connect the coated layer 701 to the support frame 101 and strengthen the medication organizer tray apparatus 100. The coated layer 701 provides additional support to the support frame 101, for example, when the medications 112 to be accommodated in the medication bins 102 are heavy. The coated layer 701 comprises coated layer alignment holes 703 that mirror tray alignment holes 118 in the support frame 101 as exemplarily illustrated in FIG. 7. The coated layer 701 further comprises coated layer cut edges 704 and coated layer perforations 705 that mirror the cut edges 114 and the perforations 110 of the support frame 101 respectively, as exemplarily illustrated in FIG. 7.

In an embodiment, the coated layer 701 forms a flap or a panel that folds over the support frame 101 and offers additional surface area for various purposes. For example, the coated layer 701 is configured to display supplementary information printed thereon, for example, patient name, patient phone number, patient address, etc. The supplementary information further comprises, for example, coupons, advertisements, incentives for medication adherence such as reward points, lottery tickets, bingo numbers, bingo cards, etc., status of incentives such as status of reward points, appointments for a week, reminders, quotes, images, wellness information, wellness messages, gaming information, quick reference telephone numbers of healthcare providers such as caregivers, case workers, physicians, etc.

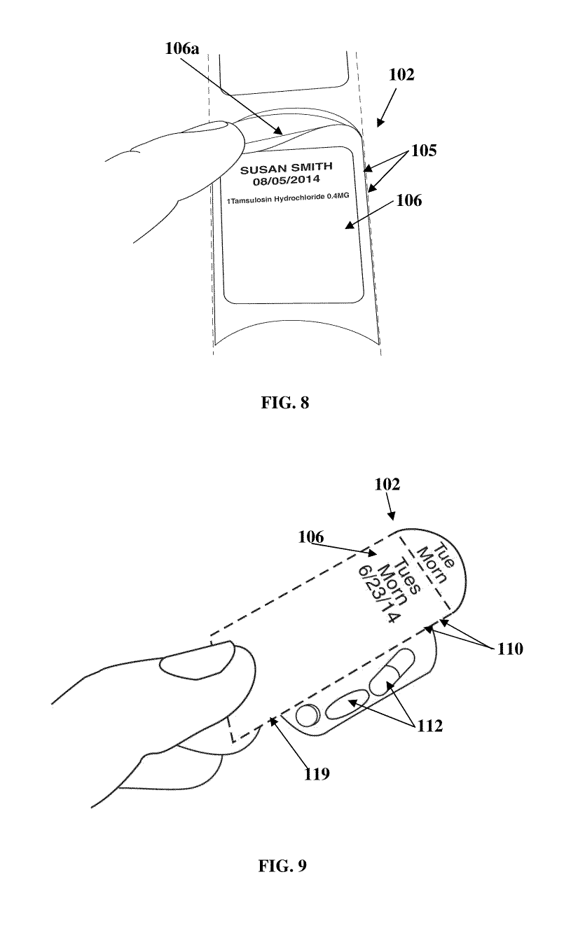

FIG. 8 exemplarily illustrates a top perspective view of a medication bin 102 of the medication organizer tray apparatus 100 exemplarily illustrated in FIGS. 1A-1C and FIGS. 2A-2B, for accommodating medications 112 exemplarily illustrated in FIG. 1B. As exemplarily illustrated in FIG. 8, the customized bin label 106 that seals the medication bin 102 can be removed by pulling a top edge 106a of the customized bin label 106 along the perforations 105 of the bin cover layer 104. The customized bin label 106 on the medication bin 102 is removed to access the medications 112 contained in the medication bin 102. The customized bin label 106 comprises, for example, a name of a patient, a date for consuming the medications 112 accommodated in the medication bin 102, name of each of the medications 112, etc., as exemplarily illustrated in FIG. 8.

FIG. 9 exemplarily illustrates a perspective view of a medication bin 102 of the medication organizer tray apparatus 100 exemplarily illustrated in FIGS. 1A-1C and FIGS. 2A-2B, removed from the support frame 101 exemplarily illustrated in FIGS. 1A-7. In an embodiment, when a medication bin 102 is removed from the medication organizer tray apparatus 100 by pulling the medication bin 102 away from the support frame 101 along the perforations 110 of the support frame 101 and the perforated rims 119 of the medication bin 102, the whole medication bin 102 peels off from the support frame 101, intact with the customized bin label 106.

FIG. 10 exemplarily illustrates a side perspective view of a medication bin 102 of the medication organizer tray apparatus 100 exemplarily illustrated in FIGS. 1A-1C and FIGS. 2A-2B, showing a raised bump front edge 115. In an embodiment, each medication bin 102 comprises a cut edge 114, a bend 120, and a raised bump front edge 115 as exemplarily illustrated in FIG. 10, for facilitating removal of the medication bin 102 from the support frame 101 exemplarily illustrated in FIG. 1B. Each medication bin 102 comprises specific cut edges 114 apart from the perforated rims 119 which allow easy removal of that medication bin 102. The raised bump front edge 115 of each medication bin 102 is a bump or a tab that can be lifted up for facilitating removal of the medication bin 102 from the support frame 101. The raised bump front edge 115 that can be folded at a bend 120 is positioned on a top edge 102b of the upper surface 102c of the medication bin 102 to allow removal of the medication bin 102 from the support frame 101. In an embodiment, the medication bin 102 is configured as a transparent bottle such that camera images can be taken of the lower surface 102a of the medication bin 102 post robotic or pharmacist fills of medications 112. The opening 117 of the medication bin 102 is sealed with the customized bin label 106 as exemplarily illustrated in FIGS. 8-9. There is no adhesive 126a behind the portion of the adhesive protective paper layer 126 exemplarily illustrated in FIG. 18A, that contacts the raised bump front edge 115 of the medication bin 102. Upon removal of the medication bin 102 from the support frame 101, the portion of the adhesive protective paper layer 126 on the raised bump front edge 115 of the medication bin 102 is easily accessible, as that portion is not glued. The raised bump front edge 115 of the medication bin 102 allows the medication bin 102 to be easily removed from the support frame 101 and reduces the need for a larger surface area to reduce the size and bulkiness of the medication organizer tray apparatus 100.

FIGS. 11A-11B exemplarily illustrate different views of embodiments of a medication bin 102 of the medication organizer tray apparatus 100 exemplarily illustrated in FIGS. 1A-1C and FIGS. 2A-2B, showing conductive sensor circuit lines 108a. FIG. 11A exemplarily illustrates a front elevation view of the medication bin 102, showing the customized bin label 106 removed from the medication bin 102. In an embodiment, the customized bin label 106 is, for example, a paper label, a plastic label, or a label made of some other material that is glued to the medication bin 102. As exemplarily illustrated in FIG. 11A, the customized bin label 106 seals the opening 117 of the medication bin 102. As exemplarily illustrated in FIG. 11A, the customized bin label 106 is peeled away to access the medications 112 contained in the medication bin 102. Furthermore, as exemplarily illustrated in FIG. 11A, a conductive sensor circuit line 108a is positioned on an upper section 102d of the medication bin 102. In an embodiment, the bottom surface 106b of each customized bin label 106 displays additional information, for example, wellness information, reminders, incentives for medication adherence such as award points, lottery tickets, gaming information, or bingo numbers, quotes such as motivational and religious quotes or a quote of the day, pictures of family members, etc.

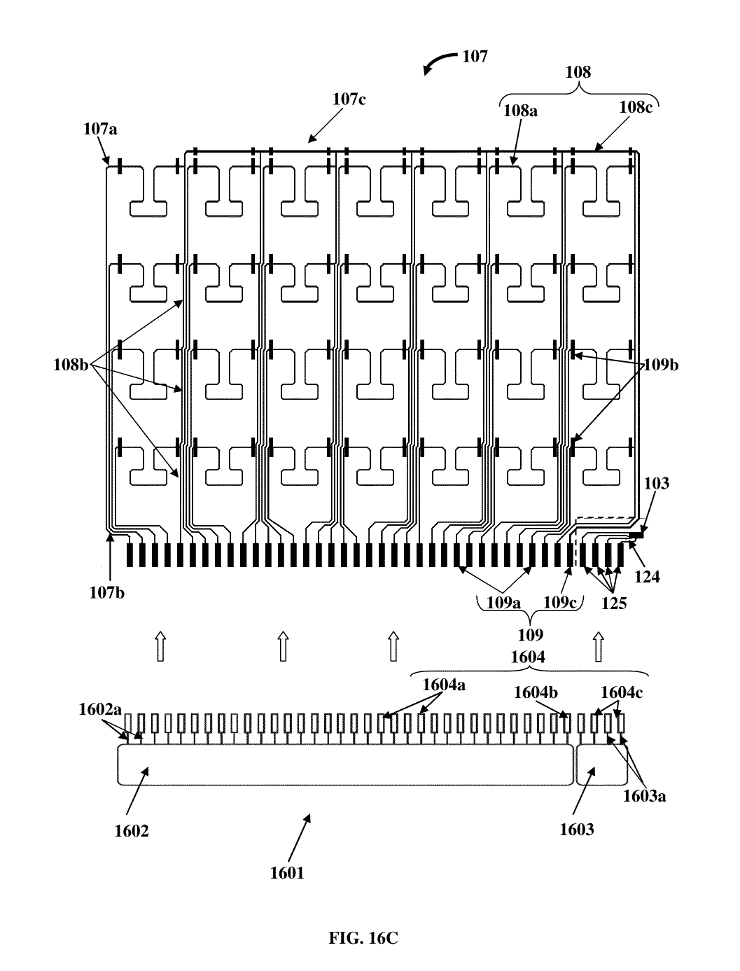

FIG. 11B exemplarily illustrates a front elevation view of the medication bin 102, showing conductive sensor circuit lines 108a running along the side surfaces 102e and 102f of the medication bin 102, on a lower surface 102a of the medication bin 102, and at the upper section 102d of the medication bin 102. To preclude tampering of high priced and/or abusable medications 112, for example, pain killers, opioids, etc., contained in the medication bin 102 by creation of incisions or cuts on the side surfaces 102e and 102f of the medication bin 102 and on the lower surface 102a of the medication bin 102, the medication organizer tray apparatus 100 exemplarily illustrated in FIGS. 1A-1C and FIGS. 2A-2B, provides additional security via detection circuitry on the medication bins 102, for example, by adding conductive sensor circuit lines 108a on an upper section 102d of each medication bin 102, the sides surfaces 102e and 102f of the medication bin 102, and on the lower surface 102a of the medication bin 102 as exemplarily illustrated in FIGS. 11A-11B, thereby making the overall surface of the medication bin 102 completely conductive. Any incision or a cut in any part of the medication bin 102 can be detected as a change in electrical properties of the medication bin 102 as measured by sensitive detection circuitry 1601 exemplarily illustrated in FIG. 16C, of the receptacle base 2101 exemplarily illustrated in FIGS. 21A-21B and FIG. 22, that is different from a change in electrical properties of the medication bin 102 detected while removing the medication bin 102 from the support frame 101 exemplarily illustrated in FIGS. 1A-7, during standard use of the medication organizer tray apparatus 100.

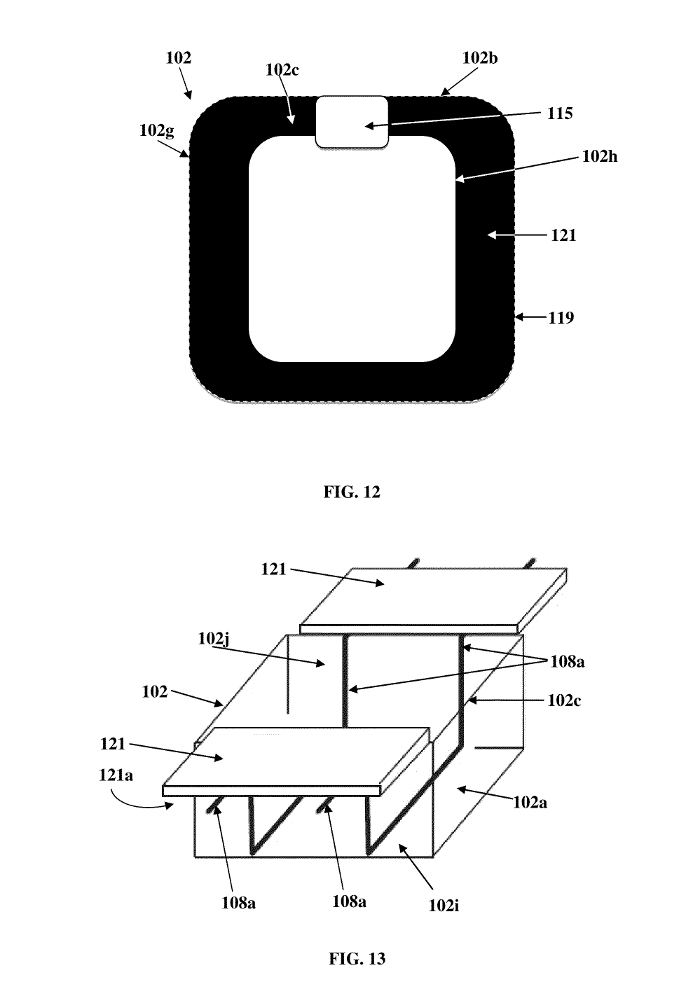

FIG. 12 exemplarily illustrates a top plan view of an embodiment of a medication bin 102 of the medication organizer tray apparatus 100 exemplarily illustrated in FIGS. 1A-1C and FIGS. 2A-2B. As exemplarily illustrated in FIG. 12, in an embodiment, the medication bin 102 comprises a raised bump front edge 115 on a top edge 102b of an upper surface 102c of the medication bin 102 for facilitating easy removal of the medication bin 102 from the support frame 101 exemplarily illustrated in FIGS. 1A-7. In an embodiment, the raised bump front edge 115 is configured as a bump on the top edge 102b of the upper surface 102c of the medication bin 102, when the medication bin 102 is configured, for example, as a plastic cup for facilitating peeling off the customized bin label 106 exemplarily illustrated in FIGS. 8-9, from the medication bin 102. In an embodiment, the raised bump front edge 115 is a configured as a slot. Each medication bin 102 comprises perforated rims 119 at upper edges 102g of the medication bin 102. The perforated rims 119 attach the medication bin 102 to perforations 110 positioned proximal to the outer edges 111a of each aperture 111 of the support frame 101 as exemplarily illustrated in FIG. 1B. The perforated rims 119 of each medication bin 102 facilitate removal of each individual medication bin 102 or a set of medication bins 102 for the day, or for multiple days from the support frame 101. Each medication bin 102 is, for example, cup shaped and comprises a lip 121 extending around a periphery 102h of the upper surface 102c of the medication bin 102. The lip 121 of the medication bin 102 facilitates enhanced access to the medication bin 102 and allows easy handling or carrying of the medication bin 102 by healthcare recipients diagnosed with certain medical conditions, for example, arthritis, nerve disorders that cause tremors, etc.

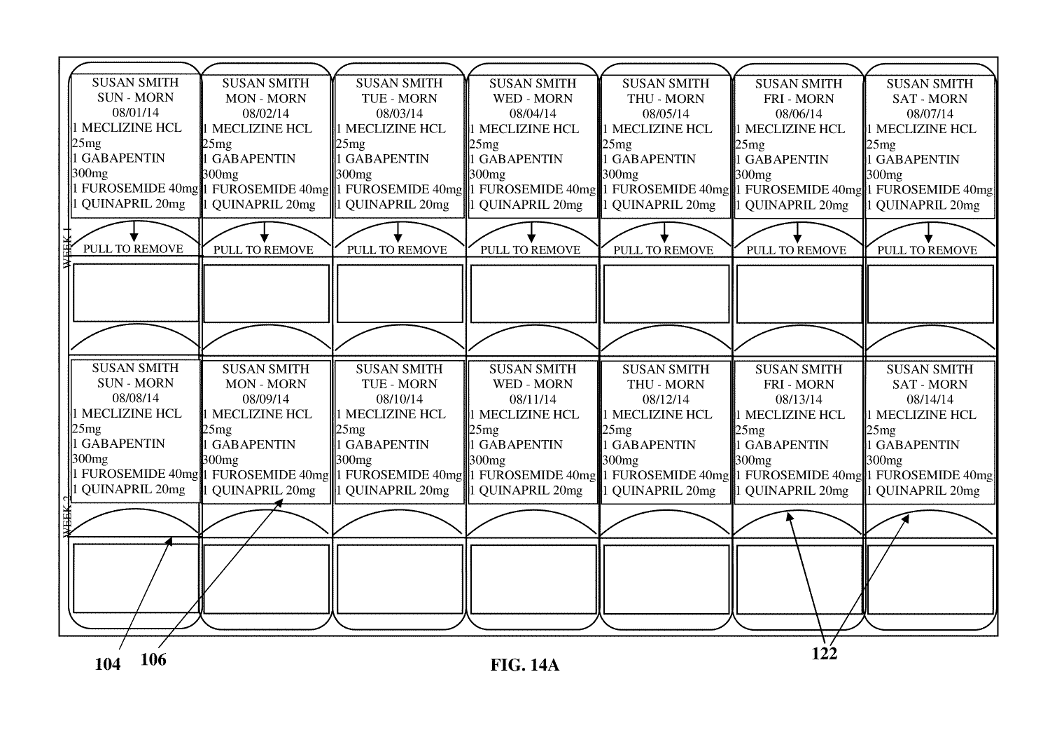

FIG. 13 exemplarily illustrates a perspective view of an embodiment of the medication bin 102, showing conductive sensor circuit lines 108a running along a front surface 102i of the medication bin 102, a rear surface 102j of the medication bin 102, a lower surface 102a of the medication bin 102, and a lower surface 121a of a lip 121 of the medication bin 102. The circuit mechanism of the conductive circuit layer 107 disclosed in the detailed description of FIGS. 16A-16C, is activated, when a healthcare recipient removes the medication bins 102 from the medication organizer tray apparatus 100 exemplarily illustrated in FIGS. 1A-1C and FIGS. 2A-2B. The conductive sensor circuit lines 108a of the conductive circuit layer 107 exemplarily illustrated in FIGS. 1A-1B and FIGS. 16A-16C, are ruptured when the medication bins 102 are removed, which are sensed by the detection circuitry 1601 exemplarily illustrated in FIG. 16C, of the receptacle base 2101 exemplarily illustrated in FIGS. 21A-21B and FIG. 22.

In an embodiment, multiple conductive sensor circuit lines 108a are applied or printed around each medication bin 102 and on the lower surface 102a of each medication bin 102 as exemplarily illustrated in FIG. 13, for example, via conductive ink printing such that any incision or a cut in the medication bin 102 can be detected by a break in the conductive sensor circuit lines 108a. In an embodiment, the layering of the conductive circuit layer 107 around the medication bin 102 is created via conductive pad printing around the medication bin 102. Multiple layers of conductive sensor circuit lines 108a are created to allow one or more of the conductive sensor circuit lines 108a to cross over another one or more of the conductive sensor circuit lines 108a without short circuiting the conductive circuit layer 107. The conductive ink is selectively printed on each medication bin 102 such that the conductive circuit layer 107 on the lower surface 104b of the bin cover layer 104 exemplarily illustrated in FIG. 18A, when placed on top of the medication bins 102, makes an appropriate electrical connection with the medication bins 102 for enabling detection of any incision or any cut in the medication bins 102. For example, conductive ink is printed on the upper surface 102c of the medication bin 102, on the front surface 102i of the medication bin 102, on the rear surface 102j of the medication bin 102, and on the lower surface 102a of the medication bin 102 such that the conductive circuit layer 107 configured, for example, as a conductive paper cover can be placed on top of the medication bin 102, to allow detection of any incision or any cut in the medication bin 102. In an embodiment, conductive ink is also printed on the lower surface 121a of each lip 121 of the medication bin 102 as exemplarily illustrated in FIG. 13. When the bin cover layer 104 is placed on such a medication bin 102, the conductive lines 108 on the lower surface 104b of the bin cover layer 104 exemplarily illustrated in FIG. 18A, connect to the conductive sensor circuit lines 108a on the lips 121 of the medication bin 102 to make the circuit connection, so that removal of the medication bin 102 can be detected on breakage of the circuit connection.

In an embodiment, the medication bins 102 are made of an electrically conductive material for communicating with the receptacle base 2101 for enabling detection of removal of each medication bin 102 from the support frame 101 exemplarily illustrated in FIGS. 1A-7, and detection of tampering of the medication bins 102. The medication bins 102 are configured, for example, as thermoform cups made of a conductive material to make the medication bins 102 tamper proof. In this embodiment, electrical resistance is measured by an electronic current measuring circuit, that is, the detection circuitry 1601 of the receptacle base 2101, to detect tampering when cuts or incisions are made on one or more of the surfaces, for example, 102i, 102j, 102a, etc., of the medication bin 102. The conductive material of the medication bins 102 conducts electricity and when a small current is supplied by a power source (not shown), which is detected by the detection circuitry 1601 of the receptacle base 2101, any cuts or any incisions in one or more of the surfaces, for example, 102i, 102j, 102a, etc., of the medication bins 102 is detected by the detection circuitry 1601 of the receptacle base 2101 by measuring resistance in the conductive circuit layer 107 in a manner similar to detection of line breaks in the conductive sensor circuit lines 108a of the medication bins 102 as disclosed in the detailed description of FIGS. 16A-16C.

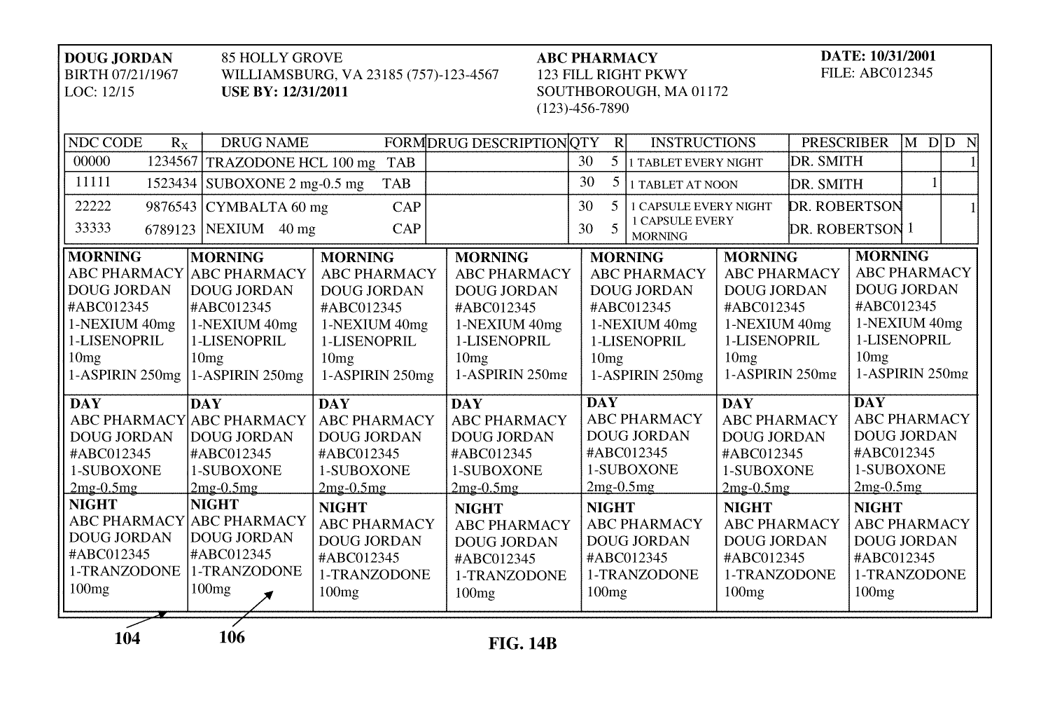

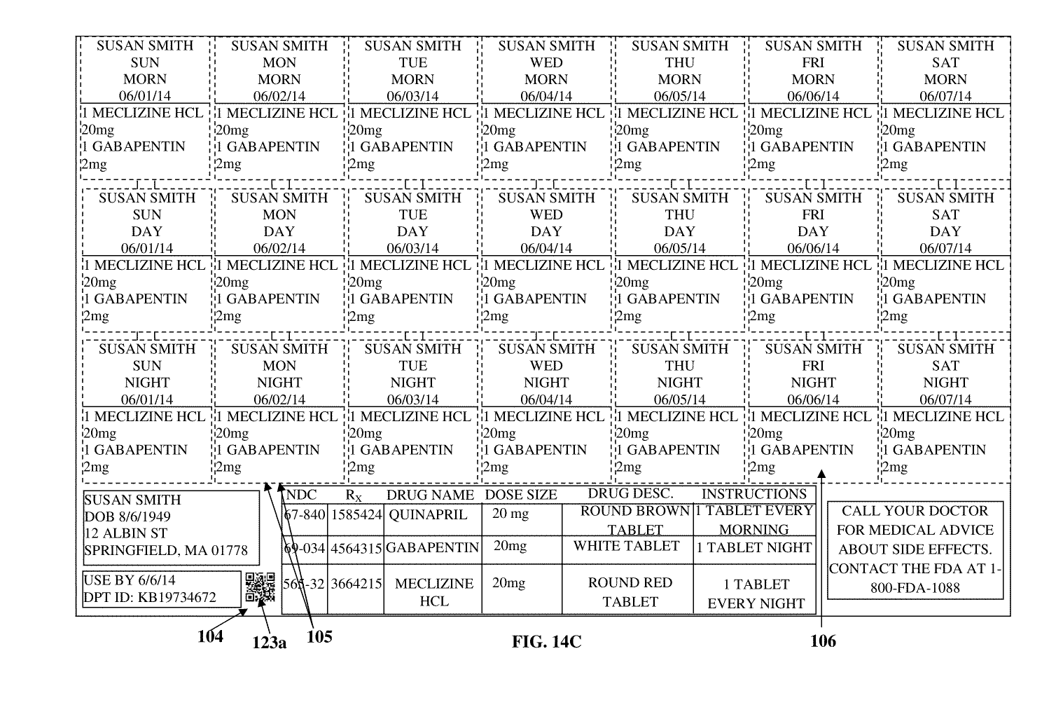

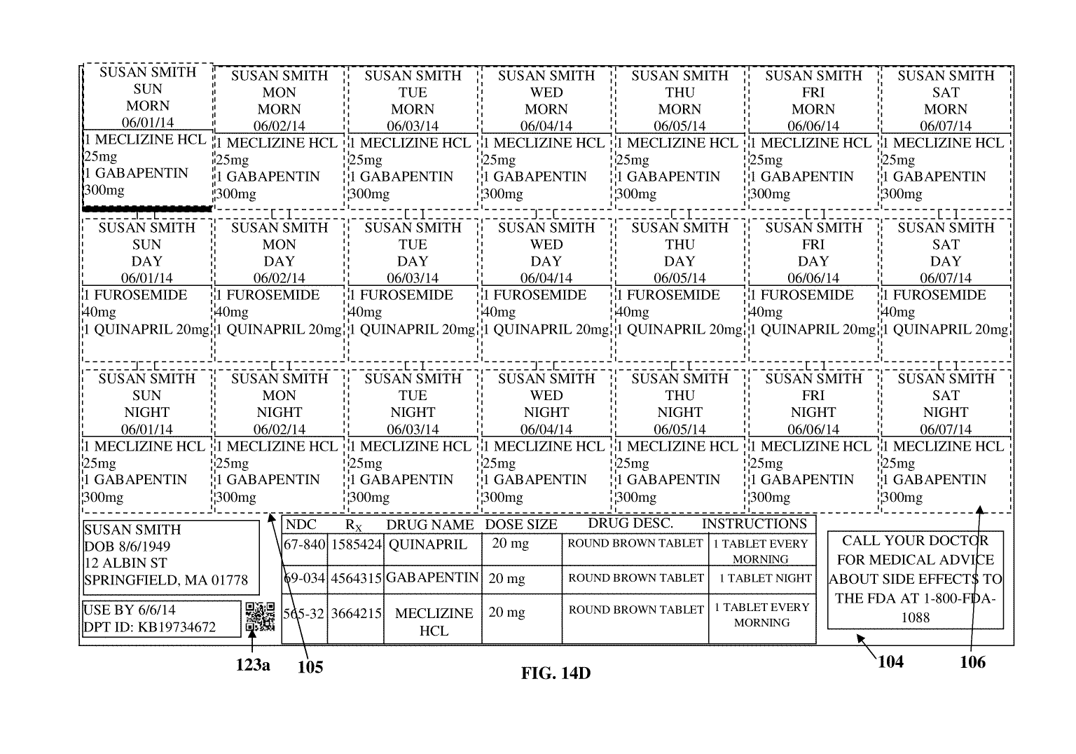

FIGS. 14A-14D exemplarily illustrate top plan views of different embodiments of the bin cover layer 104 of the medication organizer tray apparatus 100 exemplarily illustrated in FIGS. 1A-1C and FIGS. 2A-2B, showing customized bin labels 106 removably configured within the bin cover layer 104. The bin cover layer 104 is removably attached to the upper surface 101a of the support frame 101 exemplarily illustrated in FIG. 1A. The customized bin labels 106 of the bin cover layer 104 seal openings 117 of the medication bins 102 exemplarily illustrated in FIGS. 8-9 and FIG. 11A. The lower surface 104b of the bin cover layer 104 is attached to the upper surface 101a of the support frame 101 by removing the adhesive protective paper layer 126 from the lower surface 104b of the bin cover layer 104 as disclosed in the detailed description of FIGS. 18A-18B. Adhesive used around the upper surface 101a of the support frame 101 is stronger than the adhesive used on the surface 101d surrounding the outer edges 111a of the apertures 111 of the support frame 101 between the medication bins 102 exemplarily illustrated in FIG. 18B, for facilitating easy removal of the medication bins 102 via the perforations 110 of the support frame 101 exemplarily illustrated in FIG. 1B and FIG. 4A. The bin cover layer 104 comprises perforations 105 exemplarily illustrated in FIG. 14C, positioned at predefined areas on the bin cover layer 104 to match perforations 110 positioned proximal to the outer edges 111a of the apertures 111 of the support frame 101. In an embodiment, the bin cover layer 104 further comprises cut portions 122 exemplarily illustrated in FIG. 14A, for accommodating the raised bump front edge 115 of each medication bin 102 exemplarily illustrated in FIG. 10 and FIG. 12.

In an embodiment, the customized bin labels 106 of the bin cover layer 104 conform to chapter 681 of the US Pharmacopeia standards. Each customized bin label 106 is, for example, a paper label sealed within or printed to the upper surface 104a of the bin cover layer 104 at a medication packaging location after a medication fill. The customized bin labels 106 comprise medication information printed according to the configuration of the medication organizer tray apparatus 100 with color coded days and times. For example, a seven day medication organizer tray apparatus 100 comprises customized bin labels 106 comprising medication information for seven days. The customized bin labels 106 comprise other information such as the name of the healthcare recipient, names of the medications 112 exemplarily illustrated in FIG. 1B, FIG. 9, and FIGS. 11A-11B, directions to be followed, name of a healthcare professional, date of preparation, date of administration, etc., as exemplarily illustrated in FIGS. 14A-14D. Furthermore, the customized bin labels 106 provide individual bin labeling with a unique printout on the individual customized bin labels 106 displaying, for example, a description of the contents of each medication bin 102, a time of day for taking the medications 112, for example, morning, noon/day, or evening, etc., as exemplarily illustrated in FIGS. 14A-14D.

In addition to the medication information, the bin cover layer 104 of the medication organizer tray apparatus 100 further comprises an identifier code 123a and/or 123b as exemplarily illustrated in FIGS. 14C-14D, a healthcare recipient picture, and additional information comprising, for example, a personalized website link to the healthcare recipient's information, a user identifier (ID) of the healthcare recipient, past week or past month overall adherence rate or each medication adherence rate, overall or each medication possession ratio, bonus award points based on factors such as how well healthcare recipients have been adherent to the medications 112 in the medication bins 102, etc., a list of medications 112, pharmacy and Rₓ number, healthcare provider information, instructions, etc., printed on the customized bin labels 106, or on a separate page, or on other surface areas of the bin cover layer 104.

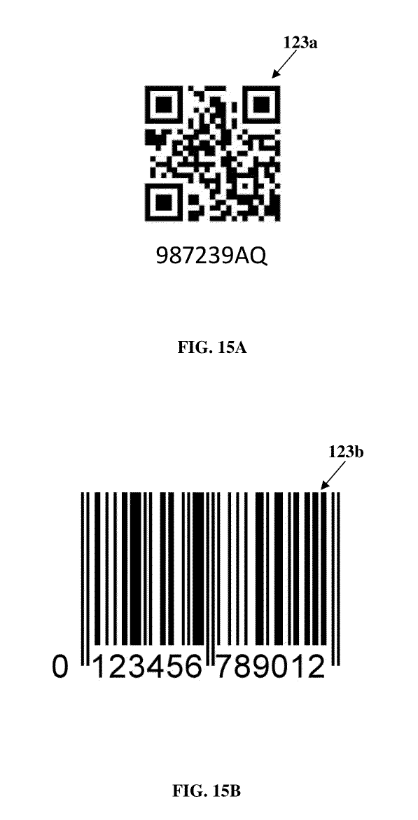

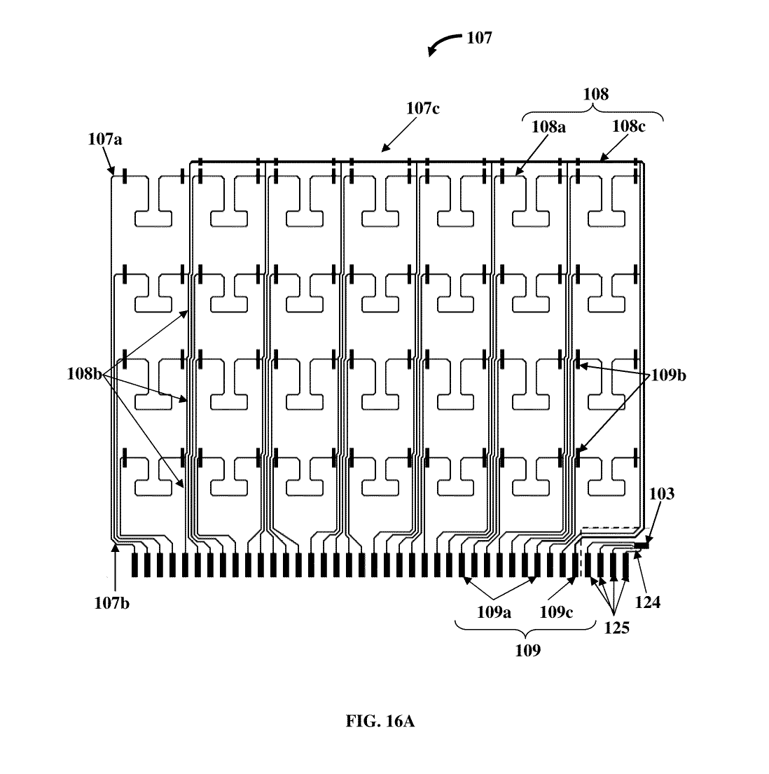

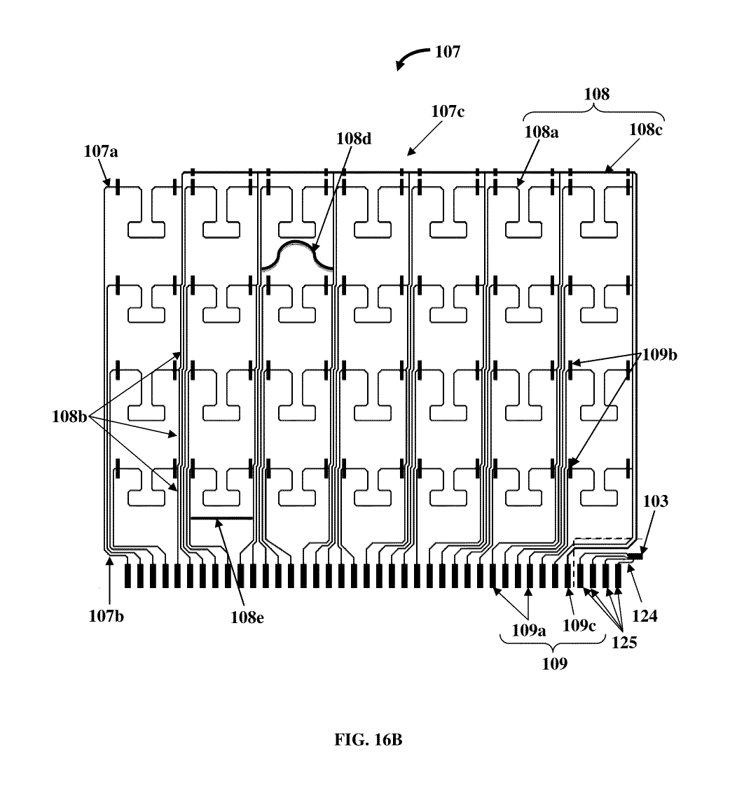

FIGS. 15A-15B exemplarily illustrate different types of identifier codes 123a and 123b configured to be printed on the bin cover layer 104 as exemplarily illustrated in FIGS. 14C-14D, of the medication organizer tray apparatus 100 exemplarily illustrated in FIGS. 1A-1C and FIGS. 2A-2B. The identifier code is configured, for example, as a quick response (QR) code 123a as exemplarily illustrated in FIG. 15A, or as a barcode 123b as exemplarily illustrated in FIG. 15B. The bin cover layer 104 displays the identifier code 123a and/or 123b, healthcare recipient information, etc. For example, a unique identifier (ID) such as a barcode 123b or a QR code 123a or a one-dimensional (1D) code or a two-dimensional (2D) code is printed on a packaging layer or on the bin cover layer 104. The identifier code 123a and/or 123b printed on the bin cover layer 104 identifies the medication organizer tray apparatus 100 and is configured to allow verification of the presence of each medication bin 102 and the medications 112 in each medication bin 102 exemplarily illustrated in FIG. 1B, FIG. 9, and FIGS. 11A-11B. That is, the identifier code 123a and/or 123b stores information on the number of medication bins 102 assigned for the medication organizer tray apparatus 100 and the number and type of medications 112 accommodated in each medication bin 102. The identifier code, for example, the QR code 123a exemplarily illustrated in FIG. 15A, is further configured to provide links to secure web pages with healthcare recipient information. Information associated with the medication organizer tray apparatus 100 comprising, for example, a list of medication codes, an identifier (ID) of the medication organizer tray apparatus 100, an ID of a healthcare recipient to whom the medication organizer tray apparatus 100 is issued, etc., is embedded in the identifier code 123a and/or 123b. A healthcare recipient or a healthcare provider can use, for example, a smartphone to scan the identifier code 123a and/or 123b and view the information embedded in the identifier code 123a and/or 123b.

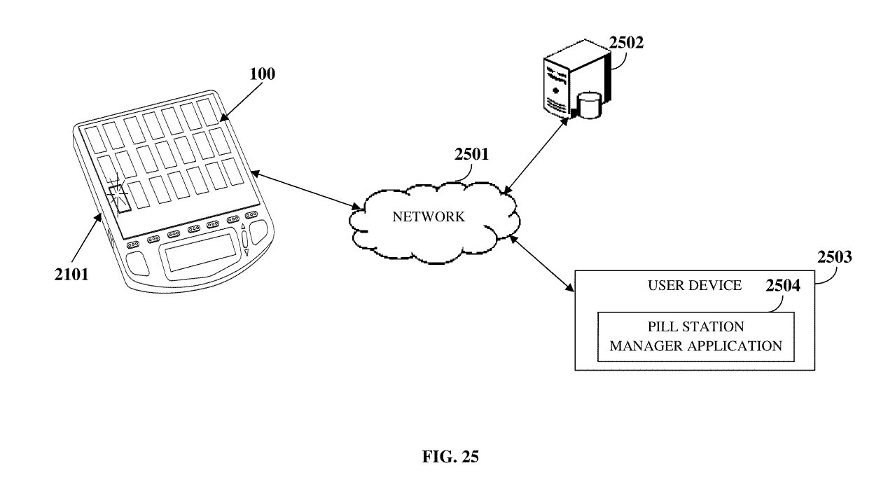

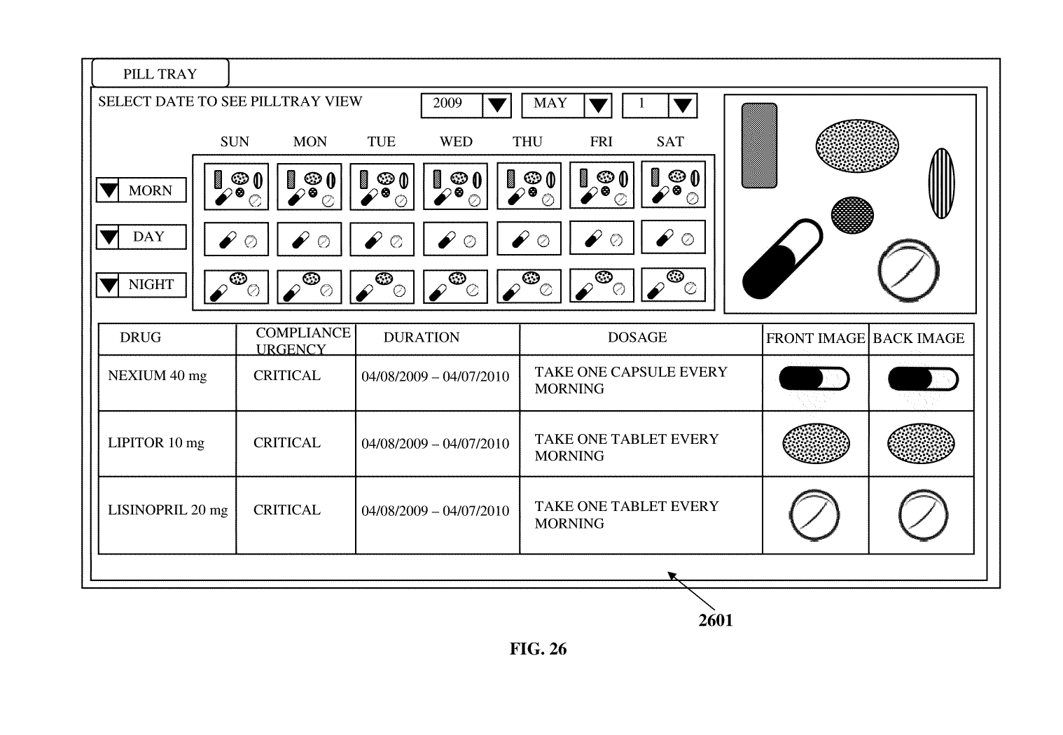

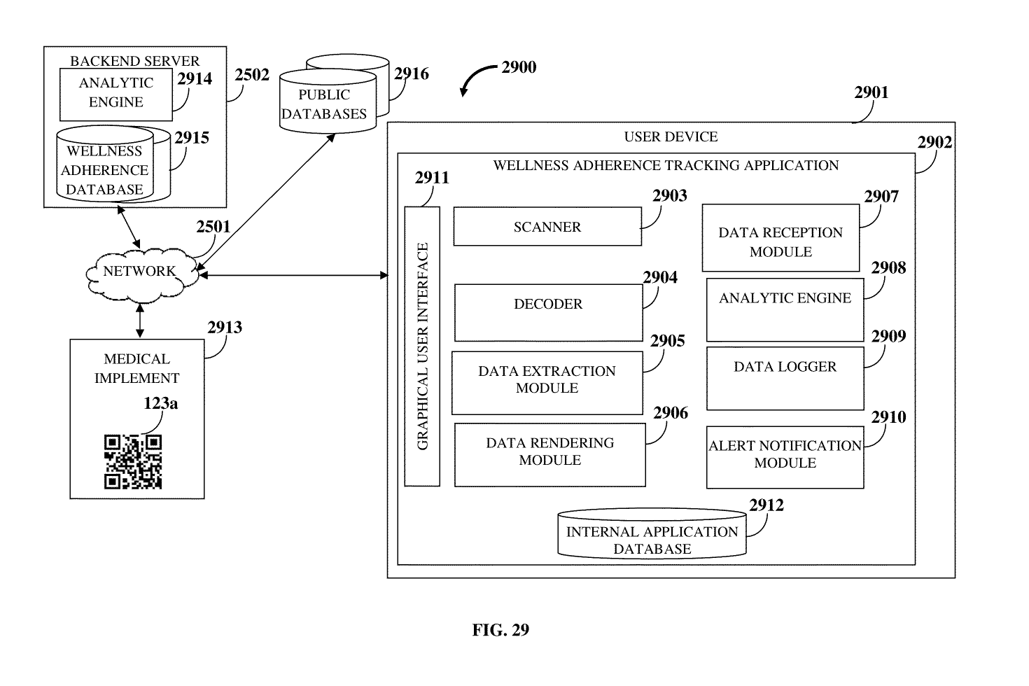

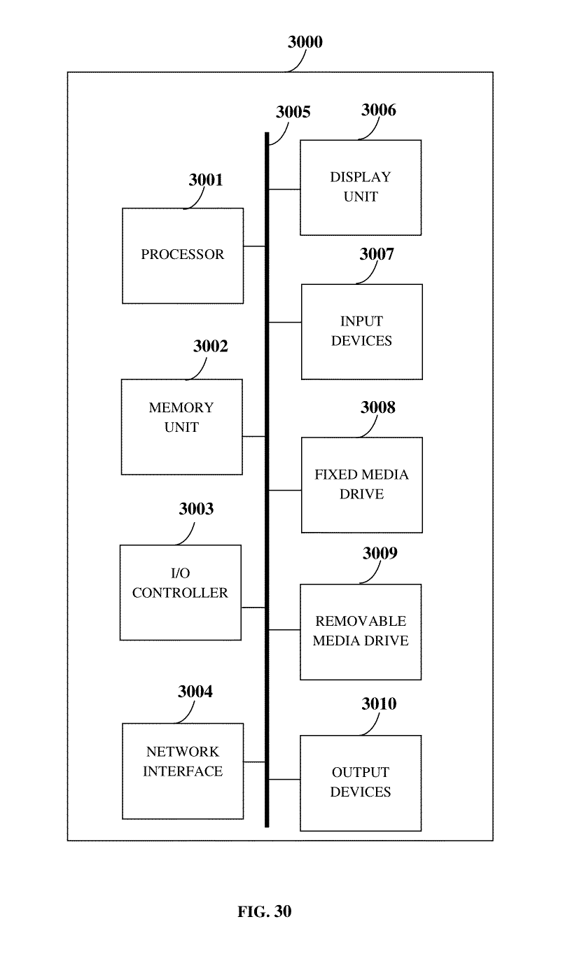

The identifier code 123a and/or 123b enables a pill station manager application 2504 configured as a client application executable by at least one processor on a user device 2503 exemplarily illustrated in FIG. 25, to verify that correct medication bins 102 of the medication organizer tray apparatus 100 contain the correct prescribed medications 112. The pill station manager application 2504 can be installed on the healthcare recipient's user device 2901 exemplarily illustrated in FIG. 29, and/or on the healthcare provider's user device 2503 exemplarily illustrated in FIG. 25. The identifier code 123a and/or 123b is configured to be synchronized with the pill station manager application 2504 to confirm accuracy of alerts and messages being transmitted to a healthcare recipient. When the medication organizer tray apparatus 100 used by a healthcare recipient is connected to the receptacle base 2101 exemplarily illustrated in FIGS. 21A-21B and FIG. 22, the identifier code 123a and/or 123b that is scanned, for example, using the healthcare recipient's user device 2901, synchronizes with the pill station manager application 2504 to ensure that correct messages and alarms are delivered to the healthcare recipient. In an embodiment, the healthcare recipient can transmit the scanned identifier code 123a and/or 123b from the healthcare recipient's user device 2901 to the pill station manager application 2504 deployed on the healthcare provider's user device 2503 for verification of information, messages, and alarms.

The identifier code 123a and/or 123b can be read by code reader devices, for example, smartphones and other identification (ID) readers for identifying the medication organizer tray apparatus 100 and confirming whether the correct medications 112 are filled in the medication bins 102 contained in the medication organizer tray apparatus 100. In an embodiment, the bin cover layer 104 displays a human readable ID for use in cases when code reader devices are not available. In another embodiment, another type of identifier code, for example, an authentication code is embedded in the quick response (QR) code 123a such that only the healthcare recipient's user device 2901 will be able to read the QR code 123a, decipher the content, match the identifiers, open a link, and display the content on the healthcare recipient's user device 2901. This authentication code is useful when the healthcare recipient is located in an area where there is no network connectivity and the healthcare recipient requires a list of medications 112 stored in the medication organizer tray apparatus 100. In an embodiment, the identifier code configured, for example, as a QR code 123a links to a secure online application for verification of the healthcare recipient's information and the medical information.

FIG. 16A exemplarily illustrates a conductive circuit layer 107 of the medication organizer tray apparatus 100 exemplarily illustrated in FIGS. 1A-1C and FIGS. 2A-2B, showing conductive lines 108 and conductive pads 109. To preclude tampering of high priced and/or abusable medications 112 exemplarily illustrated in FIG. 1B, FIG. 9, and FIGS. 11A-11B, for example, pain killers, opioids, etc., by creation of incisions or cuts on the side surfaces 102e and 102f of the medication bin 102 and on the lower surface 102a of the medication bin 102, the medication organizer tray apparatus 100 provides additional security via detection circuitry on the lower surface 104b of the bin cover layer 104 as exemplarily illustrated in FIG. 18A. The conductive lines 108 and the conductive pads 109 constitute the detection circuitry or the multi-layer conductive circuit of the conductive circuit layer 107. The conductive lines 108 of the conductive circuit layer 107 comprise, for example, conductive sensor circuit lines 108a, a common return line 108b, and a redundant circuit common return line 108c as exemplarily illustrated in FIGS. 16A-16C. The conductive pads 109 of the conductive circuit layer 107 comprise edge conductive pads 109a, medication bin conductive pads 109b, and a redundant conductive pad 109c as exemplarily illustrated in FIGS. 16A-16C.

In an embodiment, the conductive circuit layer 107 is printed and embedded on the lower surface 104b of the bin cover layer 104 as exemplarily illustrated in FIG. 18A, and around each medication bin 102 and on the lower surface 102a of each medication bin 102 as exemplarily illustrated in FIG. 13. In an embodiment, the conductive lines 108 of the conductive circuit layer 107 running along one or more of the lower surface 104b of the bin cover layer 104, around each medication bin 102, and the lower surface 102a of each medication bin 102 are printed using one or more of multiple conductive print technologies to allow etching of complex electric circuits without causing short circuit issues. In another embodiment, the conductive circuit layer 107 is printed using conductive ink. In an embodiment, the conductive ink is an invisible ink. In an embodiment, the conductive ink is printed on each medication bin 102. In another embodiment, the conductive lines 108 of the conductive circuit layer 107 running along one or more of the lower surface 104b of the bin cover layer 104, around each medication bin 102, and the lower surface 102a of each medication bin 102 are created by applying an electrically conductive material, for example, copper on one or more of the lower surface 104b of the bin cover layer 104, around the medication bins 102 exemplarily illustrated in FIGS. 11A-11B, and the lower surface 102a of the medication bins 102, and removing excess of the electrically conductive material, for example, by an etching process or using chemicals such that only the conductive lines 108 remain. In an embodiment, the conductive lines 108 are color coded such that the conductive lines 108 appear as a design element of the medication organizer tray apparatus 100 and enhance the aesthetics of the medication organizer tray apparatus 100.

The multi-layer conductive circuit of the conductive circuit layer 107 is configured to trip when one or more of the medication bins 102 are removed from the support frame 101 exemplarily illustrated in FIGS. 1A-7. The multi-layer conductive circuit comprises the conductive sensor circuit lines 108a, the conductive connection pads, that is, the edge conductive pads 109a, the medication bin conductive pads 109b, the common return lines 108b, the redundant circuit common return line 108c, the redundant conductive pad 109c, and additional conductive sensor circuit lines 108d and 108e exemplarily illustrated in FIG. 16B. In an embodiment, the edges 107a and 107b of the conductive circuit layer 107 form large conductive regions as exemplarily illustrated in FIGS. 16A-16C.

The conductive sensor circuit lines 108a of the conductive circuit layer 107 are signal lines for each medication bin 102. The conductive sensor circuit lines 108a ensure connectivity of each medication bin 102 with the conductive circuit layer 107. Each medication bin 102 has a closed loop circuit comprising a conductive sensor circuit line 108a and common return lines 108b passing through the edge conductive pads 109a. The common return lines 108b are configured for one or more medication bins 102. The common return lines 108b increase circuit reliability against incorrect registration of the conductive sensor circuit line 108a of each medication bin 102 in the conductive circuit layer 107. Sharing of common return lines 108b increases circuit reliability against incorrect registration of the conductive sensor circuit line 108a, for example, while printing, deposition, etc., or tearing beyond medication bin perforations 110 exemplarily illustrated in FIG. 1B, FIG. 4A, FIG. 5, FIG. 7, and FIG. 9. Since each medication bin 102 is independent from another medication bin 102 of the medication organizer tray apparatus 100, single or multiple line breaks in the conductive sensor circuit lines 108a of the conductive circuit layer 107 representing removal of single or multiple medication bins 102 from the support frame 101 of the medication organizer tray apparatus 100 can be detected simultaneously.

The edge conductive pads 109a are configured for each conductive sensor circuit line 108a of each medication bin 102. The edge conductive pads 109a ensure connectivity to the detection circuitry 1601 exemplarily illustrated in FIG. 16C, of the receptacle base 2101 exemplarily illustrated in FIGS. 21A-21B and FIG. 22. The edge conductive pads 109a electrically communicate with one or more base conductive pads 1604 of the receptacle base 2101 as exemplarily illustrated in FIG. 16C, to enable detection of removal of each medication bin 102 from the support frame 101 and detection of tampering of the medication bins 102. In an embodiment, the edge conductive pads 109a are formed by depositing a larger amount of conductive ink in certain regions of the bin cover layer 104. The conductive sensor circuit lines 108a are initiated and terminated through the edge conductive pads 109a which are larger in size to maximize electrical connectivity in the medication organizer tray apparatus 100. In an embodiment, the medication bin conductive pads 109b detect a medication bin 102 being opened. The medication bin conductive pads 109b are configured as large and wide lines for each of the medication bins 102 and maintain their conductive integrity even after the perforations 105 of the bin cover layer 104 pass through the medication bin conductive pads 109b. The medication bin conductive pads 109b maintain conductive integrity of the conductive sensor circuit line 108a of each medication bin 102 when perforations 105 positioned at predefined areas on the bin cover layer 104 cut through the conductive sensor circuit line 108a.

To further strengthen connectivity and protection against premature tearing during removal of the medication bins 102, a redundant circuit common return line 108c is provided in the conductive circuit layer 107. The redundant circuit common return line 108c is positioned on a periphery 107c of the conductive circuit layer 107 and terminates on a different terminating edge conductive pad 109c as exemplarily illustrated in FIGS. 16A-16C. The redundant circuit common return line 108c ensures electrical conductivity in the conductive circuit layer 107 if a common return line 108b of the multi-layer conductive circuit is compromised. All conductive circuit layers 107 can share one redundant circuit common return line 108c and reduce the number of overall edge conductive pads 109a. For example, the common return lines 108b of four day medication bins 102 comprising medications 112 exemplarily illustrated in FIG. 1B, to be consumed, for example, on a Monday, share a redundant circuit common return line 108c as exemplarily illustrated in FIGS. 16A-16C. The common return lines 108b for each day's medication bin 102 share the redundant circuit common return line 108c. The redundant conductive pad 109c is configured for the redundant circuit common return line 108c. The redundant conductive pad 109c of the redundant circuit common return line 108c connects to one or more of the base conductive pads 1604 of the receptacle base 2101 as exemplarily illustrated in FIG. 16C.

FIG. 16B exemplarily illustrates an embodiment of the conductive circuit layer 107 of the medication organizer tray apparatus 100 exemplarily illustrated in FIGS. 1A-1C and FIGS. 2A-2B, showing conductive sensor circuit lines 108d and 108e of different patterns. In an embodiment, the conductive circuit layer 107 comprises additional conductive sensor circuit lines 108d and 108e of different patterns for the medication bins 102 exemplarily illustrated in FIGS. 11A-11B. The additional conductive sensor circuit lines 108d and 108e are configured to communicate with the receptacle base 2101 exemplarily illustrated in FIGS. 21A-21B and FIG. 22, to detect tampering of the medication bins 102 and the bin cover layer 104 exemplarily illustrated in FIGS. 1A-1B. In an embodiment, the additional conductive sensor circuit lines 108d and 108e are configured in different shapes as exemplarily illustrated in FIG. 16B, to prevent tampering by creation of cuts or incisions in the medication bins 102 to remove the medications 112 exemplarily illustrated in FIGS. 11A-11B. In an embodiment, additional redundant circuitry formed by the additional conductive sensor circuit lines 108d and 108e may be embedded on the bin cover layer 104 in case one conductive circuit layer 107 is compromised. A second conductive sensor circuit line, for example, 108e is provided for additional circuit connections as a backup as exemplarily illustrated in FIG. 16B. The conductive circuit layer 107 is configured with additional conductive sensor circuit lines 108d and 108e or circuit connections as backups, thereby forming complex patterns of conductive lines 108, for example, loops on predefined areas of the bin cover layer 104 that cover the openings 117 of the medication bins 102 exemplarily illustrated in FIG. 7, FIG. 10, FIG. 11A, and FIG. 18B. These additional conductive sensor circuit lines 108d and 108e and circuit connections are provided to preclude patients from stealing medications 112, by creating a small incision or a cut in the medication bin 102 and taking the medications 112 out. This configuration of the conductive circuit layer 107 allows detection of any method of accessing the medication bins 102, for example, removal of the medication bins 102 from the support frame 101 exemplarily illustrated in FIGS. 1A-7, and any method of tampering of the bin cover layer 104 in any manner, for example, by puncturing the bin cover layer 104 and removing the medications 112 from the upper surface 102c of the medication bin 102 exemplarily illustrated in FIG. 10 and FIGS. 12-13. This configuration of the conductive circuit layer 107 allows detection when a person accesses the medication bin 102 by removing the medication bin 102 from the support frame 101 or by removing the medications 112 by puncturing the bin cover layer 104 at the upper surface 102c of the medication bin 102.

FIG. 16C exemplarily illustrates communication between the conductive circuit layer 107 of the medication organizer tray apparatus 100 exemplarily illustrated in FIGS. 1A-1C and FIGS. 2A-2B, and detection circuitry 1601 of the receptacle base 2101 exemplarily illustrated in FIGS. 21A-21B and FIG. 22. The conductive circuit layer 107 is printed and embedded in the medication organizer tray apparatus 100 such that when one or more of the medication bins 102 containing medications 112 exemplarily illustrated in FIG. 9, that are scheduled to be consumed by a healthcare recipient in a day are removed, the conductive circuit layer 107 is tripped. The tripped conductive circuit layer 107 is detected by the detection circuitry 1601 of the receptacle base 2101. The conductive circuit layer 107 communicates with the receptacle base 2101 to enable detection of removal of each medication bin 102 from the support frame 101 and detection of tampering of the medication bins 102. As exemplarily illustrated in FIG. 16C, the detection circuitry 1601 of the receptacle base 2101 comprises a detection circuitry processing component 1602 and an electronic identification processing component 1603. The detection circuitry processing component 1602 is configured to communicate with the conductive circuit layer 107 of the medication organizer tray apparatus 100. The electronic identification processing component 1603 is configured to communicate with the electronic identification component 103 of the medication organizer tray apparatus 100. The conductive pads 109 of the conductive circuit layer 107 comprising the edge conductive pads 109a and the redundant conductive pad 109c positioned on the lower surface 104b of the bin cover layer 104 exemplarily illustrated in FIGS. 1A-1B and FIG. 18B, electrically connect to connector pins 1602a that extend from the detection circuitry processing component 1602 of the receptacle base 2101 via multiple base conductive pads 1604a and 1604b of the receptacle base 2101. The electronic identification component pads 125 positioned on the lower surface 104b of the bin cover layer 104 electrically connect to connector pins 1603a that extend from the electronic identification processing component 1603 of the receptacle base 2101 via base conductive pads 1604c of the receptacle base 2101. The base conductive pads 1604 comprise base edge conductive pads 1604a, a base redundant conductive pad 1604b, and base identification component pads 1604c. Each base edge conductive pad 1604a is aligned with each edge conductive pad 109a. Each base redundant conductive pad 1604b is aligned with the redundant conductive pad 109c. Each electronic identification component pad 125 is aligned with each base identification component pad 1604c. These alignments of the conductive pads 109 of the conductive circuit layer 107 with the base conductive pads 1604 make an electrical connection between the receptacle base 2101 and the medication organizer tray apparatus 100 as exemplarily illustrated in FIG. 16C.

In an embodiment, the detection circuitry processing component 1602 of the receptacle base 2101 comprises, for example, about 35 connector pins 1602a electrically connected to the edge conductive pads 109a of the conductive circuit layer 107 via about 35 base edge conductive pads 1604a. In an embodiment, the detection circuitry processing component 1602 provides, for example, about 5 connector pins 1602a and base edge conductive pads 1604a for making electrical connections to the medication bins 102 of the medication organizer tray apparatus 100. The conductive sensor circuit lines 108a running along the lower surface 104b of the bin cover layer 104, around each medication bin 102, and on the lower surface 102a of each medication bin 102, via the edge conductive pads 109a, connect to the connector pins 1602a of the detection circuitry processing component 1602 via the base edge conductive pads 1604a. The redundant circuit common return line 108c, via the redundant conductive pad 109c of the conductive circuit layer 107, connects to the base redundant conductive pad 1604b of the detection circuitry processing component 1602. The electronic identification processing component 1603 of the detection circuitry 1601 comprises, for example, about 4 base identification component pads 1604c extending from the connector pins 1603a and configured to align with and electrically connect to connector pins 124 of the electronic identification component 103 via electronic identification component pads 125 of the medication organizer tray apparatus 100 as exemplarily illustrated in FIG. 16C.

The conductive sensor circuit lines 108a connect to the edge conductive pads 109a. The edge conductive pads 109a connect to the detection circuitry 1601 of the receptacle base 2101. Each time a medication bin 102 is opened, the conductive sensor circuit line 108a corresponding to that medication bin 102 is tripped, thereby resulting in a tripped conductive circuit layer 107 on the medication organizer tray apparatus 100. The detection circuitry 1601 of the receptacle base 2101 that is connected to the edge conductive pads 109a of the medication organizer tray apparatus 100 senses the tripped conductive sensor circuit lines 108a and intact conductive sensor circuit lines 108a of the conductive circuit layer 107. A conductive circuit layer 107 which is broken at times and intact at other times indicates tampering of the medication bins 102, for example, when a healthcare recipient may have tried to open and close the medication bin 102, but failed to make a full connection of the conductive circuit layer 107 due to improper removal and/or insertion of the medication bin 102 from the support frame 101 exemplarily illustrated in FIGS. 1A-7. When a healthcare recipient inserts the medication organizer tray apparatus 100 in the receptacle base 2101, the edge conductive pads 109a which are positioned on the lower surface 104b of the bin cover layer 104 make physical contact with the base edge conductive pads 1604a of the detection circuitry 1601 embedded in the receptacle base 2101. The positions of the base conductive pads 1604 match the positions of each of the edge conductive pads 109a, the redundant conductive pad 109c, and the electronic identification component pads 125. The physical contact makes the electrical connection for signals which connect the detection circuitry 1601 of the receptacle base 2101 to the conductive circuit layer 107 of the medication organizer tray apparatus 100.

The detection circuitry 1601 of the receptacle base 2101 collects information associated with detection of a break in the conductive sensor circuit lines 108a of the conductive circuit layer 107. The collected information comprises, for example, a time and a date of the break in the conductive sensor circuit lines 108a, the medication bin 102 that is removed from the support frame 101, etc. The receptacle base 2101 transmits the collected information to a backend server 2502 via a network 2501 exemplarily illustrated in FIG. 25. The backend server 2502 receives and uses the collected information to monitor compliance of a healthcare recipient with a medication regimen. When a patient has consumed all the prescribed medications 112 contained in the medication bins 102 of the medication organization tray apparatus 100 based on dose time information stored in the electronic identification component 103, the receptacle base 2101 further transmits the collected medication adherence information to the backend server 2502 via the network 2501. In an embodiment, the detection circuitry 1601 of the receptacle base 2101 transmits the collected information to the electronic identification component 103. For example, in cases when the patient using the medication organization tray apparatus 100 has no connectivity to the backend server 2502, for example, via the internet, a cell phone with internet connectivity, Ethernet, etc., the receptacle base 2101 stores the collected medication adherence information in the electronic identification component 103, and the patient can remove and ship the electronic identification component 103, for example, to a company, a pharmacy, or a medical entity for checking medication adherence. The pharmacy can directly access the medication adherence information that is collected from the receptacle base 2101 and stored in the electronic identification component 103.

In an embodiment, the conductive circuit layer 107 is electrically connected to a power source for receiving minimal power at predetermined time intervals to enable detection of a break in the conductive circuit layer 107, in electric communication with the receptacle base 2101, when one or more of the medication bins 102 are removed from the support frame 101. In this embodiment, when the medication bin 102 is removed from the support frame 101 of the medication organizer tray apparatus 100, the detection circuitry 1601 of the receptacle base 2101 detects removal of the medication bin 102 as the circuit connection is broken, at predetermined time intervals. In another embodiment, the conductive circuit layer 107 is electrically connected to a power source for receiving a constant power supply of minimal magnitude to enable detection of a break in the conductive circuit layer 107, in communication with the receptacle base 2101, when one or more of the medication bins 102 are removed from the support frame 101. In this embodiment, the detection circuitry 1601 of the receptacle base 2101 dynamically detects removal of the medication bins 102 as the circuit connection is broken, when the medication bins 102 are removed from the support frame 101 of the medication organizer tray apparatus 100.

In an embodiment, a power drop in the conductive sensor circuit lines 108a of the conductive circuit layer 107 can be minimized, for example, reduced to zero, except for a predetermined time interval such as a few seconds at the time of sensing removal of each medication bin 102 from the support frame 101 and/or tampering of the medication bins 102. High power drop across the medication organizer tray apparatus 100 can heat up the conductive circuit layer 107. In an embodiment, a break in the conductive circuit layer 107 of the medication organizer tray apparatus 100 is detected, when a small current generating a generally small power, for example, of about 30 milliwatts (mW) is passed through the conductive sensor circuit lines 108a and the continuity of the generated power along the conductive sensor circuit lines 108a is broken. In another embodiment, the conductive circuit layer 107 is isolated with no current flowing through the conductive sensor circuit lines 108a; hence no power flows across the conductive sensor circuit lines 108a. In this embodiment, the detection circuitry 1601 of the receptacle base 2101 periodically polls the medication organizer tray apparatus 100 at predetermined time intervals. For example, the detection circuitry 1601 of the receptacle base 2101 polls the medication organizer tray apparatus 100 at a polling time of about 15 minutes. The conductive sensor circuit lines 108a of the medication organizer tray apparatus 100 are electrically connected at the polling time. When the conductive sensor circuit lines 108a are electrically connected, then a small amount of current is passed through the conductive sensor circuit lines 108a to detect open and close conductive sensor circuit lines 108a.

FIGS. 17A-17B exemplarily illustrate embodiments of the electronic identification component 103 of the medication organizer tray apparatus 100 exemplarily illustrated in FIGS. 1A-1C and FIGS. 2A-2B. The electronic identification component 103 is configured as an embedded identifier chip or an integrated circuit chip. In an embodiment, the electronic identification component 103 is, for example, a security and identifier (ID) chip or a hardwired chip embedded in the support frame 101 of the medication organizer tray apparatus 100 exemplarily illustrated in FIGS. 1A-1C. The electronic identification component 103 is, for example, an active chip or a passive chip or a tag and operates using one or more wired modes of communication, for example, via direct contact using cables or one or more wireless modes of communication, for example, mobile Wi-Fi® (MiFi®) of Novatel Wireless, Inc., radio frequency identification (RFID), etc. The electronic identification component 103 configured, for example, as an RFID sensor or a MiFi® sensor stores medication adherence information comprising, for example, one or more of a serial identifier that matches a healthcare recipient identifier, information to coordinate medical activities, network identifiers and passwords, dosage times, wellness instructions for providing behavioral support for ensuring medication adherence by a healthcare recipient, messages, calendar information, information associated with removal of each medication bin 102 from the support frame 101 exemplarily illustrated in FIGS. 1A-1C, and tampering of the medication bins 102, etc. The electronic identification component 103 also stores identifiers of messages for the receptacle base 2101 exemplarily illustrated in FIGS. 21A-21B and FIG. 22, to play at a specific time.

In an embodiment, the electronic identification component 103 is installed or embedded into the support frame 101 via a sticker 1701 that is placed on the support frame 101 of the medication organizer tray apparatus 100. In an embodiment, the sticker 1701 is made of plastic material. In an embodiment, a rear surface 1701a of the sticker 1701 is a conductive surface comprising conductive lines 1704 and conductive pads 1703 configured to electrically connect the electronic identification component 103 to the receptacle base 2101. In an embodiment, the conductive pads 1703 on the sticker 1701 connect through an adhesive such as glue or other means to the electronic identification component pads 125 of the conductive circuit layer 107 exemplarily illustrated in FIGS. 16A-16C, which are etched and exposed on the medication organizer tray apparatus 100. In an example, the electronic identification component 103 is placed on the sticker 1701 during a manufacturing process of the electronic identification component 103, and is tested and programmed in a laboratory. Conductive ink is then applied on connector pins 124 of the electronic identification component 103. Large conductive pads 1703 are configured on the sticker 1701 to ensure appropriate alignment of the conductive pads 1703 to the electronic identification component pads 125 of the conductive circuit layer 107 of the medication organizer tray apparatus 100. The electronic identification component 103 connects to the detection circuitry 1601 exemplarily illustrated in FIG. 16C, of the receptacle base 2101 via the conductive pads 1703 of the sticker 1701 and validates the medication organizer tray apparatus 100 and healthcare recipient information.

The electronic identification component 103 comprises, for example, three or four connector pins 124 that connect to the conductive pads 1703 depending on the type of connector pins 124. In an embodiment, the electronic identification component 103 comprises four connector pins 124 as exemplarily illustrated in FIG. 17A. The four connector pins 124 of the electronic identification component 103 represent connections comprising, for example, two control lines 124a and 124c, a power line 124b, and a ground line 124d as exemplarily illustrated in FIG. 17A. In another embodiment, the electronic identification component 103 comprises three connector pins 124 as exemplarily illustrated in FIG. 17B. In this embodiment, the connector pins 124 of the electronic identification component 103 represent connections comprising, for example, a control line 124a, a power line 124b, and a ground line 124d as exemplarily illustrated in FIG. 17B. The ground line 124d is a return line which can connect, for example, to a ground line of a battery or a ground line of the receptacle base 2101. The control lines 124a and 124c are signal lines through which the electronic identification component 103 exchanges information comprising, for example, an identifier code 123a and/or 123b exemplarily illustrated in FIGS. 15A-15B, of the medication organizer tray apparatus 100, opening and/or closing of the conductive circuit layer 107, time of opening and/or closing of the conductive circuit layer 107, etc., with the receptacle base 2101. The control lines 124a and 124c are used to program and load medication adherence information in the electronic identification component 103. The rear surface 1701a of the sticker 1701 comprises conductive lines 1704 that are connected to a series of conductive pads 125 of the electronic identification component 103 via matching conductive pads 1703 of the sticker 1701. In an embodiment, the electronic identification component 103 receives power from different power sources through the power line 124b. The electronic identification component 103 comprises basic information when placed via the sticker 1701. In an embodiment, the medication organizer tray apparatus 100 further comprises placement alignment markers (not shown) that enable proper placement of the sticker 1701 and the edge conductive pads 109a in the medication organizer tray apparatus 100. For example, the placement location of the sticker 1701 is printed or indented on the medication organizer tray apparatus 100 to ensure that the sticker 1701 with the electronic identification component 103 is placed accurately in the receptacle 116 configured in the support frame 101 exemplarily illustrated in FIG. 4A, and that a connection has been made between the electronic identification component pads 125 and the base identification component conductive pads 1604c of the electronic identification processing component 1603 of the detection circuitry 1601 of the receptacle base 2101.

When the medication organizer tray apparatus 100 is inserted in the receptacle base 2101, the receptacle base 2101 validates healthcare recipient information, matches day time, updates dosage instructions, updates messages, updates wellness information, updates a type of security circuitry, etc., based on the medication adherence information stored in the electronic identification component 103. The electronic identification component 103 shares the stored medication adherence information with a healthcare recipient to whom the medication organizer tray apparatus 100 is assigned. For example, the healthcare recipient can connect the electronic identification component 103, for example, to a computing device to access the stored medication adherence information. In an embodiment, the electronic identification component 103 carries a specific security type identifier configuration. In another embodiment, the security type identifier configuration is downloaded from the pill station manager application 2504 exemplarily illustrated in FIG. 25, when the medication organizer tray apparatus 100 is inserted in the receptacle base 2101. The electronic identification component 103 confirms the healthcare recipient identifier of the healthcare recipient. The electronic identification component 103 carries additional information to confirm that the right healthcare recipient is receiving the right medication organizer tray apparatus 100 for the right week and provides information that offers additional behavioral support and encouragement to the healthcare recipient to encourage the healthcare recipient to adhere to the medications 112 exemplarily illustrated in FIG. 1B, FIG. 9, and FIGS. 11A-11B, and his/her wellness regimen.

In an embodiment, the electronic identification component 103 comprises a power source 1705, for example, a battery configured to power the electronic identification component 103. In this embodiment, the power source 1705 can be placed on the sticker 1701. In another embodiment, the electronic identification component 103 receives power from a power source (not shown) of the receptacle base 2101. The power source of the receptacle base 2101 connects to the electronic identification component pads 125 in the medication organizer tray apparatus 100 and powers the electronic identification component 103 on the medication organizer tray apparatus 100. Once the electronic identification component 103 receives power, the electronic identification component 103 is activated in a programming mode to store, for example, alarm information, information associated with a healthcare recipient identifier, etc. In another embodiment, the electronic identification component 103 comprises a light energy collector 1702 for powering the electronic identification component 103. When a light source illuminates the medication organizer tray apparatus 100, the light energy collector 1702 collects light energy from the light source which provides a primary or a backup power source for the electronic identification component 103. If a healthcare recipient inserts the medication organizer tray apparatus 100 in the receptacle base 2101 that is not powered, the light energy collector 1702 can power up the electronic identification component 103 and turn on, for example, a green light or a red light to indicate whether a healthcare recipient identifier of the medication organizer tray apparatus 100 matches a healthcare recipient identifier of the receptacle base 2101. In an embodiment, the receptacle base 2101 comprises a hardwired chip (not shown) configured to connect to the electronic identification component 103 positioned in the support frame 101 of the medication organizer tray apparatus 100 and also to power the electronic identification component 103. The electronic identification component 103 can then confirm that an identifier of the medication organizer tray apparatus 100 matches an identifier of the receptacle base 2101 to ensure that a right healthcare recipient receives the right medication organizer tray apparatus 100 assigned to him/her.

The electronic identification component 103 further comprises a light emitting diode (not shown) which is activated when the electronic identification component 103 is connected to the support frame 101 and when the medication organizer tray apparatus 100 is inserted into the receptacle base 2101. The light emitting diode confirms that a connection has been made between the electronic identification component 103 and the support frame 101 of the medication organizer tray apparatus 100, and/or between the electronic identification component 103 and the receptacle base 2101 when the medication organizer tray apparatus 100 is placed in the receptacle base 2101. In an embodiment, if the electronic identification component 103 of the medication organizer tray apparatus 100 is passive, then, when the medication organizer tray apparatus 100 is inserted into the receptacle base 2101, an indication such as a beep via a loudspeaker 2102, a light, or a message on a display screen 2103 of the receptacle base 2101 exemplarily illustrated in FIG. 21A and FIG. 22, indicates that the connections are intact.

FIG. 18A exemplarily illustrates an adhesive protective paper layer 126 removably attached to the lower surface 104b of the bin cover layer 104 of the medication organizer tray apparatus 100 exemplarily illustrated in FIGS. 1A-1C and FIGS. 2A-2B. The adhesive protective paper layer 126 forms the third component layer 303 of the medication organizer tray apparatus 100 as exemplarily illustrated in FIG. 3. The adhesive protective paper layer 126 comprises an adhesive 126a that is selectively applied on the lower surface 104b of the bin cover layer 104. The adhesive protective paper layer 126 further comprises perforations 127 and openings 128 that mirror the perforations 110 and the openings 117 of the medication bins 102 respectively, as exemplarily illustrated in FIG. 18B.

FIG. 18B exemplarily illustrates removal of the adhesive protective paper layer 126 from the lower surface 104b of the bin cover layer 104 to allow attachment of the lower surface 104b of the bin cover layer 104 to the upper surface 101a of the support frame 101. The adhesive protective paper layer 126 comprising the adhesive 126a is removably attached to the lower surface 104b of the bin cover layer 104. After the medications 112 exemplarily illustrated in FIG. 1B, are loaded in the medication bins 102 of the medication organizer tray apparatus 100 exemplarily illustrated in FIGS. 1A-1C and FIGS. 2A-2B, the adhesive protective paper layer 126 is removed from the lower surface 104b of the bin cover layer 104. The bin cover layer 104 having the selectively applied adhesive 126a exposed on the lower surface 104b of the bin cover layer 104 is then removably attached to the upper surface 101a of the support frame 101. When the adhesive protective paper layer 126 is removed from the lower surface 104b of the bin cover layer 104, the adhesive 126a of the adhesive protective paper layer 126 is left exposed on the lower surface 104b of the bin cover layer 104. When the adhesive protective paper layer 126 is removed, the exposed adhesive 126a on the lower surface 104b of the bin cover layer 104 is used to attach the lower surface 104b of the bin cover layer 104 to the upper surface 101a of the support frame 101. The exposed adhesive 126a is selectively applied on the upper surface 101a of the support frame 101 to match an outline of the lips 121 of the medication bins 102 and surfaces 101d surrounding the outer edges 111a of the apertures 111 of the support frame 101 exemplarily illustrated in FIG. 1B. The adhesive 126a is not applied on the cut edges 114 of the medication bins 102 and hence allows peeling and removal of the customized bin labels 106 exemplarily illustrated in FIG. 1A, FIGS. 2A-2B, FIGS. 8-9, and FIGS. 14A-14D, from the medication bins 102. The adhesive strength provided by the adhesive 126a of the adhesive protective paper layer 126 is calibrated to allow easy and clean removal of the customized bin labels 106 from the medication bins 102 and for removing medications 112 from the medication bins 102.

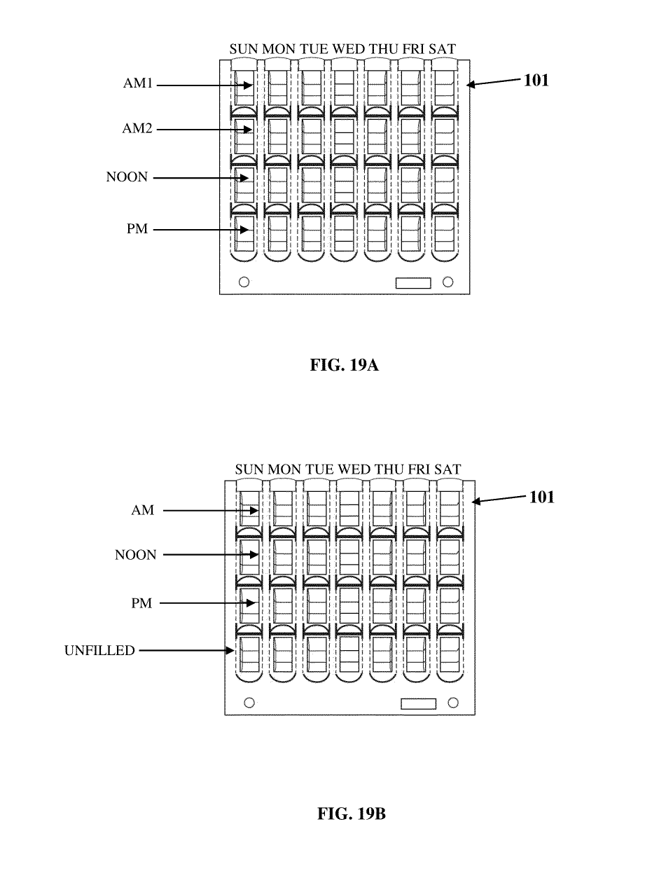

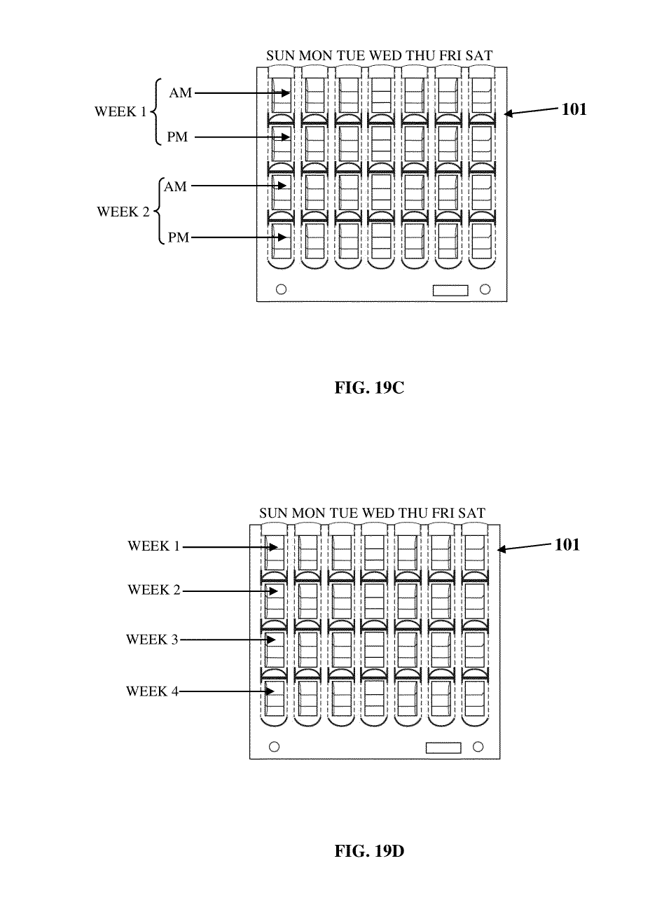

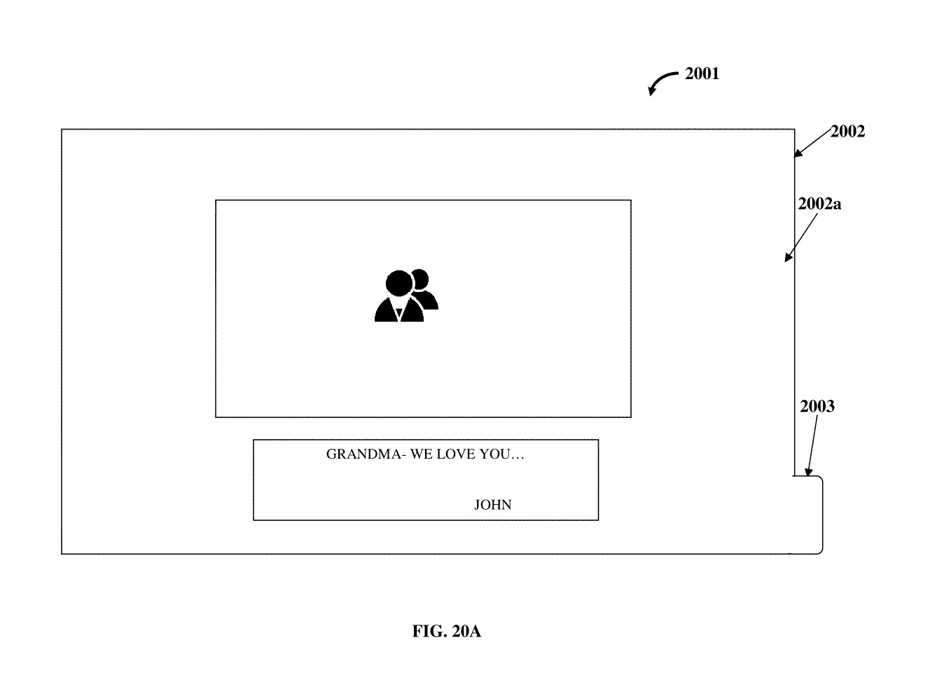

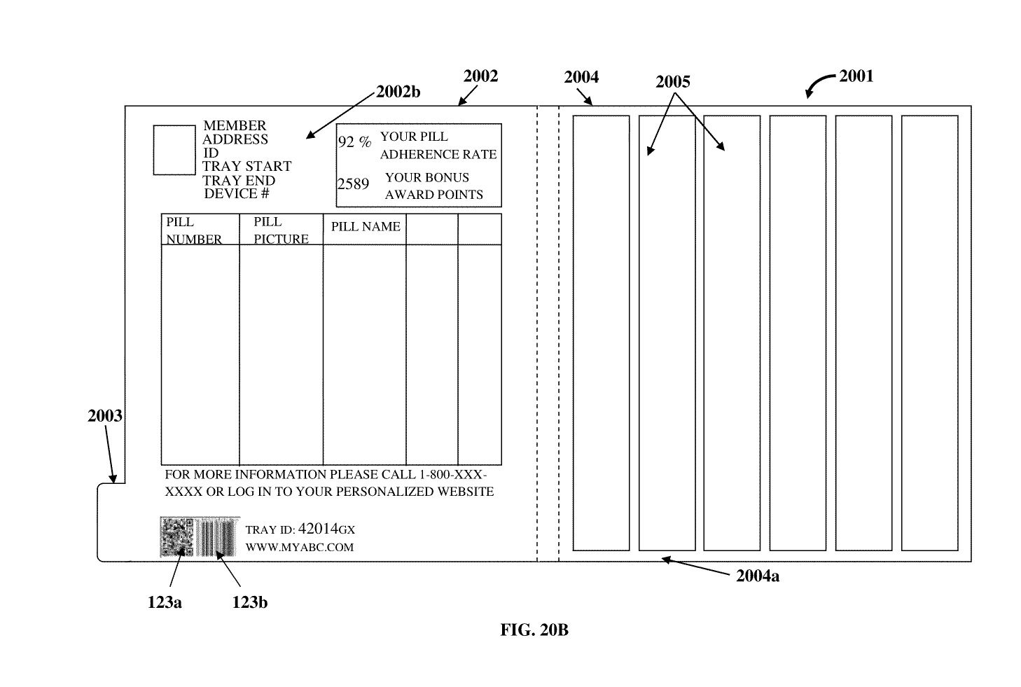

FIGS. 19A-19D exemplarily illustrate different configurations for organizing medications 112 in the medication organizer tray apparatus 100 exemplarily illustrated in FIGS. 1A-1C and FIGS. 2A-2B. FIGS. 19A-19D exemplarily illustrate multiple weekly configurations for organizing medications 112 in the medication organizer tray apparatus 100. The medication organizer tray apparatus 100 can be customized for holding different types of medications 112 and medication dosages. In an example, up to four pre-filled medication organizer tray apparatuses 100 a month or weekly pre-filled medication organizer tray apparatuses 100 are sent to a healthcare recipient as per his/her prescription with medical information printed on the customized bin labels 106 exemplarily illustrated in FIG. 1A, FIGS. 2A-2B, FIGS. 8-9, and FIGS. 14A-14D. In an embodiment, the medication organizer tray apparatus 100 is configured to hold a daily dosage, a weekly dosage for 7 days, 14 days, 21 days, or 28 days, or a monthly dosage of medications 112.

FIG. 19A exemplarily illustrates a 4×7 medication organizer tray apparatus 100 containing a medication dosage to be taken four times a day, each day of the week. The first two rows of the 4×7 medication organizer tray apparatus 100 contain medications 112 that are to be taken at different times during the day, every day of the week. The third row contains medications 112 that are to be taken at noon time, every day of the week. The fourth row of the 4×7 medication organizer tray apparatus 100 contains medications 112 that are to be taken in the evening, every day of the week.

FIG. 19B exemplarily illustrates a 4×7 medication organizer tray apparatus 100 containing a medication dosage to be taken three times a day, each day of the week. The first row of the 4×7 medication organizer tray apparatus 100 contains medications 112 that are to be taken in the morning, every day of the week. The second row of the 4×7 medication organizer tray apparatus 100 contains medications 112 that are to be taken at noon time, every day of the week. The third row of the 4×7 medication organizer tray apparatus 100 contains medications 112 that are to be taken in the evening, every day of the week. The fourth row is not filled and is empty.

FIG. 19C exemplarily illustrates a 4×7 medication organizer tray apparatus 100 containing a medication dosage for two weeks. The first row of the 4×7 medication organizer tray apparatus 100 contains medications 112 that are to be taken in the morning, every day of week 1. The second row of the 4×7 medication organizer tray apparatus 100 contains medications 112 that are to be taken in the evening, every day of week 1. The third row of the 4×7 medication organizer tray apparatus 100 contains medications 112 that are to be taken in the morning, every day of week 2. The fourth row of the 4×7 medication organizer tray apparatus 100 contains medications 112 that are to be taken in the evening, every day of week 2.

FIG. 19D exemplarily illustrates a 4×7 medication organizer tray apparatus 100 containing a medication dosage for a month or for four weeks. The first row of the 4×7 medication organizer tray apparatus 100 contains medications 112 that are to be taken every day of week 1, once a day. The second row of the 4×7 medication organizer tray apparatus 100 contains medications 112 that are to be taken every day of week 2, once a day. The third row of the 4×7 medication organizer tray apparatus 100 contains medications 112 that are to be taken every day of week 3, once a day. The fourth row of the 4×7 medication organizer tray apparatus 100 contains medications 112 that are to be taken every day of week 4, once a day.

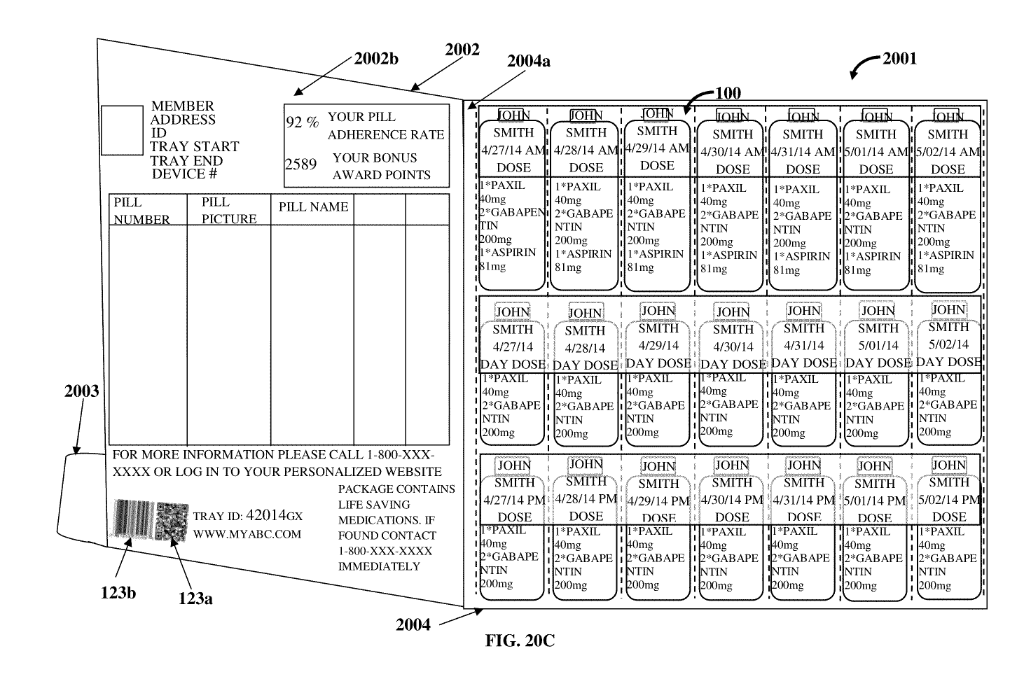

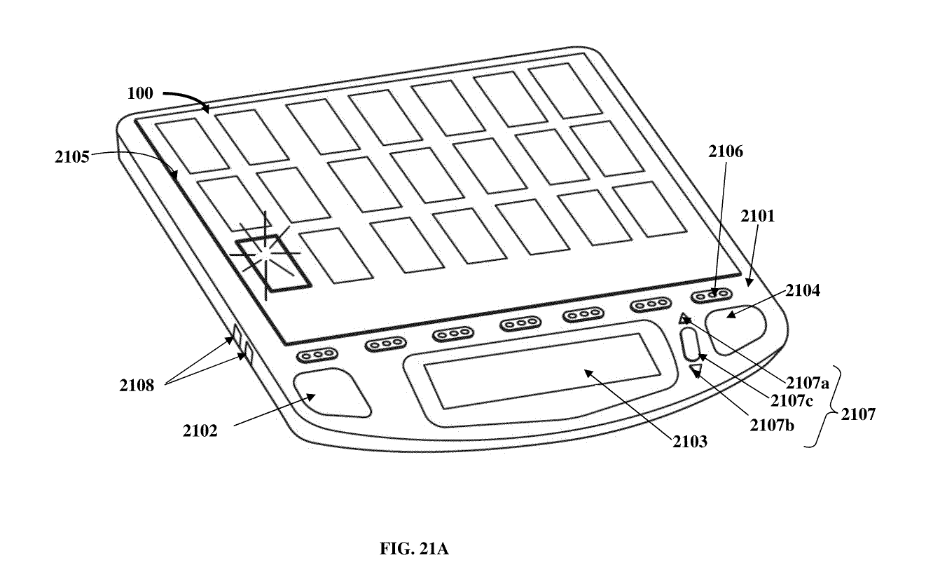

FIGS. 20A-20B exemplarily illustrate different views of a cover jacket 2001 configured to cover and accommodate the medication organizer tray apparatus 100 exemplarily illustrated in FIG. 20C. The cover jacket 2001 securely accommodates the medication organizer tray apparatus 100, thereby facilitating easy transportation and storage of the medication organizer tray apparatus 100. FIG. 20C exemplarily illustrates the medication organizer tray apparatus 100 accommodated within the cover jacket 2001. In an embodiment, the cover jacket 2001 is configured as a foldable jacket comprising a top panel 2002 exemplarily illustrated in FIGS. 20A-20C, and a bottom panel 2004 exemplarily illustrated in FIGS. 20B-20C. FIG. 20A exemplarily illustrates a top plan view of the cover jacket 2001, showing a front surface 2002a of the top panel 2002 of the cover jacket 2001. In an embodiment, the front surface 2002a of the top panel 2002 comprises information specific to a healthcare recipient comprising, for example, personalized images, personalized messages, a company name, healthcare recipient information, etc., printed thereon as exemplarily illustrated in FIG. 20A. The top panel 2002 comprises a tab 2003 for opening the cover jacket 2001 as exemplarily illustrated in FIGS. 20A-20C.

FIGS. 20B-20C exemplarily illustrate top perspective views of the cover jacket 2001, showing the top panel 2002 and the bottom panel 2004 of the cover jacket 2001. In an embodiment, a rear surface 2002b of the top panel 2002 comprises, for example, information specific to medications 112 contained in each medication bin 102 of the medication organizer tray apparatus 100, information specific to a patient to whom the medication organizer tray apparatus 100 is prescribed, incentives for medication adherence, status of incentives such as reward points status, the identifier codes 123a and 123b of the medication organizer tray apparatus 100, etc. In an embodiment, the bottom panel 2004 of the cover jacket 2001 comprises multiple slots 2005 that allow insertion of the medication bins 102 of the medication organizer tray apparatus 100 through the slots 2005. The medication organizer tray apparatus 100 is removably attached to a front surface 2004a of the bottom panel 2004 and the medication bins 102 of the medication organizer tray apparatus 100 are inserted through the slots 2005 of the bottom panel 2004. When a healthcare recipient receives the medication organizer tray apparatus 100 in the cover jacket 2001 from a pharmacy, he/she places the medication organizer tray apparatus 100 together with the cover jacket 2001 into the receptacle base 2101 exemplarily illustrated in FIGS. 21A-21B and FIG. 22. In an embodiment, the cover jacket 2001 is removed prior to placing the medication organizer tray apparatus 100 into the receptacle base 2101.

FIGS. 21A-21B exemplarily illustrate different views showing the medication organizer tray apparatus 100 inserted into the receptacle base 2101. FIG. 21A exemplarily illustrates a top perspective view of the medication organizer tray apparatus 100 inserted into the receptacle base 2101. FIG. 21B exemplarily illustrates a side perspective view of the medication organizer tray apparatus 100 inserted into the receptacle base 2101. The receptacle base 2101 is a base that holds the medication organizer tray apparatus 100 with prefilled medications 112 exemplarily illustrated in FIG. 1B. In an embodiment, the receptacle base 2101 comprises a receptacle 2105, a loudspeaker 2102, a display screen 2103 such as a liquid crystal display (LCD) screen, and a call button 2104. The medication organizer tray apparatus 100 is inserted into the receptacle 2105 of the receptacle base 2101. The receptacle base 2101 plays personalized audio messages such as “grandma thank you for taking your medication” or chimes to communicate or talk to a healthcare recipient via the loudspeaker 2102, and displays personalized text messages, adherence status, a clock interface that displays time, etc., on the display screen 2103. In an embodiment, the loudspeaker 2102 vocalizes a serial identifier that matches a healthcare recipient identifier. Furthermore, when the medication organizer tray apparatus 100 is inserted into the receptacle base 2101, the receptacle base 2101 extracts messages and other medication adherence information from the electronic identification component 103 and annunciates the messages at the right dose and alarm time and other times as programmed via the loudspeaker 2102.

In an embodiment, the display screen 2103 displays a serial identifier that matches a healthcare recipient identifier. The call button 2104 of the receptacle base 2101 allows a healthcare recipient to call or connect with a healthcare provider or an advisor. The healthcare provider or the advisor responds, when the call button 2104 is pressed by the healthcare recipient. The receptacle base 2101 further comprises adherence indicators 2106 that are configured to indicate behavior of a healthcare recipient based on medication adherence. The adherence indicators 2106 change colors based on medication adherence of the healthcare recipient. The receptacle base 2101 further comprises additional buttons 2107 to allow the healthcare recipients to communicate with the healthcare provider or select options. The additional buttons 2107 comprise, for example, an “up” button 2107a, a “down” button 2107b, and a “select” button 2107c as exemplarily illustrated in FIG. 21A. In an embodiment, the receptacle base 2101 allows connection, for example, to a computing device, for example, a cell phone, a smartphone, etc., via universal serial bus (USB) ports 2108. The USB ports 2108 are spaced appropriately to hold, for example, two dongles at one time.

In an embodiment, the receptacle base 2101 comprises a lid 2109 with sensor bars, hereinafter referred to as “clamp bars” 2110, as exemplarily illustrated in FIG. 21B, for keeping the medication organizer tray apparatus 100 from flapping and ensuring a strong electrical connection between the medication organizer tray apparatus 100 and the receptacle base 2101, when closed. In an embodiment, the receptacle base 2101 comprises, for example, eight clamp bars 2110. The lid 2109 with the clamp bars 2110 is pushed down by a healthcare recipient or a healthcare provider after placing the medication organizer tray apparatus 100 in the receptacle base 2101, leaving the medication bins 102 exemplarily illustrated in FIG. 21B, exposed through the clamp bars 2110. In an embodiment, a diffused material 130 is deposited on a cut 129 configured on each medication bin 102 as exemplarily illustrated in FIG. 21B. The diffused material 130 indicates one or more dosage times of the medications 112 in each medication bin 102 and/or a message specific to each medication bin 102. In an embodiment, the diffused material 130 configured as a blinking light on the medication bin 102 can indicate that there is a message for that specific medication bin 102, for example, a message indicating medications 112 in that medication bin 102 have changed, a message indicating not to take the medications 112 as that dose period has expired, specific instructions on how to take the medications 112, etc. The diffused material 130 is configured as a diffused light source and deposited on the raised bump front edge 115 of each of the medication bins 102 to light the raised bump front edge 115 of each of the medication bins 102 as exemplarily illustrated in FIG. 21B. The lit raised bump front edge 115 of a medication bin 102 shows the healthcare recipient which raised bump front edge 115 of a medication bin 102 needs to be raised and hence which medication bin 102 needs to be opened. This lighting arrangement of the medication organizer tray apparatus 100 assists healthcare recipients with dementia and forgetfulness who may have difficulty in remembering, for example, a day, a date, or a time for consuming the medications 112 and who need to be directed to remove or open a correct medication bin 102. In an embodiment, for proper adhesive application of the bin cover layer 104 on the medication bins 102 of the medication organizer tray apparatus 100 exemplarily illustrated in FIGS. 2A-2B, at a pharmacy, or for stacking for storage before shipment, or transport of the medication organizer tray apparatus 100, the medication bins 102 are configured without the raised bump front edges 115. In this embodiment, the raised bump front edges 115 of the medication bins 102 are raised at the time of inserting the medication organizer tray apparatus 100 into the receptacle base 2101.

FIG. 22 exemplarily illustrates a top plan view of an embodiment of the receptacle base 2101 accommodating the medication organizer tray apparatus 100. The receptacle base 2101 disclosed herein comprises a loudspeaker 2102, a display screen 2103 such as a liquid crystal display (LCD) screen, and a call button 2104. The receptacle base 2101 plays audio messages via the loudspeaker 2102 and displays text messages and an adherence status on the display screen 2103. The call button 2104 of the receptacle base 2101 allows a healthcare recipient to call a healthcare provider. The receptacle base 2101 further comprises additional buttons, for example, an “up” button 2107a and a “down” button 2107b to allow the healthcare recipients to select options.

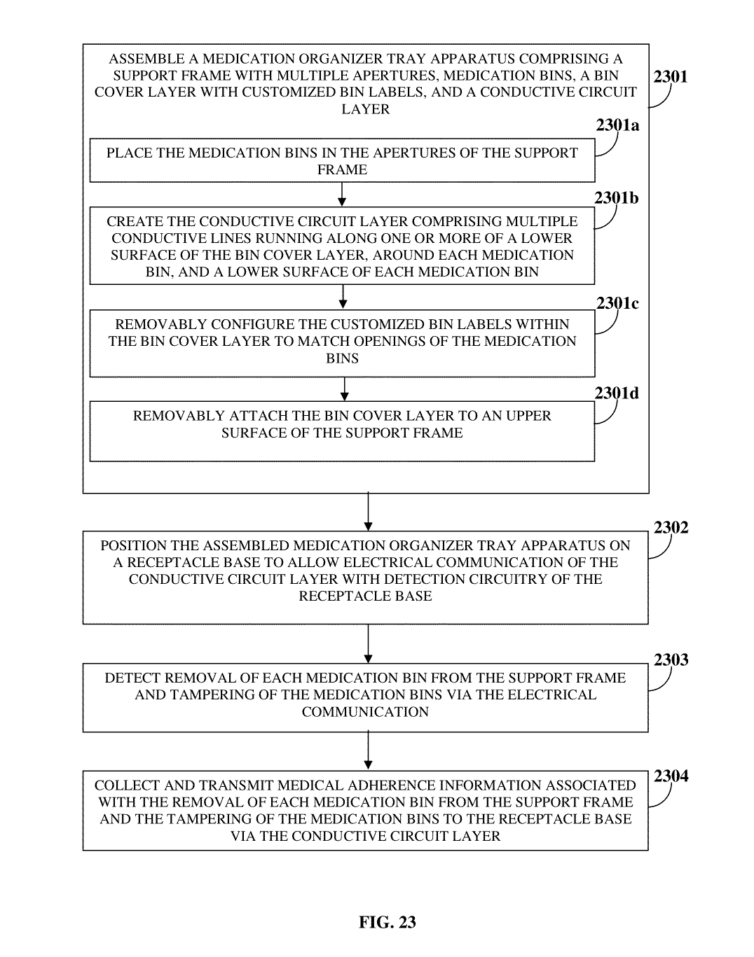

FIG. 23 illustrates a method for organizing medications 112 exemplarily illustrated in FIG. 1B, FIG. 9, and FIGS. 11A-11B, and collecting medication adherence information. The method disclosed herein comprises assembling 2301 the medication organizer tray apparatus 100 comprising the support frame 101 with multiple apertures 111 positioned at predefined intervals from each other, multiple medication bins 102, the bin cover layer 104 with multiple customized bin labels 106, and the conductive circuit layer 107 as exemplarily illustrated in FIGS. 1A-1C and as disclosed in the detailed description of FIGS. 1A-1C. The medication bins 102 are placed 2301a in the apertures 111 of the support frame 101 exemplarily illustrated in FIG. 1B. The medication bins 102 accommodate multiple medications 112. In an embodiment, a medication dispensing system 2401 exemplarily illustrated in FIG. 24, captures an image of an upper surface 101a and a lower surface 101b of the support frame 101 of the medication organizer tray apparatus 100 exemplarily illustrated in FIGS. 1A-1B, after filling of the medication organizer tray apparatus 100 with the medications 112. The images are captured before attaching the bin cover layer 104 to the upper surface 101a of the support frame 101 as exemplarily illustrated in FIG. 18B. The conductive circuit layer 107 comprising multiple conductive lines 108 running along one or more of the lower surface 104b of the bin cover layer 104, around each medication bin 102, and the lower surface 102a of each medication bin 102 is created 2301b. The customized bin labels 106 exemplarily illustrated in FIG. 1A, FIGS. 2A-2B, FIGS. 8-9, and FIGS. 14A-14D, are removably configured 2301c within the bin cover layer 104 to match openings 117 of the medication bins 102 exemplarily illustrated in FIG. 7, FIG. 10, and FIG. 18B. The customized bin labels 106 comprise medical information printed thereon. The bin cover layer 104 is removably attached 2301d to the upper surface 101a of the support frame 101. The customized bin labels 106 of the bin cover layer 104 affixed to the upper surface 101a of the support frame 101 seals the openings 117 of the medication bins 102.

The assembled medication organizer tray apparatus 100 is positioned 2302 on the receptacle base 2101 exemplarily illustrated in FIGS. 21A-21B and FIG. 22, to allow electrical communication of the conductive circuit layer 107 of the assembled medication organizer tray apparatus 100 with the detection circuitry 1601 of the receptacle base 2101 exemplarily illustrated in FIG. 16C. Removal of each medication bin 102 from the support frame 101 and tampering of the medication bins 102 are detected 2303 via the electrical communication between the conductive circuit layer 107 of the assembled medication organizer tray apparatus 100 and the detection circuitry 1601 of the receptacle base 2101. In an embodiment, a power source (not shown) is electrically connected to the conductive circuit layer 107 of the assembled medication organizer tray apparatus 100. In an embodiment, the power source supplies minimal power at predetermined time intervals to the conductive circuit layer 107 to enable detection of a break in the conductive circuit layer 107 that is in electric communication with the receptacle base 2101, when one or more of the medication bins 102 are removed from the support frame 101. In another embodiment, the power source supplies a constant power supply of a minimal magnitude to the conductive circuit layer 107 to enable detection of a break in the conductive circuit layer 107 that is in electric communication with the receptacle base 2101, when one or more of the medication bins 102 are removed from the support frame 101.

The assembled medication organizer tray apparatus 100 collects and transmits 2304 medication adherence information associated with the removal of each medication bin 102 from the support frame 101 and the tampering of the medication bins 102, to the receptacle base 2101 via the conductive circuit layer 107. The medication adherence information indicates, for example, which of the medication bins 102 is removed from the support frame 101 for ensuring medication adherence by a healthcare recipient and verifying the presence of medications 112 in each medication bin 102. The electronic identification component 103 exemplarily illustrated in FIGS. 17A-17B, is embedded into the support frame 101 during assembly of the medication organizer tray apparatus 100. The electronic identification component 103 is configured to electrically communicate with the receptacle base 2101. The electronic identification component 103 identifies the medication organizer tray apparatus 100 for verifying the presence of medications 112 in each medication bin 102, and stores and exchanges the medication adherence information with the receptacle base 2101.

FIG. 24 exemplarily illustrates a side perspective view of a medication dispensing system 2401 for filling the medication organizer tray apparatus 100 with medications 112 exemplarily illustrated in FIG. 1B. Multiple medication bins 102 of different shapes or sizes accommodate medications 112 of different types, for example, parenterals 112c, oral medications, blister packed medications 112b exemplarily illustrated in FIG. 6, etc., in the medication organizer tray apparatus 100 as disclosed in the detailed description of FIGS. 1A-1C and FIG. 6. In an embodiment, up to eight medication organizer tray apparatuses 100 can be placed in the medication dispensing system 2401. The medication dispensing system 2401 fills medications 112 into the medication organizer tray apparatus 100 using a manual dispenser or a robotic dispenser 2402 as exemplarily illustrated in FIG. 24. In an embodiment, the medication dispensing system 2401 captures an image of the medication organizer tray apparatus 100 after the filling process is complete. Once the filling is complete, each medication organizer tray apparatus 100 is manually removed, checked, and sealed with the bin cover layer 104 configured with the customized bin labels 106 exemplarily illustrated in FIG. 1A, FIGS. 2A-2B, FIGS. 8-9, and FIGS. 14A-14D, and the other component layers, for example, 303, 304, 305, 307, 308, 309, etc., exemplarily illustrated in FIG. 3, of the medication organizer tray apparatus 100 by a pharmacist or a pharmacy technician.

FIG. 25 exemplarily illustrates communication between the medication organizer tray apparatus 100 inserted in the receptacle base 2101, and a backend server 2502 and a user device 2503 via a network 2501. The user device 2503 is an electronic device, for example, a personal computer, a tablet computing device, a mobile computer, a mobile phone, a smartphone, a portable computing device, a laptop, a touch centric device, a workstation, a portable electronic device, a network enabled computing device, an interactive network enabled communication device, any other suitable computing equipment, combinations of multiple pieces of computing equipment, etc. Computing equipment, for example, one or more servers may be associated with one or more online services. The network 2501 is, for example, the internet, an intranet, a wired network, a wireless network, a communication network that implements Bluetooth® of Bluetooth Sig, Inc., a network that implements Wi-Fi® of Wi-Fi Alliance Corporation, an ultra-wideband communication network (UWB), a wireless universal serial bus (USB) communication network, a communication network that implements ZigBee® of ZigBee Alliance Corporation, a general packet radio service (GPRS) network, a mobile telecommunication network such as a global system for mobile (GSM) communications network, a code division multiple access (CDMA) network, a third generation (3G) mobile communication network, a fourth generation (4G) mobile communication network, a long-term evolution (LTE) mobile communication network, a public telephone network, etc., a local area network, a wide area network, an internet connection network, an infrared communication network, etc., or a network formed from any combination of these networks.

The conductive circuit layer 107 of the medication organizer tray apparatus 100 sends sensor signals that comprise medication adherence information to the detection circuitry 1601 of the receptacle base 2101 as exemplarily illustrated in FIGS. 16A-16C and as disclosed in the detailed description of FIGS. 16A-16C. The receptacle base 2101 then transmits the medication adherence information to the backend server 2502 via the network 2501. The backend server 2502 processes the medication adherence information and transmits the processed medication adherence information to the user device 2503 via the network 2501. In an embodiment, the backend server 2502 is implemented in a cloud computing environment. As used herein, “cloud computing environment” refers to a processing environment comprising configurable computing physical and logical resources, for example, networks, servers, storage, applications, services, etc., and data distributed over the network 2501, for example, the internet. The cloud computing environment provides on-demand network access to a shared pool of the configurable computing physical and logical resources. The backend server 2502 is a cloud computing based platform implemented as a service for receiving medication adherence information collected from the medication organizer tray apparatus 100 and transmitting the received medication adherence information to the user device 2503 via the network 2501. The backend server 2502 is a cloud computing web based server developed, for example, using Microsoft®.NET, the Oracle® database server, etc. In an embodiment, the backend server 2502 is hosted in a cloud computing environment, for example, at a customer premise, a company premise, a remote hosting center, etc.

The pill station manager application 2504 downloadable and executable on the user device 2503 displays the medication adherence information received from the backend server 2502 to a user via a graphical user interface (GUI) 2601 exemplarily illustrated in FIG. 26, provided by the pill station manager application 2504. A user, for example, a healthcare provider can view the medication adherence information on the GUI 2601 of the user device 2503. The user device 2503 comprises a non-transitory computer readable storage medium, for example, a memory unit (not shown) configured to store computer program instructions defined by the pill station manager application 2504. As used herein, “non-transitory computer readable storage medium” refers to all computer readable media, for example, non-volatile media such as optical discs or magnetic disks, volatile media such as a register memory, a processor cache, etc., and transmission media such as wires that constitute a system bus coupled to the processor, except for a transitory, propagating signal. The user device 2503 further comprises at least one processor (not shown) communicatively coupled to the non-transitory computer readable storage medium for executing the defined computer program instructions. The backend server 2502 transmits actionable information, for example, about the medications 112 exemplarily illustrated in FIG. 1B, wellness information, loyalty program information, surveys, etc., to a user device 2901 exemplarily illustrated in FIG. 29, of a healthcare recipient who is using the medication organizer tray apparatus 100, via the network 2501.

FIG. 26 exemplarily illustrates a screenshot of an image of the medication organizer tray apparatus 100 exemplarily illustrated in FIGS. 1A-1C and FIGS. 2A-2B, filled with medications 112 exemplarily illustrated in FIG. 1B, displayed on the graphical user interface (GUI) 2601 provided by the pill station manager application 2504 on a user device 2503 exemplarily illustrated in FIG. 25. The pill station manager application 2504 stores images of the medication organizer tray apparatus 100 in a memory unit (not shown) of the user device 2503. At a pharmacy, when the medication organizer tray apparatus 100 is filled with medications 112, an image of the medication organizer tray apparatus 100 can be captured from different angles, for example, from the upper surface 101a and the lower surface 101b of the support frame 101 of the medication organizer tray apparatus 100 exemplarily illustrated in FIGS. 1A-1B, before placing the bin cover layer 104 exemplarily illustrated in FIG. 1A and FIGS. 2A-2B, on the upper surface 101a of the support frame 101. Imaging at different angles of the medication organizer tray apparatus 100 facilitates capturing of all the medications 112 in all the medication bins 102 of the medication organizer tray apparatus 100 exemplarily illustrated in FIGS. 1A-1C. In an embodiment, the receptacle base 2101 exemplarily illustrated in FIGS. 21A-21B and FIG. 22, comprises an embedded camera for capturing images of the medication organizer tray apparatus 100 from the lower surface 101b of the support frame 101 of the medication organizer tray apparatus 100. In this embodiment, the medication organizer tray apparatus 100 is then turned and placed face down using a temporary cover (not shown) to keep the medications 112 intact and in place during imaging of the upper surface 101a and the lower surface 101b of the support frame 101.

In another embodiment, a standard scanner is used to capture, store, and forward images to the pill station manager application 2504 for future reference. The pill station manager application 2504 displays clear views of the medication organizer tray apparatus 100 and provides enlarged views of each medication bin 102 for clarity on the graphical user interface (GUI) 2601 as exemplarily illustrated in FIG. 26. The pill station manager application 2504 further provides a detailed table providing a list of the different drugs or medications 112 in the medication organizer tray apparatus 100, compliance urgency of each of the medications 112, medication duration, dosage details, etc., on the GUI 2601. The pill station manager application 2504 also displays the latest medication images, for example, front images and back images of each of the medications 112 as exemplarily illustrated in FIG. 26, on the GUI 2601 for medication bin reconciliation.

The pill station manager application 2504 stores the captured images in the memory unit for record purposes or transmits the captured images to a remote pharmacist to confirm the right fill. Such remote checks allow robots, technicians, or a licensed pharmacist to fill the medication organizer tray apparatus 100 and get the fill approved and signed off as per standards rules and regulations. Once the medication organizer tray apparatus 100 is approved by the licensed pharmacist, the medication organizer tray apparatus 100 is shipped to the healthcare recipients. For example, the medication organizer tray apparatus 100 is filled in one place and approved by the local pharmacist to be sent to a healthcare recipient who lives in another state. The medication organizer tray apparatus 100 is sent to the healthcare recipient after verification and/or confirmation of a correct fill by a remote pharmacist of that state.

Each image of the medication organizer tray apparatus 100 that is taken is stored and shared with healthcare providers, for example, advisors through their respective user devices 2501, for example, smartphones. The captured images can also be used by advisors or healthcare professionals to instruct healthcare recipients about their medications 112 and refer to the medications 112 by color, size, shape, etc., when guiding the healthcare recipients to remove a particular medication 112. In an embodiment, the image of the medication organizer tray apparatus 100 is also provided on a healthcare recipient portal and a healthcare provider portal for allowing the healthcare recipients, healthcare providers, home health staff, etc., to view the images. These images are also sent to healthcare recipients' user devices 2901 exemplarily illustrated in FIG. 29, for example, phones, their computer, a care giver's phone, and other physicians to visually indicate what medications 112 have been loaded into the medication organizer tray apparatus 100. This image capture can be used to verify a correct fill in incidences of incorrect filling reporting by healthcare recipients who may be abusing, diverting, or hoarding the medications 112.

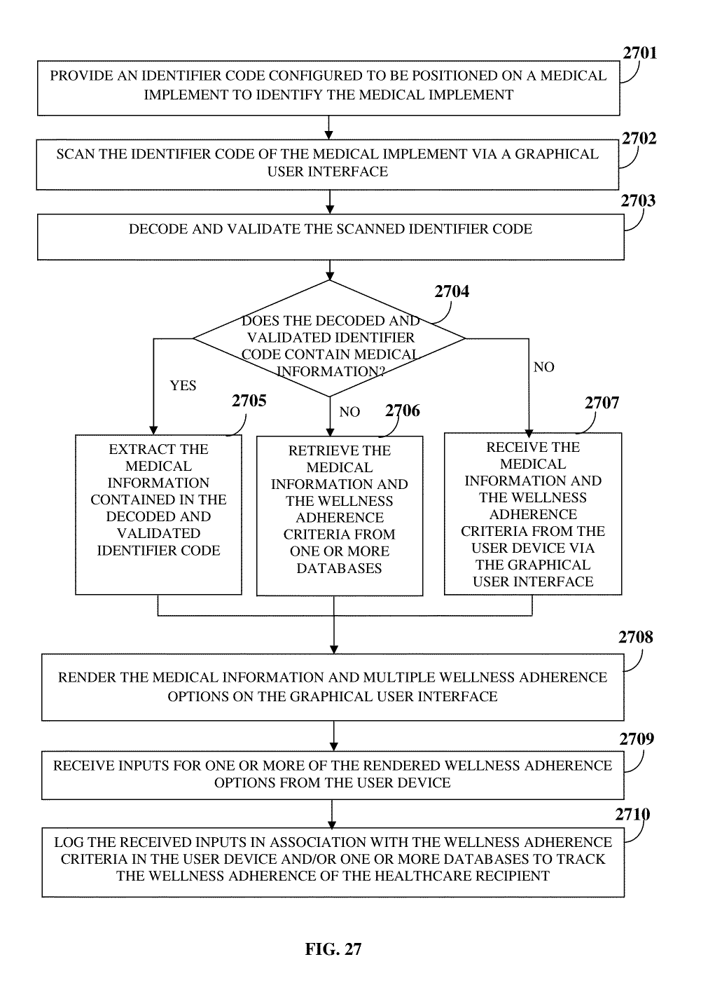

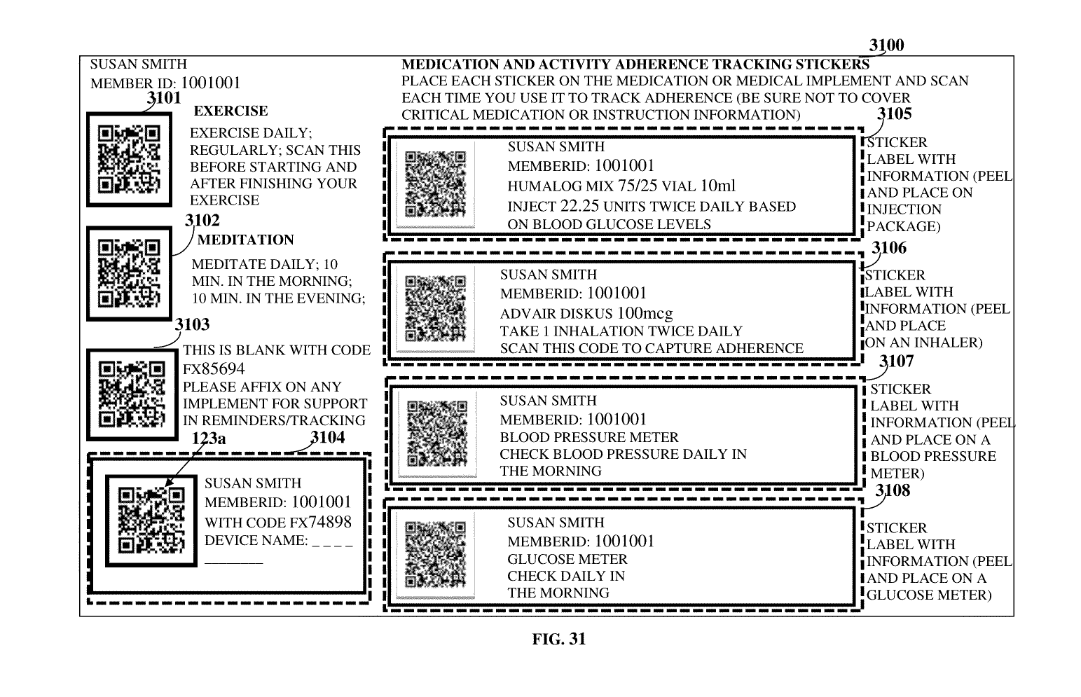

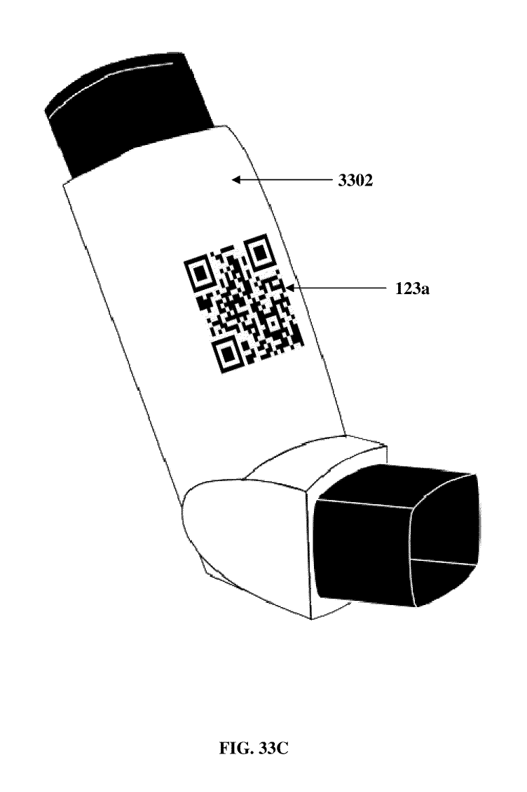

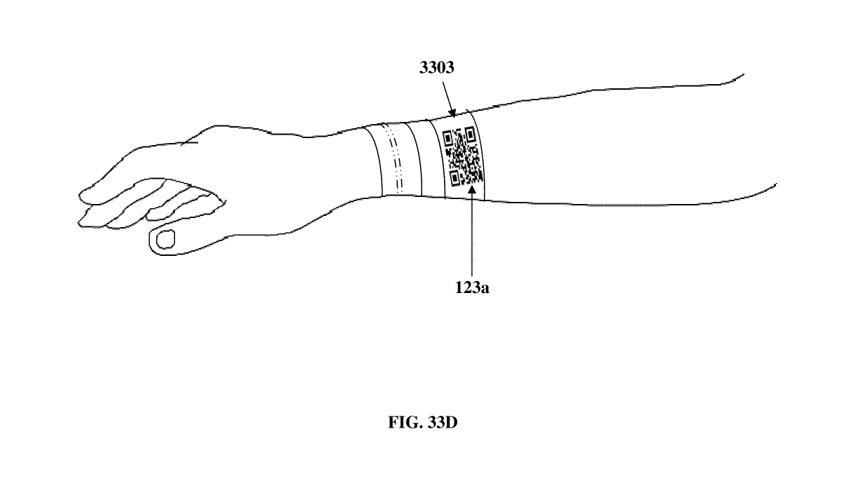

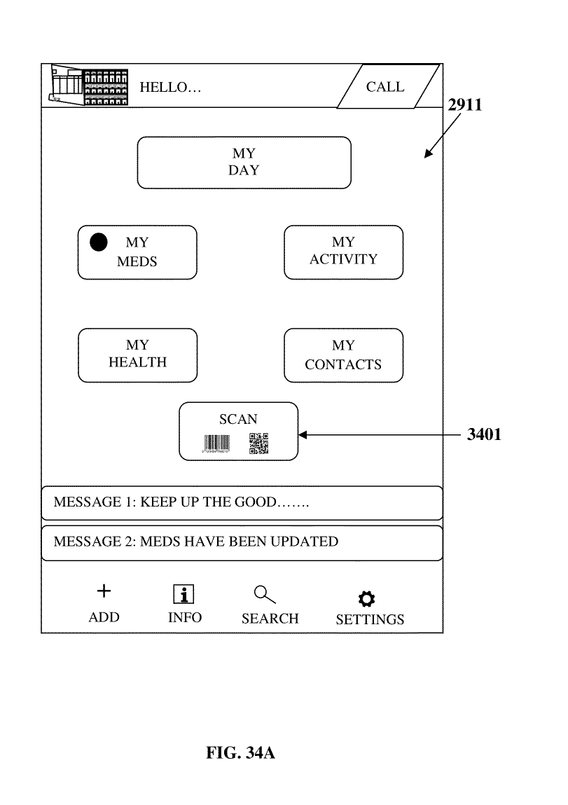

FIG. 27 illustrates a method for tracking wellness adherence of a healthcare recipient. As used herein, “wellness adherence” refers to compliance of healthcare recipients to healthcare provider prescribed medications 112 exemplarily illustrated in FIG. 1B, and/or wellness activities such as exercise, diet, wound care, etc. Tracking wellness adherence comprises, for example, tracking whether a healthcare recipient administers medicines as prescribed as well as whether the healthcare recipient continues administering the medicines for a prescribed duration. In the method disclosed herein, an identifier code 123a exemplarily illustrated in FIG. 29, FIG. 31, and FIGS. 33A-33D, configured to be positioned on a medical implement 2913 exemplarily illustrated in FIG. 29, to identify the medical implement 2913 is provided 2701. As used herein, “identifier code” refers to a machine readable two-dimensional code rendered on an optical label comprising, for example, square dots arranged in a square grid on a white background, containing a substantial amount of information about a medical implement 2913 to which the optical label is attached. The identifier code 123a is, for example, a quick response (QR) code. Also, as used herein, “medical implement” refers to any item used in a medical activity or a wellness activity, on which the identifier code 123a can be affixed for tracking wellness adherence of a healthcare recipient. The medical implement 2913 is, for example, a medication bin 102 exemplarily illustrated in FIGS. 1A-1C, configured to store one or more medications 112, a parenteral device 3302 exemplarily illustrated in FIG. 33C, a fitness device, a medical identification card 3301 exemplarily illustrated in FIG. 33B, a medical wellness plan, the medication organizer tray apparatus 100 exemplarily illustrated in FIGS. 1A-1C and FIGS. 2A-2B, etc.

In an embodiment, the identifier code 123a is printed on the medical implement 2913. In another embodiment, the identifier code 123a is fastened to the medical implement 2913, for example, using glue. In another embodiment, the identifier code 123a is etched on the medical implement 2913. The identifier code 123a is configured in multiple sizes, for example, in about a 20 millimeter (mm) square, and is printed in black and white colors. The identifier code 123a is configured to be positioned on multiple surfaces of the medical implement 2913, for example, at the center on an upper surface 102c of a medication bin 102 exemplarily illustrated in FIG. 10 and FIG. 12, or on one of the inner surfaces, for example, on a bottom surface 106b of a customized bin label 106 that covers the medication bin 102 as exemplarily illustrated in FIG. 33A. The identifier code 123a is configured to be positioned on a medical implement 2913, for example, a parenteral device 3302 exemplarily illustrated in FIG. 33C, containing one week's dose of a medication and which is not discarded after taking a single dose of the medication. In the method disclosed herein, an additional identifier code 123a is pre-printed on paper and configured as an identifier code sticker along with labels and notes exemplarily illustrated in FIG. 31, to allow a healthcare recipient to enter information related to medications 112 or a medical implement 2913 on the labels or on the notes and then stick the labels and the notes along with the identifier code 123a on the medical implement 2913. The identifier code 123a is configured to be of use to healthcare recipients who use user devices 2901, for example, smart phones, tablet computing devices, etc., and applications such as a wellness adherence tracking application 2902 on their user devices 2901 exemplarily illustrated in FIG. 29. For example, patients who are prescribed medications 112 can use the identifier codes 123a and the wellness adherence tracking application 2902 on their smart phones, tablet computing devices, etc., to track the patients' wellness adherence.

In an embodiment, the identifier code 123a is configured to be positioned on a medication bin 102 of the medication organizer tray apparatus 100 to identify the medication bin 102, in the absence of the receptacle base 2101 exemplarily illustrated in FIGS. 21A-21B and FIG. 22, that enables detection of removal of each medication bin 102 from the support frame 101 via the conductive circuit layer 107 exemplarily illustrated in FIGS. 1A-1B. The method disclosed herein allows tracking of wellness adherence of healthcare recipients who use the medication organizer tray apparatus 100 without the receptacle base 2101 and/or without the conductive circuit layer 107. The method disclosed herein tracks the wellness adherence of a healthcare recipient using identifier codes 123a positioned on medication bins 102, when the medication bins 102 are removed from the medication organizer tray apparatus 100 and are used as standalone medication bins 102 for storing medications 112 during travel, for refrigeration of medications 112, etc. The table below summarizes different scenarios for use of the identifier code 123a on a medical implement 2913:

| Medication organizer tray apparatus/ | | |
|---|---|---|
| Receptacle base/Parenteral | Conductive | Identifier code |
| configuration | circuit layer | needed |
| Medication organizer tray apparatus | Yes | No |
| with a receptacle base | | |
| Medication organizer tray apparatus | No | Yes |
| standalone without a receptacle base | | |
| Wellness adherence tracking | No | Yes |
| application (Mobile Application) Needed | | |

As exemplarily illustrated in the table above, an identifier code 123a is used for tracking wellness adherence of a healthcare recipient when the medication organizer tray apparatus 100 is used without the receptacle base 2101 and/or without the conductive circuit layer 107. The method disclosed herein employs a wellness adherence tracking system 2900 exemplarily illustrated in FIG. 29, comprising at least one processor 3001 exemplarily illustrated in FIG. 30, configured to execute computer program instructions for tracking the wellness adherence of a healthcare recipient. The wellness adherence tracking system 2900 comprises a wellness adherence tracking application 2902 deployed on the healthcare recipient's user device 2901. The wellness adherence tracking application 2902 is a software application downloadable and usable on the healthcare recipient's user device 2901 for tracking the healthcare recipient's wellness adherence in the above tabulated scenarios. The wellness adherence tracking application 2902 on the healthcare recipient's user device 2901 communicates with the backend server 2502 of the wellness adherence tracking system 2900 via a network 2501, for example, the internet exemplarily illustrated in FIG. 29.

The identifier code 123a is exclusive, that is, unique to each medical implement 2913 for each healthcare recipient as the identifier code 123a is, for example, printed at a pharmacy, or pre-printed and sent to the pharmacy for a specific healthcare recipient, or sent directly to the healthcare recipient, for example, through mail, in person, or via electronic mail in a printable format. In an embodiment, the identifier code 123a is printed at the pharmacy using Food and Drug Administration (FDA) approved ink as there is minimal exposure of the medications 112 to the identifier code 123a. In an embodiment, additional identifier code stickers are printed, for example, on paper and supplied to the pharmacy for including the identifier code stickers in the healthcare recipient's package, where these identifier code stickers may not be positioned on the medication bins 102. In this embodiment, the additional identifier code stickers need not use the FDA approved ink. The identifier code 123a is configured to store alphanumeric data with a predefined data size in one or more of multiple formats as exemplarily illustrated in FIG. 31. The identifier code integration depends on one or more requirements comprising, for example, pharmacy printers with sufficient registration to print the identifier code 123a and the wellness adherence tracking application 2902 that requires a minimum number of clicks to scan the identifier code 123a.

A healthcare recipient can scan 2702 the identifier code 123a of the medical implement 2913 via a graphical user interface (GUI) 2911 provided by the wellness adherence tracking application 2902 of the wellness adherence tracking system 2900 accessible on the healthcare recipient's user device 2901 exemplarily illustrated in FIG. 29. The wellness adherence tracking application 2902, in communication with the backend server 2502, decodes 2703 the scanned identifier code 123a and validates the decoded identifier code 123a. The identifier code 123a is encoded, for example, encrypted, in a way that any other code scanning application apart from the wellness adherence tracking application 2902 will fail to decode the identifier code 123a. Only the wellness adherence tracking application 2902 can decode the identifier code 123a. If another code scanning application attempts to decode the identifier code 123a, the identifier code 123a redirects the healthcare recipient, who is scanning the identifier code 123a, to a certified website of the wellness adherence tracking system 2900 to download the wellness adherence tracking application 2902. In an embodiment, the identifier code 123a contains a common key for decoding the identifier code 123a. In another embodiment, only the healthcare recipient and his/her healthcare providers can decode the identifier code 123a using their respective keys. For example, the identifier code 123a positioned on a bottom surface 106b of a customized bin label 106 that seals the medication bin 102 exemplarily illustrated in FIG. 33A, can only be read by the wellness adherence tracking application 2902 deployed on authorized user devices 2901, for example, mobile phones, of the healthcare recipient and his/her healthcare provider and not by any other healthcare recipient or another healthcare provider having the same wellness adherence tracking application 2902. This type of security precludes another healthcare recipient having the same wellness adherence tracking application 2902 from reading the identifier code 123a and obtaining another healthcare recipient's medical information or accessing a wellness adherence database 2915 of the backend server 2502 exemplarily illustrated in FIG. 29, through a server website account. This type of security also strengthens the privacy of the healthcare recipient in accordance with Health Insurance Portability and Accountability Act (HIPAA) regulations.

In an embodiment, the identifier code 123a comprises one or more authentication codes embedded therein for validation of the identifier code 123a with reference to authentication codes stored by the wellness adherence tracking system 2900 in the healthcare recipient's user device 2901 and/or one or more databases, for example, the wellness adherence database 2915 of the backend server 2502. In an example, an authentication code and a healthcare recipient code is encrypted and embedded in the identifier code 123a, for example, a quick response (QR) code. The wellness adherence tracking application 2902, upon scanning the identifier code 123a, decrypts the identifier code 123a and searches for the authentication code and the healthcare recipient code. In an embodiment, the authentication codes are positioned in a specific known location or tagged with a header or a footer such that the wellness adherence tracking application 2902 recognizes the authentication codes from a data snippet. If the wellness adherence tracking application 2902 matches the identified authentication code to an internal single or multiple authentication code, then the identifier code 123a and an associated message embedded in the identifier code 123a is authentic and valid. If the identified authentication code does not match with the internal single or multiple authentication code, then the wellness adherence tracking application 2902 discards the identifier code 123a and displays an error message on the graphical user interface (GUI) 2911 of the wellness adherence tracking application 2902 stating that the identifier code 123a is invalid. The identifier code 123a has a standard built-in error detection and correction option to restore data if the identifier code 123a is damaged.

The identifier code 123a assists in identifying potential counterfeit medications. In an embodiment, when the identifier code 123a is scanned, decoded, and validated, the wellness adherence tracking application 2902 renders a message on the GUI 2911 on the healthcare recipient's user device 2901 to validate, for example, sources or purchase locations of medications 112. Furthermore, the wellness adherence tracking application 2902 requests the healthcare recipient to key into a device medication identification (ID) serial number and enter the location of purchase of a medication 112 to further validate the authenticity of the medical implement 2913, for example, the medication bin 102 that stores the medication 112. In an embodiment, the wellness adherence tracking system 2900 transmits an alert notification on the GUI 2911, for example, based on a validation status of the decoded identifier code 123a. The validation status of the decoded identifier code 123a is, for example, valid or invalid. The alert notification warns the healthcare recipient of an invalid identifier code.

In an embodiment, the wellness adherence tracking system 2900 performs encryption and decryption of the authentication codes and messages embedded in the identifier code 123a using, for example, public-key cryptography which uses an asymmetric key pair having a public key and a private key. The public key is publicly available and the private key is kept secret. The authentication codes, the messages, and other medical information stored in the identifier code 123a are encrypted with the public key and decrypted only with the private key. In another embodiment, the wellness adherence tracking system 2900 executes a pretty good privacy (PGP) data encryption and decryption computer program that provides cryptographic privacy and authentication for data communication. The PGP encryption and decryption computer program combines symmetric-key encryption and public-key encryption. In this embodiment, the wellness adherence tracking system 2900 encrypts the authentication codes, the messages, and other medical information in the identifier code 123a by executing a symmetric encryption algorithm using a symmetric key that is used only once. The wellness adherence tracking system 2900 encrypts the symmetric key with the public key of the healthcare recipient's user device 2901. The wellness adherence tracking system 2900 sends the symmetric key encrypted with the public key along with the identifier code 123a containing the authentication codes, the messages, and other medical information to the healthcare recipient's user device 2901, where the symmetric key is decrypted using a private key of the healthcare recipient's user device 2901 to decrypt the identifier code 123a and access the authentication codes, the messages, and other medical information.

After decoding and validating the identifier code 123a, the wellness adherence tracking application 2902 of the wellness adherence tracking system 2900 reads and obtains medical information associated with the medical implement 2913 and/or an activity associated with the medical implement 2913 from the decoded and validated identifier code 123a, for example, in a quick response format or another coded format, and wellness adherence criteria. The medical information encoded in the identifier code 123a comprises, for example, one or more of a number of medications 112 in the medical implement 2913, a list of the medications 112 in the medical implement 2913, drug names, directions to follow, color coding of dosage times, name of a prescriber, a date of preparation, a description of contents of the medical implement 2913, a personalized website link configured to link to a secure online interface comprising healthcare recipient information, a healthcare recipient identifier, etc., and any combination thereof. The activity associated with the medical implement 2913 comprises, for example, administration of one or more medications 112, an exercise activity, a diet activity, wound care, a health checkup, etc. As used herein, “wellness adherence criteria” refers to one or more parameters associated with administration of medications 112 or performance of the activity that a healthcare provider prescribes to a healthcare recipient in a medication regimen or a wellness regimen. The wellness adherence criteria comprise, for example, dosage information such as amount of a medication 112, a date for administering one or more medications 112, a time of day for administering the medications 112, directions to follow, etc. In an embodiment, the wellness adherence tracking application 2902 obtains the wellness adherence criteria from the decoded and validated identifier code 123a. In another embodiment, the wellness adherence tracking application 2902 obtains the wellness adherence criteria from one or more databases, for example, the wellness adherence database 2915 of the backend server 2502 via a network 2501.

In an embodiment, the identifier code 123a comprises supplementary information comprising, for example, one or more of coupons, advertisements, incentives for wellness adherence, status of incentives, appointments for a week, reminders, quotes, images, wellness information, wellness messages, promotional messages, gaming information, quick reference telephone numbers of healthcare providers, etc., embedded therein. The incentives for wellness adherence comprise, for example, one or more awards for wellness adherence along with an award message. The wellness adherence tracking application 2902 decodes and displays the award message on the graphical user interface (GUI) 2911 of the healthcare recipient's user device 2901. The healthcare recipient, who has been rewarded for consistent wellness adherence, is directed to a website or a web link to redeem the award. The wellness messages comprise, for example, a motivational message, a healthcare recipient specific message, a generic health motivational message, a medication specific message, a disease specific message, etc. In an embodiment, the wellness adherence tracking application 2902 displays messages, for example, wellness messages contained in the identifier code 123a at the time of the scan of the identifier code 123a along with instructions. The promotional messages comprise, for example, one or more messages and a web link associated with each message for promotional purposes such as a wellness brand promotion, a wellness event promotion, etc. The wellness adherence tracking system 2900 targets messages to healthcare recipients based on specific diseases, medications 112 present, wellness adherence rates of the healthcare recipient, etc. The wellness adherence tracking system 2900 renders discounts and award points to healthcare recipients who opt to receive the promotional messages. The wellness adherence tracking system 2900 does not transmit the promotional messages to premium healthcare recipients. The wellness adherence tracking system 2900 encodes the medical information in the identifier code 123a to allow the wellness adherence tracking application 2902 to decode the medical information.

The wellness adherence tracking application 2902 determines 2704 whether the decoded and validated identifier code 123a contains the encoded medical information, for example, using a key that is embedded in the wellness adherence tracking application 2902. If the identifier code 123a contains the encoded medical information, the wellness adherence tracking application 2902 extracts 2705 the medical information directly from the decoded and validated identifier code 123a. In an embodiment, if the medical information is not available in the decoded and validated identifier code 123a, the wellness adherence tracking application 2902 transmits the decoded and validated identifier code 123a to one or more databases, for example, an internal application database 2912, the wellness adherence database 2915 in the backend server 2502, or one or more public databases 2916 via a network 2501 exemplarily illustrated in FIG. 29, and retrieves 2706 the medical information and the wellness adherence criteria from the databases, for example, 2912, 2915, or 2916. The wellness adherence tracking application 2902 loads the extracted medical information and the wellness adherence criteria in the internal application database 2912 for performing further actions on the extracted medical information and the wellness adherence criteria. In this embodiment, if the medical information is not available in the decoded and validated identifier code 123a, the wellness adherence tracking system 2900 prompts the wellness adherence tracking application 2902 and the internal application database 2912. If the medical information does not exist in the wellness adherence tracking application 2902 and the internal application database 2912, the wellness adherence tracking application 2902 connects to the backend server 2502 or to one or more public databases 2916 via the network 2501 to retrieve the medical information and the wellness adherence criteria.

In an embodiment, if the encoded medical information becomes outdated over time and requires updates, the medical information is updated in one or more databases, for example, the wellness adherence database 2915 at the backend server 2502 to which the identifier code 123a can link, or to which the wellness adherence tracking application 2902 on the healthcare recipient's user device 2901 can link to retrieve the medical information. In another embodiment, the wellness adherence tracking application 2902 may also prompt the healthcare recipient to enter the medical information and the wellness adherence criteria via the graphical user interface (GUI) 2911 of the wellness adherence tracking application 2902. The wellness adherence tracking system 2900 receives 2707 the entered medical information and the wellness adherence criteria from the healthcare recipient's user device 2901 via the GUI 2911. In this embodiment, each time the healthcare recipient scans the identifier code 123a, the user entered medical information is displayed on the GUI 2911.

In an embodiment, the wellness adherence tracking application 2902, in communication with the user device 2901 and/or the backend server 2502, validates the medical information associated with the medical implement 2913 and/or the activity associated with the medical implement 2913 and loads valid medical information into the internal application database 2912 for performing actions on the valid medical information. For example, the wellness adherence tracking application 2902 verifies whether the decoded data from the identifier code 123a is correct, incorrect, counterfeit, or not readable. If the decoded data is incorrect, not readable, or counterfeit, then the wellness adherence tracking application 2902 transmits the decoded data to a data logger 2909 exemplarily illustrated in FIG. 29, or to the backend server 2502 that logs the decoded data for further analysis. In an embodiment, the wellness adherence tracking system 2900 renders an alert notification via the graphical user interface (GUI) 2911 of the wellness adherence tracking application 2902 on identifying invalid medical information. That is, the backend server 2502 transmits an alert notification to the wellness adherence tracking application 2902 on the healthcare recipient's user device 2901 and a healthcare provider's user device 2503 exemplarily illustrated in FIG. 25, to warn them of a contaminated identifier code and of a potential malicious attack. In an embodiment, the wellness adherence tracking system 2900 transmits an alert notification on the GUI 2911, for example, based on a validation status of the medical information contained in the decoded identifier code 123a. The validation status of the medical information is, for example, valid or invalid. The alert notification warns the healthcare recipient of invalid medical information.

In an embodiment, the wellness adherence tracking application 2902 on the healthcare recipient's user device 2901 validates the decoded data containing the medical information by executing a hash function on the decoded data for determining whether the decoded data is incorrect, not readable, or counterfeit. The wellness adherence tracking application 2902 executes the hash function on the decoded data and generates a key digest. A key digest is a type of hash that provides a fingerprint for the decoded data. The wellness adherence tracking application 2902 transmits the decoded data encrypted by the hash function and the key digest to the backend server 2502. The backend server 2502 executes an algorithm to encrypt the decoded data and runs a hash function on the decoded data again. If the key digest generated by the hash function at the backend server 2502 matches the key digest that was transmitted by the wellness adherence tracking application 2902, the healthcare recipient can conclude that the decoded data is intact and not tampered with, and that no data snippets have been injected into the decoded data.

The wellness adherence tracking application 2902 renders 2708 the extracted and validated medical information and multiple wellness adherence options on the graphical user interface (GUI) 2911. The wellness adherence options comprise, for example, indicators that define administration and non-administration of one or more medications 112 such as medication taken or medication not taken, presence and absence of medications 112 in the medical implement 2913 such as medication missing, performance and non-performance of the activity associated with the medical implement 2913, a percentage of performance of the activity such as exercise performed for half of the prescribed duration, an abortion of the activity, an establishment of communication with a prescriber of the activity, time settings for the administration of the medications 112 and the performance of the activity within preconfigured time periods such as exercise performance snoozed till a future time instant, etc.

In an embodiment, the wellness adherence tracking system 2900 configures the wellness adherence options in accordance with the wellness adherence criteria and/or user inputs received via the graphical user interface (GUI) 2911 of the wellness adherence tracking application 2902. The wellness adherence tracking system 2900 identifies possibilities of wellness adherence based on adherence of the healthcare recipient to the prescribed wellness adherence criteria and accordingly configures the wellness adherence options. Consider an example where the prescribed wellness adherence criteria comprises administering two pills each day and reducing the number of pills to be taken per day to one pill after a certain number of days. The healthcare provider makes a decision on the number of pills to be taken per day by the healthcare recipient. In this example, the wellness adherence tracking system 2900 configures the wellness adherence criteria as “2 pills per day to 1 pill per day” and renders wellness adherence options as pills taken, pills not taken, pill consumption reduced, and pill consumption snoozed on the GUI 2911.

The healthcare recipient provides inputs for one or more of the rendered wellness adherence options, for example, by checking a box displayed on the graphical user interface (GUI) 2911, entering the number of pills taken, activating a snooze button displayed on the GUI 2911, etc. The wellness adherence tracking application 2902 receives 2709 the inputs for one or more of the rendered wellness adherence options from the healthcare recipient's user device 2901 via the GUI 2911. The wellness adherence tracking application 2902 logs 2710 the received inputs in association with the wellness adherence criteria in the user device 2901 and/or one or more databases, for example, the wellness adherence database 2915 of the backend server 2502, to track the wellness adherence of the healthcare recipient. In an embodiment, the wellness adherence tracking application 2902, in communication with the backend server 2502, compares the received inputs with the wellness adherence criteria and determines whether the healthcare recipient has achieved wellness adherence or not.

Consider an example where prescribed wellness adherence criteria from a medication regimen comprises a dosage of a pill to be taken once per day post breakfast, a capsule to be taken once per day post dinner, and a brisk walk to be performed for 45 minutes per day. The wellness adherence criteria therefore comprise 1 pill to be taken between 7 am and 10 am, 1 capsule to be taken between 7 pm and 12 pm, and an exercise activity to be performed for 45 minutes. Based on the wellness adherence criteria, the wellness adherence tracking system 2900 configures the wellness adherence options per medication, for example, the pill and the capsule, and the exercise activity as follows: for medication 1, pill administered, pill not administered, pill administration snoozed, and pill missing. Similarly, for medication 2, the configured wellness adherence options comprise, for example, capsule administered, capsule not administered, capsule administration snoozed, and capsule missing. For the exercise activity, the configured wellness adherence options comprise, for example, activity performed, activity not performed, activity snoozed, and activity partially performed. Assuming the healthcare recipient selects pill administered, capsule administered, and activity performed, the wellness adherence tracking system 2900 compares the user selections and logging times of the user selections with the wellness adherence criteria and determines that the healthcare recipient has achieved wellness adherence. In an embodiment, the wellness adherence tracking system 2900 transmits alert notifications on the GUI 2911, for example, based on time settings configured on the healthcare recipient's user device 2901. The wellness adherence tracking system 2900 configures the alert notifications to remind the healthcare recipient to perform one or more actions to meet the wellness adherence criteria. For example, these alert notifications remind a healthcare recipient to perform an incomplete activity that was snoozed by the healthcare recipient.

In an embodiment, the wellness adherence tracking application 2902 transmits alerts to the healthcare recipient via the graphical user interface (GUI) 2911 for capturing one or more images in one or more views of a medical implement 2913, for example, the medication organizer tray apparatus 100 exemplarily illustrated in FIGS. 1A-1C and FIGS. 2A-2B, at configurable time instants. The backend server 2502 of the wellness adherence tracking system 2900 then verifies the type, number, and arrangement of medications 112 in the medication bins 102 of the medication organizer tray apparatus 100 exemplarily illustrated in FIG. 1B, in accordance with the wellness adherence criteria prescribed by the healthcare provider using the captured images for tracking the wellness adherence of the healthcare recipient in accordance with the wellness adherence criteria. In this embodiment, the healthcare recipient may use an image capture device of the user device 2901, for example, a mobile phone's camera to capture images of the medication bins 102 and the medication organizer tray apparatus 100 and transmit the captured images to the backend server 2502 for review. The healthcare recipient may use any portable user device 2901 with a camera, for example, a smart phone, a tablet computing device, a video camera, etc., to capture images of the filled medication organizer tray apparatus 100, in one or more different views, for example, a top view, a bottom view, etc., based on which view of the medication bins 102 is clear with minimal to no markings. For example, if medical information such as days and times for administering medications 112 are printed on the customized bin labels 106 of the medication bins 102 exemplarily illustrated in FIGS. 2A-2B, the healthcare recipient can capture an image of a bottom view of the medication organizer tray apparatus 100 using the image capture device in the healthcare recipient's user device 2901.

The wellness adherence tracking application 2902 on the healthcare recipient's user device 2901 with the image capture device transmits the captured images to the backend server 2502 for review by healthcare providers, for example, advisors. The advisors can review the transmitted images and confirm that the medication organizer tray apparatus 100 has been filled properly. At the end of each day or mid-week or randomly, the wellness adherence tracking application 2902 transmits alerts to the healthcare recipient to capture an image of their medication organizer tray apparatus 100. The wellness adherence tracking application 2902 transmits the captured image to the backend server 2502 for review by an advisor. The advisor reviews the transmitted image to confirm adherence, medications filled correctly for the rest of the week, appropriate use of abusable medications, etc. Furthermore, if a healthcare provider such as a clinician or a pharmacist changes the medication dosage mid-week, the healthcare recipient will be required to reorganize the medication organizer tray apparatus 100 for the remaining week to reflect the new dose regimen. The wellness adherence tracking application 2902 transmits alerts to the healthcare recipient to capture an image of the reorganized medication organizer tray apparatus 100 again for the advisors to confirm that the medications 112 have been loaded and reorganized as per the new dose regime in the healthcare provider's request.

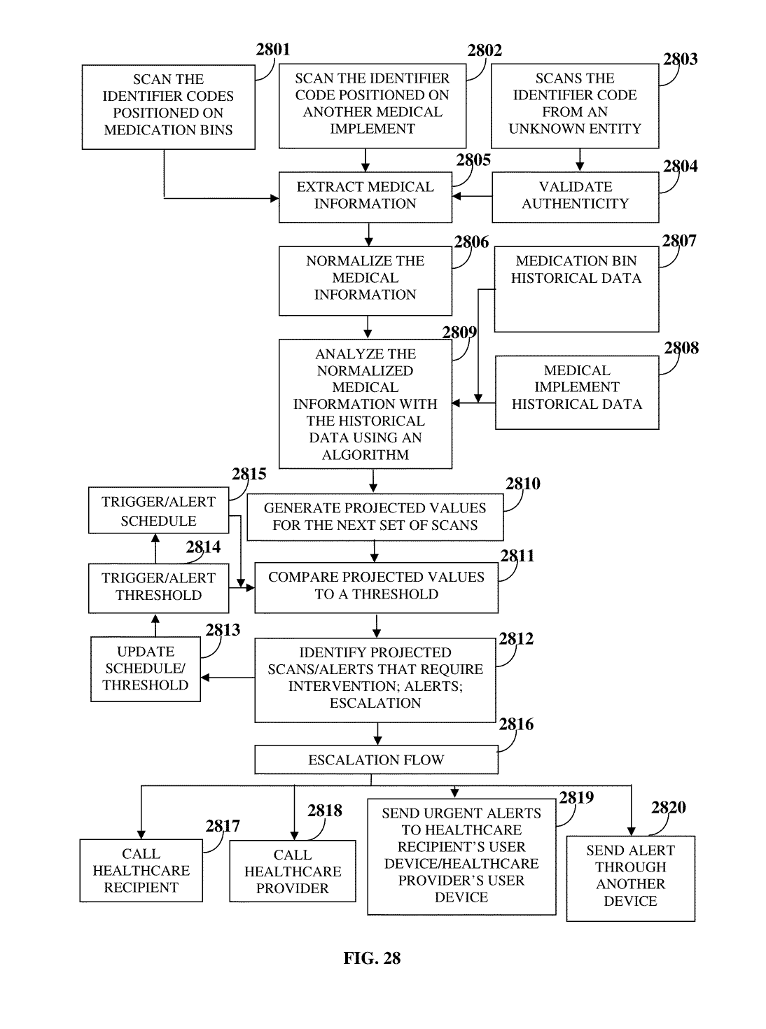

FIG. 28 exemplarily illustrates a flowchart comprising the steps performed by the wellness adherence tracking system 2900 exemplarily illustrated in FIG. 29, for dynamically analyzing medical information and adapting the workflow. In an embodiment, the wellness adherence tracking system 2900 dynamically analyzes the medical information with historical data 2807 and 2808 and trends and predicts future medical information and planned actionable tasks and outcomes. The wellness adherence tracking system 2900 executes an algorithm for dynamic real time analyzing, correlating, trending, and updating triggers, alerts, and schedules of scanned data and other medical information. The wellness adherence tracking application 2902 of the wellness adherence tracking system 2900 exemplarily illustrated in FIG. 29, scans the identifier codes positioned on medication bins 2801, the identifier code positioned on another medical implement 2802, for example, a parenteral device, a fitness device, etc., and the identifier code from an unknown entity 2803, and transmits the scans to the backend server 2502 of the wellness adherence tracking system 2900. The backend server 2502 receives the scans and validates 2804 the authenticity of the scanned identifier codes as disclosed in the detailed description of FIG. 27. The backend server 2502 then extracts 2805 medical information from the scanned and validated identifier codes and normalizes 2806 the extracted medical information. The backend server 2502 further receives medication bin historical data 2807 comprising, for example, number of pills taken, number of medication bins emptied, etc., and medical implement historical data 2808 that is stored from past scans to perform an analysis of the normalized medical information.

The backend server 2502 analyzes 2809 the normalized medical information with the medication bin historical data 2807 and the medical implement historical data 2808, for example, using the Kalman filter algorithm. The Kalman filter algorithm uses a mathematical predictive representation model of the functions of the medical implement 2913 exemplarily illustrated in FIG. 29, and the healthcare recipient's interaction with the medical implement 2913 with respect to time, frequency, duration, etc., over time. The Kalman filter algorithm compares expected measurements of the mathematical predictive representation model with actual measurements received from the wellness adherence tracking application 2902 on the healthcare recipient's user device 2901 exemplarily illustrated in FIG. 29, to predict future measurements. Based on the predicted future measurements generated by application of the Kalman filter algorithm, the backend server 2502 compares the predicted future measurements with thresholds of measurements predefined for the medical implement 2913. If the predicted future measurements are outside of the thresholds, then the backend server 2502 initiates pre-programmed automated alerts and proactive intervention. For example, if a healthcare recipient has delayed taking his/her morning medications for the past week, the backend server 2502 executes the Kalman filter algorithm to analyze the trend and predicts the consumption of the next morning's medications will be also be delayed. If the Kalman filter algorithm predicts that the delayed time is beyond the window of dose time, for example, a few hours before and after the time that the healthcare recipient should ideally take his/her medications, the backend server 2502 transmits a preemptive alert notification to the healthcare recipient's user device 2901 to remind him/her to take his/her medications. The backend server 2502 transmits this preemptive alert notification, for example, at a previous dose time or a few hours before a dose time alarm based on a pre-programmed intervention plan.

The Kalman filter algorithm executes on the backend server 2502 and generates 2810 projected values, for example, the expected healthcare recipient medication intake to identify 2812 projected scans or alerts that require intervention, preemptively generate alert notifications, and perform escalations. The backend server 2502 compares 2811 the projected values to a trigger or alert threshold 2814, for example, a pre-programmed medication intake time and determines the difference. If a trigger or alert time schedule 2815, for example, a dose time is 10:00 am and the Kalman filter algorithm predicts that the healthcare recipient will take the medications at 12:30 pm and the alert threshold time 2814 for escalating an alert is 12:00 noon, the backend server 2502 determines the difference of 30 minutes over the threshold. Since the difference is above the alert threshold time 2814, the backend server 2502 generates an alert. The backend server 2502 dynamically updates 2813 the schedule and thresholds. The backend server 2502 implements an escalation flow 2816, for example, by triggering a call 2817 to the healthcare recipient, triggering a call 2818 to the healthcare provider, sending urgent alerts 2819 to the healthcare recipient's user device 2901 and/or the healthcare provider's user device 2503 exemplarily illustrated in FIG. 25, sending 2820 an alert through another device, etc.

FIG. 29 exemplarily illustrates the wellness adherence tracking system 2900 for tracking wellness adherence of a healthcare recipient. The wellness adherence tracking system 2900 is accessible by a healthcare recipient's user device 2901 via a network 2501, for example, a short range network or a long range network. The wellness adherence tracking system 2900 is accessible, for example, through a broad spectrum of technologies and devices such as personal computers with access to the internet, internet enabled cellular phones, tablet computing devices, smart glasses, etc. In an embodiment, the wellness adherence tracking system 2900 is configured as a web based platform, for example, a website hosted on a server or a network of servers. In another embodiment, the wellness adherence tracking system 2900 comprises the wellness adherence tracking application 2902 downloadable and usable on the healthcare recipient's user device 2901. In an embodiment, the wellness adherence tracking system 2900 is implemented as a client-server architecture comprising the wellness adherence tracking application 2902 that communicates with the backend server 2502 via a network 2501 as exemplarily illustrated in FIG. 29. In an embodiment, the wellness adherence tracking system 2900 is implemented in a cloud computing environment. The wellness adherence tracking system 2900 is a cloud computing based platform implemented as a service for tracking wellness adherence of a healthcare recipient.

The healthcare recipient's user device 2901 is an electronic device, for example, a personal computer, a notebook, a tablet computing device, a mobile computer, a mobile phone, a smart phone, a portable computing device, a laptop, a personal digital assistant, a wearable device such as the Google Glass™ of Google Inc., the Apple Watch™ of Apple Inc., etc., a touch centric device, a workstation, a client device, a portable electronic device, a network enabled computing device, an interactive network enabled communication device, any other suitable computing equipment, combinations of multiple pieces of computing equipment, etc., capable of running the wellness adherence tracking application 2902. The wellness adherence tracking system 2900 disclosed herein further comprises a non-transitory computer readable storage medium, for example, a memory unit 3002 and at least one processor 3001 communicatively coupled to the non-transitory computer readable storage medium exemplarily illustrated in FIG. 30. The non-transitory computer readable storage medium is configured to store computer program instructions defined by modules, for example, 2903, 2904, 2905, 2906, 2907, 2908, 2909, 2910, etc., of the wellness adherence tracking system 2900. The processor 3001 is configured to execute the defined computer program instructions.

In an embodiment, the wellness adherence tracking application 2902 of the wellness adherence tracking system 2900 is configured and coded as a mobile application. The wellness adherence tracking application 2902 comprises a graphical user interface (GUI) 2911, a scanner 2903, a decoder 2904, a data extraction module 2905, a data rendering module 2906, a data reception module 2907, an analytic engine 2908, a data logger 2909, an alert notification module 2910, and an internal application database 2912. The GUI 2911 is, for example, a webpage of a website hosted by the wellness adherence tracking system 2900, an online web interface, a web based downloadable application interface, a mobile based downloadable application interface, etc. The scanner 2903 scans the identifier code 123a positioned on a medical implement 2913 via the GUI 2911. The decoder 2904 decodes and validates the scanned identifier code 123a as disclosed in the detailed description of FIG. 27. In an embodiment, the decoder 2904 validates the decoded identifier code 123a by comparing the authentication codes embedded therein with authentication codes stored by the wellness adherence tracking application 2902 in the internal application database 2912 in the user device 2901 and/or in one or more databases, for example, the wellness adherence database 2915 of the backend server 2502.

The data extraction module 2905 obtains medical information associated with the medical implement 2913 and/or an activity associated with the medical implement 2913 from the decoded and validated identifier code 123a, and/or wellness adherence criteria. The decoder 2904 determines the presence of medical information in the identifier code 123a. When the decoder 2904 determines the presence of medical information in the decoded and validated identifier code 123a, the data extraction module 2905 directly extracts the medical information contained in the decoded and validated identifier code 123a. In an embodiment, the data extraction module 2905 receives the medical information and the wellness adherence criteria from the healthcare recipient's user device 2901 via the graphical user interface (GUI) 2911. In another embodiment, the decoder 2904 transmits the decoded and validated identifier code 123a to one or more databases, for example, the wellness adherence database 2915 in the backend server 2502, the public databases 2916, etc., via the network 2501, and the data extraction module 2905 retrieves the medical information and the wellness adherence criteria from the wellness adherence database 2915, the public databases 2916, etc., via the network 2501 based on the decoded and validated identifier code 123a. In an embodiment, the analytic engine 2908, in communication with the user device 2901 and/or the backend server 2502, validates the medical information associated with the medical implement 2913 and/or the activity associated with the medical implement 2913 and loads the valid medical information in the wellness adherence tracking application 2902 or the backend server 2502 for performing actions on the valid medical information. The data rendering module 2906 renders the medical information and multiple wellness adherence options on the GUI 2911. In an embodiment, the data rendering module 2906 configures the wellness adherence options in accordance with the wellness adherence criteria and user inputs and then renders the configured wellness adherence options on the GUI 2911.

The data reception module 2907 receives inputs for one or more of the rendered wellness adherence options from the healthcare recipient's user device 2901. The data logger 2909 logs the received inputs in association with the wellness adherence criteria in the user device 2901 and/or one or more databases, for example, the wellness adherence database 2915 for tracking the wellness adherence of the healthcare recipient. The wellness adherence database 2915 refers to any storage area or medium that can be used for storing data and files. The wellness adherence database 2915 can be, for example, a structured query language (SQL) data store or a not only SQL (NoSQL) data store such as the Microsoft® SQL Server®, the Oracle® servers, the MySQL® database of MySQL AB Company, the mongoDB® of MongoDB, Inc., the Neo4j graph database of Neo Technology Corporation, the Cassandra database of the Apache Software Foundation, the HBase™ database of the Apache Software Foundation, etc. In an embodiment, the wellness adherence database 2915 can also be a location on a file system. In another embodiment, the wellness adherence database 2915 can be remotely accessed by the wellness adherence tracking system 2900 via the network 2501. In another embodiment, the wellness adherence database 2915 is a cloud based database implemented in a cloud computing environment, where computing resources are delivered as a service over the network 2501.

The alert notification module 2910 transmits alert notifications on the graphical user interface (GUI) 2911 based on alerting criteria comprising, for example, one or more of time settings configured on the healthcare recipient's user device 2901, a validation status of the decoded identifier code 123a, a validation status of the medical information contained in the decoded identifier code 123a, etc. The alert notifications, for example, remind the healthcare recipient to perform one or more actions to meet the wellness adherence criteria, warn the healthcare recipient of an invalid identifier code and/or invalid medical information, etc. In an embodiment, the alert notification module 2910 transmits alerts for capturing one or more images in one or more views of the medication organizer tray apparatus 100 exemplarily illustrated in FIGS. 1A-1C and FIGS. 2A-2B, on the GUI 2911 at configurable time instants. In this embodiment, the analytic engine 2908 verifies type, number, and arrangement of medications 112 in the medication bins 102 of the medication organizer tray apparatus 100 exemplarily illustrated in FIG. 1B, in accordance with the wellness adherence criteria prescribed by a healthcare provider using the captured images for tracking the wellness adherence of the healthcare recipient in accordance with the wellness adherence criteria. The internal application database 2912 stores the medical information that can be retrieved by the data extraction module 2905 if the medical information is not available in the decoded identifier code 123a. In an embodiment, the backend server 2502 further comprises an analytic engine 2914 in addition to the wellness adherence database 2915. The analytic engine 2914 dynamically analyzes the medical information with historical data and trends and predicts future medical information and planned actionable tasks and outcomes as disclosed in the detailed description of FIG. 28. In an embodiment, the analytic engine 2914 dynamically assesses health, wellness, and adherence requirements of the healthcare recipient and updates the wellness adherence criteria for an associated medical implement 2913.

FIG. 30 exemplarily illustrates the hardware architecture 3000 of the wellness adherence tracking system 2900 exemplarily illustrated in FIG. 29, employed for tracking wellness adherence of a healthcare recipient. The wellness adherence tracking system 2900 is a computer system that is programmable using a high level computer programming language. The wellness adherence tracking system 2900 may be implemented using programmed and purposeful hardware. As exemplarily illustrated in FIG. 30, the hardware architecture 3000 of the wellness adherence tracking system 2900 comprises a processor 3001, a non-transitory computer readable storage medium such as a memory unit 3002 for storing programs and data, an input/output (I/O) controller 3003, a network interface 3004, a data bus 3005, a display unit 3006, input devices 3007, a fixed media drive 3008 such as a hard drive, a removable media drive 3009 for receiving removable media, output devices 3010, etc. The processor 3001 refers to any one or more microprocessors, central processing unit (CPU) devices, finite state machines, computers, microcontrollers, digital signal processors, logic, a logic device, an electronic circuit, an application specific integrated circuit (ASIC), a field-programmable gate array (FPGA), a chip, etc., or any combination thereof, capable of executing computer programs or a series of commands, instructions, or state transitions. The processor 3001 may also be implemented as a processor set comprising, for example, a programmed microprocessor and a math or graphics co-processor. The processor 3001 is selected, for example, from the Intel® processors such as the Itanium® microprocessor or the Pentium® processors, Advanced Micro Devices (AMD®) processors such as the Athlon® processor, UltraSPARC® processors, microSPARC® processors, Hp® processors, International Business Machines (IBM®) processors such as the PowerPC® microprocessor, the MIPS® reduced instruction set computer (RISC) processor of MIPS Technologies, Inc., RISC based computer processors of ARM Holdings, Motorola® processors, Qualcomm® processors, etc. The wellness adherence tracking system 2900 disclosed herein is not limited to employing a processor 3001. The wellness adherence tracking system 2900 may also employ a controller or a microcontroller. The processor 3001 executes the modules, for example, 2903, 2904, 2905, 2906, 2907, 2908, 2909, 2910, etc., of the wellness adherence tracking application 2902 of the wellness adherence tracking system 2900 exemplarily illustrated in FIG. 29.

The memory unit 3002 is used for storing programs, applications, and data. For example, the scanner 2903, the decoder 2904, the data extraction module 2905, the data rendering module 2906, the data reception module 2907, the analytic engine 2908, the data logger 2909, the alert notification module 2910, etc., are stored in the memory unit 3002 of the user device 2901 exemplarily illustrated in FIG. 29. The memory unit 3002 is, for example, a random access memory (RAM) or another type of dynamic storage device that stores information and instructions for execution by the processor 3001. The memory unit 3002 also stores temporary variables and other intermediate information used during execution of the instructions by the processor 3001. The wellness adherence tracking system 2900 further comprises a read only memory (ROM) or another type of static storage device that stores static information and instructions for the processor 3001. The I/O controller 3003 controls input actions and output actions performed by the wellness adherence tracking application 2902.

The network interface 3004 enables connection of the wellness adherence tracking application 2902 to the network 2501 exemplarily illustrated in FIG. 29. In an embodiment, the network interface 3004 is provided as an interface card also referred to as a line card. The network interface 3004 comprises, for example, one or more of an infrared (IR) interface, an interface implementing Wi-Fi® of Wi-Fi Alliance Corporation, a universal serial bus (USB) interface, a FireWire® interface of Apple Inc., an Ethernet interface, a frame relay interface, a cable interface, a digital subscriber line (DSL) interface, a token ring interface, a peripheral controller interconnect (PCI) interface, a local area network (LAN) interface, a wide area network (WAN) interface, interfaces using serial protocols, interfaces using parallel protocols, and Ethernet communication interfaces, asynchronous transfer mode (ATM) interfaces, a high speed serial interface (HSSI), a fiber distributed data interface (FDDI), interfaces based on a transmission control protocol (TCP)/internet protocol (IP), interfaces based on wireless communications technology such as satellite technology, radio frequency (RF) technology, near field communication, etc. The data bus 3005 permits communications between the modules, for example, 2903, 2904, 2905, 2906, 2907, 2908, 2909, 2910, 2911, 2912, etc., of the wellness adherence tracking application 2902.

The display unit 3006, via the graphical user interface (GUI) 2911 exemplarily illustrated in FIG. 29, displays information, display interfaces, user interface elements such as text fields, checkboxes, text boxes, windows, etc., for allowing the healthcare recipient to scan the identifier code 123a exemplarily illustrated in FIG. 29, enter the medical information and the wellness adherence criteria, provide user inputs to meet the wellness adherence criteria, select the wellness adherence options, etc. The display unit 3006 comprises, for example, a liquid crystal display, a plasma display, an organic light emitting diode (OLED) based display, etc. The input devices 3007 are used for inputting data into the wellness adherence tracking system 2900. The healthcare recipient uses the input devices 3007 to provide inputs to the wellness adherence tracking system 2900. For example, a healthcare recipient may enter the medical information and the wellness adherence criteria for a particular medical implement 2913 exemplarily illustrated in FIG. 29, when a correct identifier code 123a is determined, etc., using the input devices 3007. The input devices 3007 are, for example, a keyboard such as an alphanumeric keyboard, a microphone, a joystick, a pointing device such as a computer mouse, a touch pad, a light pen, a physical button, a touch sensitive display device, a track ball, a pointing stick, any device capable of sensing a tactile input, etc.

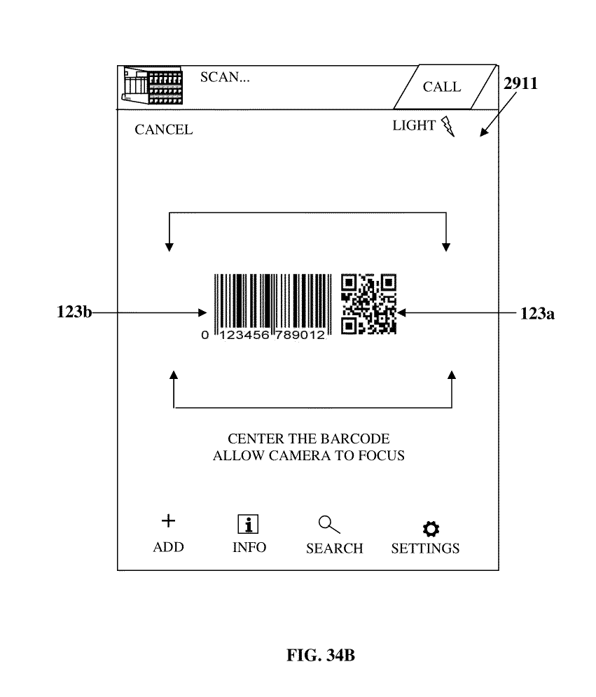

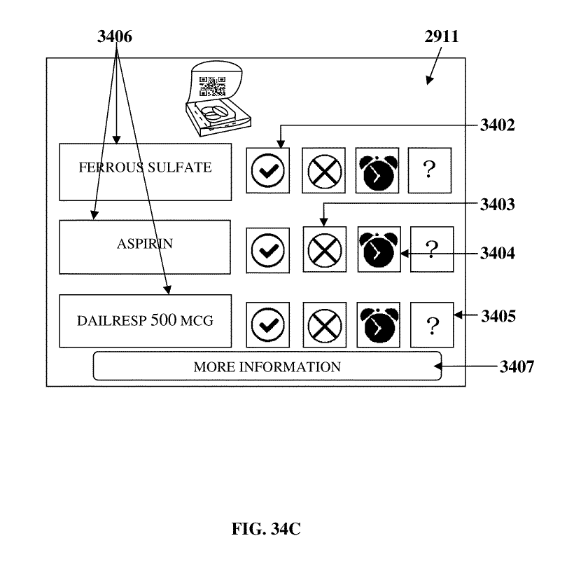

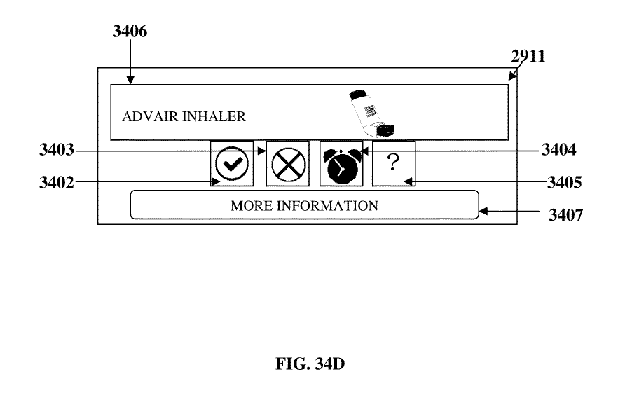

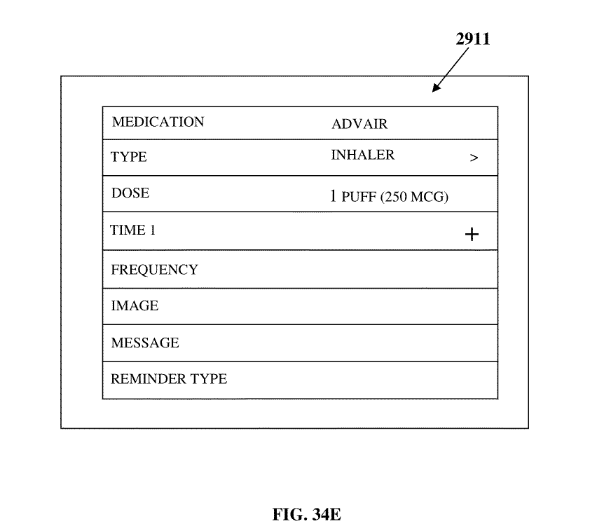

Computer applications and programs are used for operating the wellness adherence tracking system 2900. The programs are loaded onto the fixed media drive 3008 and into the memory unit 3002 of the user device 2901 via the removable media drive 3009. In an embodiment, the computer applications and programs may be loaded directly via the network 2501. Computer applications and programs are executed by double clicking a related icon displayed on the display unit 3006 using one of the input devices 3007. The output devices 3010 output the results of operations performed by the wellness adherence tracking application 2902. For example, the wellness adherence tracking application 2902 provides the wellness adherence options 3402, 3403, 3404, and 3405 exemplarily illustrated in FIGS. 34C-34D, to the healthcare recipients using the output devices 3010. The wellness adherence tracking system 2900 displays the wellness adherence options 3402, 3403, 3404, and 3405 using the output devices 3010.

The processor 3001 executes an operating system, for example, the Linux® operating system, the Unix® operating system, any version of the Microsoft® Windows® operating system, the Mac OS of Apple Inc., the IBM® OS/2, VxWorks® of Wind River Systems, Inc., QNX Neutrino® developed by QNX Software Systems Ltd., Palm OS®, the Solaris operating system developed by Sun Microsystems, Inc., the Android operating system, the Windows Phone® operating system of Microsoft Corporation, the BlackBerry® operating system of BlackBerry Limited, the iOS operating system of Apple Inc., the Symbian™ operating system of Symbian Foundation Limited, etc. The wellness adherence tracking system 2900 employs the operating system for performing multiple tasks. The operating system is responsible for management and coordination of activities and sharing of resources of the wellness adherence tracking system 2900. The operating system further manages security of the wellness adherence tracking system 2900, peripheral devices connected to the wellness adherence tracking system 2900, and network connections. The operating system employed on the wellness adherence tracking system 2900 recognizes, for example, inputs provided by the users using one of the input devices 3007, the output display, files, and directories stored locally on the fixed media drive 3008. The operating system on the wellness adherence tracking system 2900 executes different programs using the processor 3001. The processor 3001 and the operating system together define a computer system for which application programs in high level programming languages are written.

The processor 3001 of the user device 2901 retrieves instructions defined by the scanner 2903, the decoder 2904, the data extraction module 2905, the data rendering module 2906, the data reception module 2907, the analytic engine 2908, the data logger 2909, the alert notification module 2910, etc., for performing respective functions disclosed in the detailed description of FIG. 29. The processor 3001 of the backend server 2502 of the wellness adherence tracking system 2900 retrieves instructions defined by the analytic engine 2914 for performing associated functions disclosed in the detailed description of FIG. 29. The processor 3001 retrieves instructions for executing the modules, for example, 2903, 2904, 2905, 2906, 2907, 2908, 2909, 2910, etc., of the wellness adherence tracking application 2902 from the memory unit 3002. A program counter determines the location of the instructions in the memory unit 3002. The program counter stores a number that identifies the current position in the program of each of the modules, for example, 2903, 2904, 2905, 2906, 2907, 2908, 2909, 2910, etc., of the wellness adherence tracking application 2902. The instructions fetched by the processor 3001 from the memory unit 3002 after being processed are decoded. The instructions are stored in an instruction register in the processor 3001. After processing and decoding, the processor 3001 executes the instructions, thereby performing one or more processes defined by those instructions.

At the time of execution, the instructions stored in the instruction register are examined to determine the operations to be performed. The processor 3001 then performs the specified operations. The operations comprise arithmetic operations and logic operations. The operating system performs multiple routines for performing a number of tasks required to assign the input devices 3007, the output devices 3010, and memory for execution of the modules, for example, 2903, 2904, 2905, 2906, 2907, 2908, 2909, 2910, etc., of the wellness adherence tracking application 2902. The tasks performed by the operating system comprise, for example, assigning memory to the modules, for example, 2903, 2904, 2905, 2906, 2907, 2908, 2909, 2910, etc., of the wellness adherence tracking application 2902, and to data used by the wellness adherence tracking application 2902, moving data between the memory unit 3002 and disk units, and handling input/output operations. The operating system performs the tasks on request by the operations and after performing the tasks, the operating system transfers the execution control back to the processor 3001. The processor 3001 continues the execution to obtain one or more outputs. The outputs of the execution of the modules, for example, 2903, 2904, 2905, 2906, 2907, 2908, 2909, 2910, etc., of the wellness adherence tracking application 2902 are displayed to the healthcare recipient on the display unit 3006.

For purposes of illustration, the detailed description refers to the wellness adherence tracking application 2902 being run locally as a single computer system; however the scope of the method and the wellness adherence tracking system 2900 disclosed herein is not limited to the wellness adherence tracking application 2902 being run locally as a single computer system via the operating system and the processor 3001, but may be extended to run remotely over the network 2501 by employing a web browser and a remote server, a mobile phone, or other electronic devices. One or more portions of the wellness adherence tracking system 2900 may be distributed across one or more computer systems (not shown) coupled to the network 2501.

Disclosed herein is also a computer program product comprising a non-transitory computer readable storage medium that stores computer program codes comprising instructions executable by at least one processor 3001 for tracking wellness adherence of a healthcare recipient. The computer program product comprises a first computer program code for scanning an identifier code 123a of a medical implement 2913 via a graphical user interface (GUI) 2911; a second computer program code for decoding and validating the scanned identifier code 123a; a third computer program code for obtaining medical information associated with the medical implement 2913 and/or an activity associated with the medical implement 2913 from the decoded and validated identifier code 123a, and/or the wellness adherence criteria; a fourth computer program code for rendering the medical information and multiple wellness adherence options on the GUI 2911; a fifth computer program code for receiving inputs for one or more of the rendered wellness adherence options from the healthcare recipient's user device 2901; and a sixth computer program code for logging the received inputs in association with the wellness adherence criteria in the user device 2901 and/or one or more databases, for example, the wellness adherence database 2915 exemplarily illustrated in FIG. 29, to track the wellness adherence of the healthcare recipient. The computer program product disclosed herein further comprises a seventh computer program code for transmitting alert notifications on the GUI 2911 based on the alerting criteria disclosed in the detailed description of FIG. 27 and FIG. 29. The computer program product disclosed herein further comprises an eighth computer program code for dynamically analyzing the medical information with historical data and trends and predicting future medical information and planned actionable tasks and outcomes as disclosed in the detailed description of FIG. 28.

The computer program product disclosed herein further comprises one or more additional computer program codes for performing additional steps that may be required and contemplated for tracking wellness adherence of a healthcare recipient. In an embodiment, a single piece of a computer program code comprising computer executable instructions performs one or more steps of the method disclosed herein for tracking wellness adherence of the healthcare recipient. The computer program codes comprising computer executable instructions are embodied on the non-transitory computer readable storage medium. The processor 3001 retrieves these computer executable instructions and executes them. When the computer executable instructions are executed by the processor 3001, the computer executable instructions cause the processor 3001 to perform the steps of the method for tracking wellness adherence of the healthcare recipient.

FIG. 31 exemplarily illustrates a tracker card 3100 with identifier codes 3101 and 3102 and stickers 3103, 3104, 3105, 3106, 3107, and 3108 containing identifier codes 123a that can be positioned on a medical implement 2913 exemplarily illustrated in FIG. 29, for tracking wellness adherence of a healthcare recipient. The tracker card 3100 with the identifier codes 3101 and 3102 and the stickers 3103, 3104, 3105, 3106, 3107, and 3108 is provided to a healthcare recipient along with the medication organizer tray apparatus 100 exemplarily illustrated in FIGS. 1A-1C and FIGS. 2A-2B. A healthcare provider can also send the tracker card 3100 with the identifier codes 3101 and 3102 and the stickers 3103, 3104, 3105, 3106, 3107, and 3108 to the healthcare recipient along with the medication organizer tray apparatus 100, for example, through mail, or send the tracker card 3100 to the healthcare recipient's user device 2901 via the wellness adherence tracking application 2902 exemplarily illustrated in FIG. 29. The identifier codes 3101 and 3102 on the tracker card 3100 are used for tracking activities such as exercise and meditation respectively that are not associated with the medication organizer tray apparatus 100 or another medical implement 2913. For these activities, the healthcare recipient can scan the identifier code 3101 or 3102 corresponding to the activity performed on the tracker card 3100 using the scanner 2903 of the wellness adherence tracking application 2902 exemplarily illustrated in FIG. 29, after performing the activity based on the time scheduled in the wellness adherence tracking application 2902.

As exemplarily illustrated in FIG. 31, the tracker card 3100 comprises a blank identifier code sticker 3103 with an identifier code, for example, FX85694 to enable the healthcare recipient to track an activity performed on any medical implement 2913 or to obtain reminders to perform the activity by affixing the blank identifier code sticker 3103 on any medical implement 2913. When the healthcare recipient scans the blank identifier code FX85694 using the scanner 2903 of the wellness adherence tracking application 2902, the wellness adherence tracking application 2902 provides an option to the healthcare recipient to enter information to create a reminder to keep track of the medical implement 2913 via the graphical user interface (GUI) 2911 exemplarily illustrated in FIG. 29, and adds the information entered by the healthcare recipient to the wellness adherence tracking system 2900 exemplarily illustrated in FIG. 29. The healthcare recipient can affix the sticker 3104 to corresponding medical implements 2913, for example, a parenteral device 3302 exemplarily illustrated in FIG. 33C, an exercise bike, a yoga mat, a meditation application, an eye drops vial which can be refrigerated, etc., to track and log wellness adherence of the healthcare recipient with respect to these medical implements 2913, receive promotional messages, etc. The healthcare recipient can affix the stickers 3105, 3106, 3107, and 3108 to corresponding medical implements 2913, for example, an insulin injection package, an inhaler, a blood pressure meter, and a glucose meter respectively, to track and log the wellness adherence of the healthcare recipient with respect to these medical implements 2913. In an embodiment, the identifier codes 3101 and 3102 are static identifier codes that do not change over a period of time unless a new set of codes are electronically mailed or mailed to an address of the healthcare recipient. For example, a sticker used for the exercise bike contains a static identifier code. In another embodiment, the stickers 3105, 3106, 3107, and 3108 comprise dynamic identifier codes that change over a period of time, for example, on a weekly basis or a monthly basis. For example, a sticker 3106 used for inhaler instructions changes on a monthly basis.

The healthcare recipient may have other medical implements 2913 with different identifier codes 123a that are not included in the tracker card 3100, which can also be linked to the wellness adherence tracking application 2902. When the healthcare recipient scans the identifier code 123a on another medical implement 2913, the wellness adherence tracking application 2902 determines whether the identifier code is a known identifier code or an unknown identifier code. If the wellness adherence tracking application 2902 does not recognize the identifier code and deems the identifier code as unknown, the wellness adherence tracking application 2902 transmits the identifier code 123a to the backend server 2502 of the wellness adherence tracking system 2900 exemplarily illustrated in FIG. 29. The backend server 2502 retrieves medical information associated with the identifier code 123a of the medical implement 2913 from one or more public databases 2916 via the network 2501 exemplarily illustrated in FIG. 29, and adds secure and credible medical information of the identifier code 123a to the wellness adherence tracking application 2902. In an embodiment, the wellness adherence tracking application 2902 prompts the healthcare recipient to enter reminder information via the graphical user interface (GUI) 2911 for creation of reminders associated with the newly added medical implements 2913. If the content of the medical information retrieved by the backend server 2502 from one or more public databases 2916 appears suspect, the backend server 2502 sends an alert to the wellness adherence tacking application 2902 warning the healthcare recipient of a contaminated identifier code and to be aware of a potential malicious attack.

In an embodiment, when the healthcare recipient scans an identifier code 123a positioned on a new medical implement 2913 for which there was no corresponding identifier code 123a in the tracker card 3100, the backend server 2502 of the wellness adherence tracking system 2900 receives the medical information encoded in the scanned identifier code 123a from the wellness adherence tracking application 2902 via the network 2501 and correlates features and functions of the new medical implement 2913 with the healthcare recipient's health, wellness, and adherence requirements, and transmits specific wellness adherence criteria optimal for the healthcare recipient based on the healthcare recipient's current real time state of health and wellness metrics. In an embodiment, the identifier code 123a and associated medical information for the newly added medical implement 2913 is included in an updated tracker card 3100 issued to the healthcare recipient.

In an embodiment, when the wellness adherence tracking application 2902 scans and decodes the identifier code 123a positioned on the new medical implement 2913 for which there was no corresponding identifier code in the tracker card 3100, the wellness adherence tracking application 2902 searches for two codes, that is, the authentication code and the healthcare recipient code as disclosed in the detailed description of FIG. 27. If these codes are not found in the scanned and decoded identifier code 123a, the wellness adherence tracking application 2902 reviews the content of the decoded identifier code 123a. If there is no content in the decoded identifier code 123a, that is, if the decoded identifier code 123a is a blank identifier code, the wellness adherence tracking application 2902 displays a screen on the graphical user interface (GUI) 2911 where the healthcare recipient can enter specific information about the medical implement 2913 and how, when, frequency, etc., they plan to use the medical implement 2913. Once this information is entered, the wellness adherence tracking application 2902 transmits the new identifier code 123a along with the entered information specific to the medical implement 2913 and its use to the backend server 2502 via the network 2501 for registration and further processing. The backend server 2502 processes and correlates this transmitted information with a similar medical implement to confirm that there is not duplication or overlap.

If there is a similar medical implement stored in the wellness adherence database 2915 in the backend server 2502 exemplarily illustrated in FIG. 29, the backend server 2502 sends a notification to the wellness adherence tracking application 2902 to inform the healthcare recipient of the duplicate medical implement and requests the healthcare recipient to indicate which is the dominant medical implement and if the other medical implements are inactive. If the other medical implements are inactive, the statuses of those specific medical implements are updated to an inactive status in the wellness adherence database 2915. If the medical implement 2913 is new, the backend server 2502 registers the new medical implement 2913 and stores the associated medical information in the wellness adherence database 2915. The backend server 2502 integrates the medical information of the medical implement 2913 with the other medical implements such that the recipient is not alerted or pinged constantly and that a cohesive message instead of a fragmented device by device message is passed to the healthcare recipient upon a trigger from the medical implement 2913, the wellness adherence tracking application 2902, or the backend server 2502.

In an embodiment where the medical implement 2913 has its own identifier code 123a which leads to a corresponding manufacturer's website, the wellness adherence tracking application 2902 connects to the manufacturer's website and determines whether there is a match in the wellness adherence database 2915 for that particular manufacturer's website from previously received identifier codes from other recipients or whether the manufacturer is a registered entity. If there is a match, the wellness adherence tracking application 2902 extracts the medical information of the medical implement 2913 and auto-populates from the wellness adherence database 2915. If the identifier code 123a and the associated medical information appear suspect, the backend server 2502 sends an alert notification to the wellness adherence tracking application 2902 warning the healthcare recipient of the contaminated identifier code and to be aware of a potential malicious attack. These contaminated identifier codes are stored in the wellness adherence database 2915, and if such a contaminated identifier code on the same or another medical implement 2913 is uploaded in the future from the same or another healthcare recipient's user device 2901, the wellness adherence tracking application 2902 searches the wellness adherence database 2915 at the backend server 2502 via the network 2501 and recognizes these contaminated identifier codes as malicious identifier codes and alerts the healthcare recipient.

The backend server 2502 dynamically assesses the healthcare recipient's health, wellness, and adherence requirements and updates the wellness adherence criteria for specific impacted medical implements. For example, if the wellness adherence tracking application 2902 triggers a reminder for a medical implement 2913 to measure blood pressure and detects high blood pressure from the measured values entered by the healthcare recipient via the graphical user interface (GUI) 2911 of the wellness adherence tracking application 2902 or from measured values automatically sent at random, via triggers, or upon availability via a wireless medical implement, in communication with the backend server 2502 via the network 2501, the wellness adherence tracking application 2902 may prompt the healthcare recipient to measure his/her weight which was not part of the original wellness adherence criteria via the GUI 2911. In an embodiment, the backend server 2502 transmits updated instructions to medical implements 2913 that are in operable communication with the backend server 2502 or another associated server via the network 2501 to alert the healthcare recipient, for example, through an alarm on the user device 2901 exemplarily illustrated in FIG. 29.

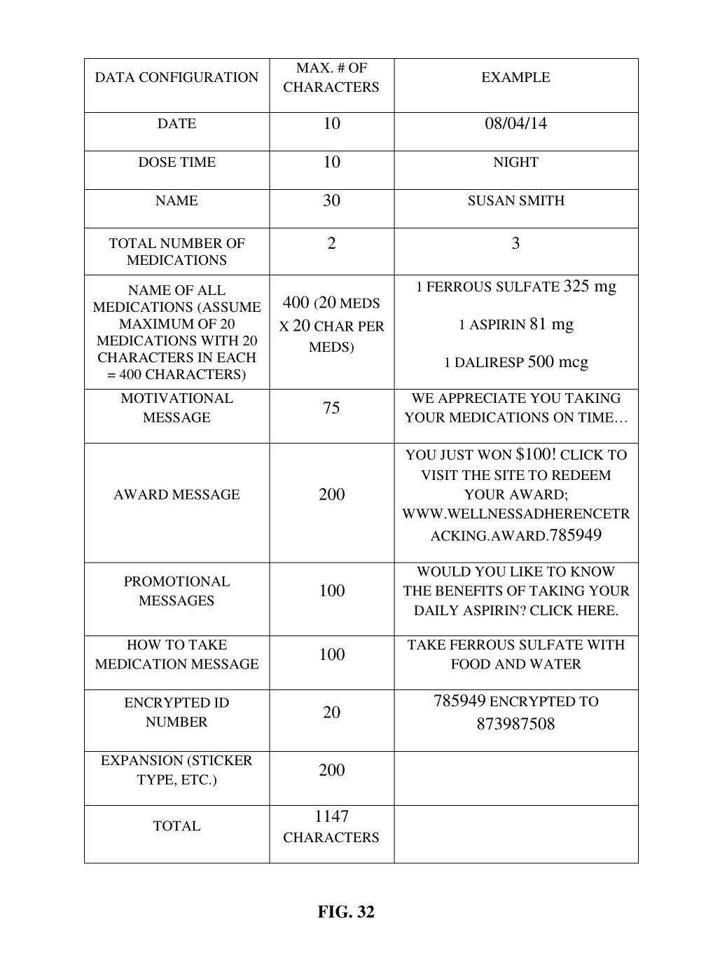

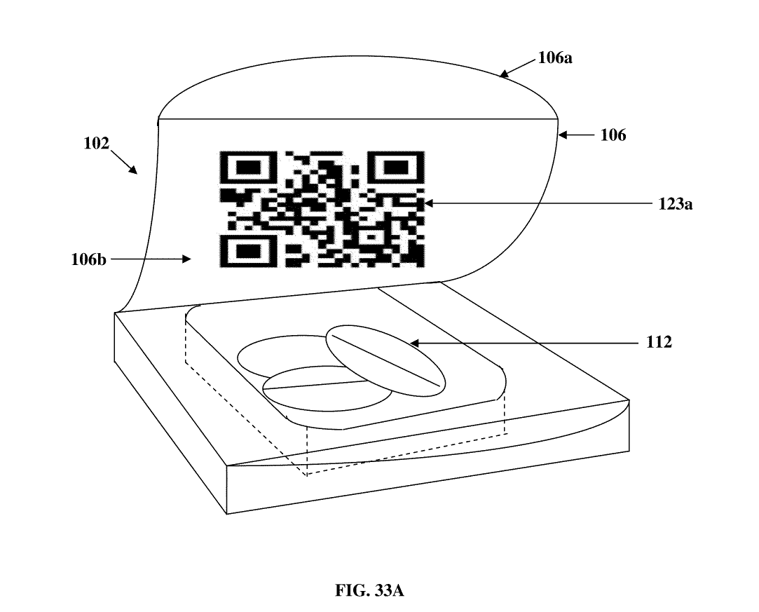

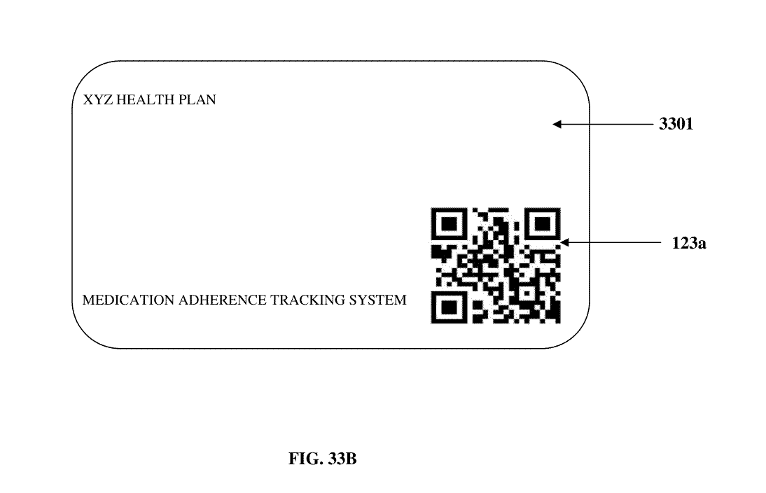

FIG. 32 exemplarily illustrates a tabular representation of data size allocation in an identifier code 123a exemplarily illustrated in FIG. 29 and FIG. 31. The identifier code 123a contains encrypted alphanumeric data with a data size allocation as exemplarily illustrated in the table in FIG. 32. The identifier code 123a is encrypted and does not contain personal health information of a healthcare recipient which links a medication to the healthcare recipient, when the identifier code 123a is scanned by another individual using the wellness adherence tracking application 2902 exemplarily illustrated in FIG. 29, downloaded on a user device of the other individual. The identifier code 123a is configured to store, that is, accommodate data or medical information of, for example, about 1147 characters. However, if there are fewer characters, the wellness adherence tracking system 2900 exemplarily illustrated in FIG. 29, generates an identifier code 123a with a fewer number of rows and columns. In an embodiment, the identifier code 123a can hold, for example, about 70 rows and about 70 columns for a total of about 4296 characters with error correction set to low, which allows about one third of the medical information to be available. The identifier code 123a stores, for example, about 10 characters for a date of administration of a medication, about 10 characters for a dose time, about 30 characters for a name of the healthcare recipient, about 2 characters for the total number of medications, about 400 characters for names of medications stored in a medication bin, about 75 characters for a motivational message, about 200 characters for an award message, about 100 characters for promotional messages, about 100 characters for instructions on how to administer the medication, about 20 characters for an encrypted identification number, and about 200 characters for a sticker type expansion as exemplarily illustrated in FIG. 32.

FIGS. 33A-33D exemplarily illustrate identifier codes 123a positioned on different medical implements. The medical implements comprise, for example, a medication bin 102 configured to store one or more medications 112 as exemplarily illustrated in FIG. 33A, a medical identification card 3301 as exemplarily illustrated in FIG. 33B, a parenteral device 3302 such as an inhaler as exemplarily illustrated in FIG. 33C or an injection, a fitness device or a fitness accessory such as a wrist band 3303 as exemplarily illustrated in FIG. 33D, a medical wellness plan, etc. In an embodiment, the identifier code 123a is, for example, affixed using an adhesive or printed on a bottom surface 106b, that is, on an inner side of the customized bin label 106 that seals the medication bin 102 as exemplarily illustrated in FIG. 33A. When the identifier code 123a is positioned on the bottom surface 106b of the customized bin label 106, the healthcare recipient can pull a top edge 106a, for example, a tab of the customized bin label 106 to access the identifier code 123a. In another embodiment, the identifier code 123a is positioned on a right side lower corner of the medical identification card 3301. The healthcare recipient scans the identifier code 123a positioned on the bottom surface 106b of the customized bin label 106, on the medical identification card 3301, on the inhaler 3302, or on the wrist band 3303 using the scanner 2903 of the wellness adherence tracking application 2902 on the healthcare recipient's user device 2901 exemplarily illustrated in FIG. 29, to track wellness adherence of the healthcare recipient.

In an embodiment, the medication organizer tray apparatus 100 exemplarily illustrated in FIGS. 1A-1C and FIGS. 2A-2B, may or may not have the electronic identification component 103 embedded into the support frame 101 of the medication organizer tray apparatus 100 exemplarily illustrated in FIG. 1A, which is configured to carry an identifier (ID). In this embodiment, the identifier code 123a which identifies the medication organizer tray apparatus 100 will be positioned on the cover jacket 2001 of the medication organizer tray apparatus 100 exemplarily illustrated in FIGS. 20A-20C. The healthcare recipient scans the identifier code 123a using the scanner 2903 of the wellness adherence tracking application 2902, to confirm that the medication organizer tray apparatus 100 is for a correct week and a correct healthcare recipient. In an embodiment, when the medical information about one or more medications 112, for example, nutraceuticals, parenterals, etc., is not listed in the pill station manager application 2504 exemplarily illustrated in FIG. 25, or when the medical information and alarm schedule for the medications 112 in the medication organizer tray apparatus 100 is absent, the wellness adherence tracking application 2902 scans two dimensional (2D) barcodes 123b exemplarily illustrated in FIG. 15B, of the medications 112 in the medication organizer tray apparatus 100, and extracts the medical information associated with the medications 112 or receives the medical information from the healthcare recipient, and loads the medical information into the wellness adherence tracking application 2902 and the pill station manager application 2504.

FIGS. 34A-34E exemplarily illustrate screenshots of a graphical user interface (GUI) 2911 provided by the wellness adherence tracking application 2902 of the wellness adherence tracking system 2900 on a healthcare recipient's user device 2901 exemplarily illustrated in FIG. 29, for tracking wellness adherence of the healthcare recipient. FIG. 34A exemplarily illustrates the GUI 2911, for example, a dashboard of the wellness adherence tracking application 2902 deployed on the healthcare recipient's user device 2901. FIG. 34A exemplarily illustrates multiple interface elements such as buttons or icons named, for example, as “My Day”, “My Meds”, “My Activity”, “My Health”, “My Contacts”, “Scan”, etc., that the wellness adherence tracking application 2902 renders to the healthcare recipient for tracking wellness adherence of the healthcare recipient. Using the “Scan” interface element 3401 of the wellness adherence tracking application 2902, the healthcare recipient scans identifier codes 123a and 123b positioned on a medical implement 2913 exemplarily illustrated in FIG. 29. When the healthcare recipient activates the “Scan” interface element 3401 by tapping the “Scan” interface element 3401, the wellness adherence tracking application 2902 allows the healthcare recipient to focus a camera lens of the user device 2901 on the identifier codes 123a and 123b as exemplarily illustrated in FIG. 34B. When the healthcare recipient focuses the camera lens of the user device 2901 on the identifier codes 123a and 123b, the wellness adherence tracking application 2902 scans the identifier codes 123a and 123b and decodes the scanned identifier codes 123a and 123b to obtain medical information associated with the medical implement 2913, an activity associated with the medical implement 2913, and/or the wellness adherence criteria.

When the healthcare recipient scans the identifier codes 123a and 123b and the wellness adherence tracking application 2902 determines that the identifier codes 123a and 123b are valid and obtains the medical information from the identifier codes 123a and 123b, the wellness adherence tracking application 2902 renders wellness adherence options comprising, for example, an “administered” option 3402, a “not administered” option 3403, a time settings option 3404, and an “absence of a medication” option 3405, that are configured in accordance with the wellness adherence criteria as exemplarily illustrated in FIGS. 34C-34D. For medications 112 exemplarily illustrated in FIG. 1B, that need to be taken after a few hours, the healthcare recipient can schedule a time using the time settings option 3404 on the GUI 2911, which reminds the healthcare recipient at the scheduled time to consume the medications 112. If the healthcare recipient after being sent a reminder has not cleared the time settings option 3404, then the wellness adherence tracking application 2902 determines that consumption of the medications 112 in the medical implement 2913, that is, the medication bin 102 exemplarily illustrated in FIG. 33A, or any other activity associated with the medical implement 2913 has not been completed. When the time settings option 3404 is not cleared, the wellness adherence tracking application 2902 enables the healthcare recipient to select the “administered” option 3402 after consuming the medication 112, till a predefined time period of, for example, about four hours after the initial reminder. For example, when the healthcare recipient has not consumed a medication 112 and selected the time settings option 3404, that is, snoozed the activity of consuming the medication 112, then the wellness adherence tracking application 2902 enables the healthcare recipient to select the administered option 3402 once he/she consumes the medication 112, till about four hours after the snooze. Some medications 112 that remain in the medication bin 102 need to be taken a few hours later than the other medications 112 in the medication bin 102. The wellness adherence tracking application 2902 does not disable reminders for unchecked, that is, not administered medications and triggers a reminder at a selected time.

When the healthcare recipient scans the identifier codes 123a and 123b and the wellness adherence tracking application 2902 determines that the identifier codes 123a and 123b are valid and obtains the medical information, the wellness adherence tracking application 2902 renders a medical information window on the graphical user interface (GUI) 2911 as exemplarily illustrated in FIG. 34E, for allowing the healthcare recipient to view the medical information and/or for receiving additional medical information and/or wellness adherence criteria from the healthcare recipient via the GUI 2911. The medical information that the healthcare recipient enters on the GUI 2911 comprises, for example, a type of medication, a type of the medical implement 2913 such as a medication bin 102 or a parenteral device 3302 such as an inhaler exemplarily illustrated in FIG. 33C, dosage information, frequency of administration, a reminder type, etc.

Consider an example where a healthcare recipient wants to consume medications 112, for example, pills from a medication bin 102 of the medication organizer tray apparatus 100 exemplarily illustrated in FIGS. 1A-1C and FIGS. 2A-2B. The healthcare recipient invokes the wellness adherence tracking application 2902 installed on the healthcare recipient's user device 2901 exemplarily illustrated in FIG. 29. The wellness adherence tracking application 2902 renders a dashboard, for example, a home screen on the graphical user interface (GUI) 2911 comprising the “Scan” interface element 3401 as exemplarily illustrated in FIG. 34A. In this example, an identifier code 123a is positioned on the bottom surface 106b of the customized bin label 106 that seals the medication bin 102 exemplarily illustrated in FIG. 33A. The healthcare recipient lifts the top edge 106a of the customized bin label 106 to reveal the identifier code 123a, for example, a quick response (QR) code. The healthcare recipient positions his/her user device 2901 such that a camera lens in his/her user device 2901 focuses on the identifier code 123a and then taps on the “Scan” interface element 3401 to scan the identifier code 123a in focus as exemplarily illustrated in FIG. 34B. The wellness adherence tracking application 2902 scans the identifier code 123a to determine presence of medical information in the identifier code 123a. When the wellness adherence tracking application 2902 determines the presence of the medical information in the identifier code 123a, the wellness adherence tracking application 2902 extracts the medical information from the scanned identifier code 123a to display names of contents 3406, for example, pills contained in the medication bin 102 as exemplarily illustrated in FIG. 34C.

The wellness adherence tracking application 2902 renders the contents 3406 and multiple wellness adherence options 3402, 3403, 3404, 3405, etc., and by default displays, for example, a check mark for each medication 112 in the medication bin 102 indicating that the healthcare recipient has consumed each pill stored in the medication bin 102 as exemplarily illustrated in FIG. 34C. However, if the healthcare recipient has not consumed each of the pills stored in the medication bin 102, the wellness adherence tracking application 2902 allows the healthcare recipient to manually uncheck the unconsumed pills by selecting the “not administered” option 3403 on the graphical user interface (GUI) 2911. When the healthcare recipient consumes these unconsumed medications 112 in the medication bin 102 at a later time, he/she can manually select the “administered” option 3402 to indicate administration of the medications 112. When the healthcare recipient decides to take the medications 112 at a later time of a day, he/she can select the time settings option 3404 to indicate rescheduling of time for the administration of the medications 112. When the healthcare recipient does not have one or more of the medications 112, he/she can select the “absence of medication” option 3405 to indicate missing medications 112.

On receiving inputs for the wellness adherence options 3402, 3403, 3404, or 3405 from the healthcare recipient, the wellness adherence tracking application 2902 logs the selections and compares the selections and time of each selection that indicates time of consumption of a pill, with the wellness adherence criteria, for example, a medication regimen prescribed by a healthcare provider to the healthcare recipient. If the comparison yields a positive match for each of the medications 112 consumed based on one or more adherence parameters comprising, for example, a prescribed quantity of pills to be consumed, a prescribed time of day of consumption of the pills, a prescribed method of consuming the pills, etc., the wellness adherence tracking application 2902 confirms the wellness adherence of the healthcare recipient. In an embodiment, the wellness adherence tracking application 2902 renders the medical information and/or the wellness adherence criteria exemplarily illustrated in FIG. 34E, when the healthcare recipient taps on the “more information” interface element 3407 exemplarily illustrated in FIGS. 34C-34D.

It will be readily apparent that the various methods, algorithms, and computer programs disclosed herein may be implemented on computer readable media appropriately programmed for computing devices. As used herein, “computer readable media” refers to non-transitory computer readable media that participate in providing data, for example, instructions that may be read by a computer, a processor or a similar device. Non-transitory computer readable media comprise all computer readable media, for example, non-volatile media, volatile media, and transmission media, except for a transitory, propagating signal. Non-volatile media comprise, for example, optical discs or magnetic disks and other persistent memory volatile media including a dynamic random access memory (DRAM), which typically constitutes a main memory. Volatile media comprise, for example, a register memory, a processor cache, a random access memory (RAM), etc. Transmission media comprise, for example, coaxial cables, copper wire, fiber optic cables, modems, etc., including wires that constitute a system bus coupled to a processor, etc. Common forms of computer readable media comprise, for example, a floppy disk, a flexible disk, a hard disk, magnetic tape, a laser disc, a Blu-ray Disc® of the Blu-ray Disc Association, any magnetic medium, a compact disc-read only memory (CD-ROM), a digital versatile disc (DVD), any optical medium, a flash memory card, punch cards, paper tape, any other physical medium with patterns of holes, a random access memory (RAM), a programmable read only memory (PROM), an erasable programmable read only memory (EPROM), an electrically erasable programmable read only memory (EEPROM), a flash memory, any other memory chip or cartridge, or any other medium from which a computer can read.

The computer programs that implement the methods and algorithms disclosed herein may be stored and transmitted using a variety of media, for example, the computer readable media in a number of manners. In an embodiment, hard-wired circuitry or custom hardware may be used in place of, or in combination with, software instructions for implementation of the processes of various embodiments. Therefore, the embodiments are not limited to any specific combination of hardware and software. In general, the computer program codes comprising computer executable instructions may be implemented in any programming language. Examples of programming languages that can be used comprise C, C++, C#, Java®, JavaScript®, Fortran, Ruby, Perl®, Python®, Visual Basic®, hypertext preprocessor (PHP), Microsoft® .NET etc. The computer program codes or software programs may be stored on or in one or more mediums as object code. Various aspects of the method and the wellness adherence tracking system 2900 disclosed herein may be implemented in a non-programmed environment comprising documents created, for example, in a hypertext markup language (HTML), an extensible markup language (XML), or other format that render aspects of a graphical user interface (GUI) or perform other functions, when viewed in a visual area or a window of a browser program. Various aspects of the method and the wellness adherence tracking system 2900 disclosed herein may be implemented as programmed elements, or non-programmed elements, or any suitable combination thereof. The computer program product disclosed herein comprises one or more computer program codes for implementing the processes of various embodiments.

Where databases are described such as the internal application database 2912 and the wellness adherence database 2915 exemplarily illustrated in FIG. 29, it will be understood by one of ordinary skill in the art that (i) alternative database structures to those described may be readily employed, and (ii) other memory structures besides databases may be readily employed. Any illustrations or descriptions of any sample databases disclosed herein are illustrative arrangements for stored representations of information. Any number of other arrangements may be employed besides those suggested by tables illustrated in the drawings or elsewhere. Similarly, any illustrated entries of the databases represent exemplary information only; one of ordinary skill in the art will understand that the number and content of the entries can be different from those disclosed herein. Further, despite any depiction of the databases as tables, other formats including relational databases, object-based models, and/or distributed databases may be used to store and manipulate the data types disclosed herein. Likewise, object methods or behaviors of a database can be used to implement various processes such as those disclosed herein. In addition, the databases may, in a known manner, be stored locally or remotely from a device that accesses data in such a database. In embodiments where there are multiple databases in the wellness adherence tracking system 2900 exemplarily illustrated in FIG. 29, the databases may be integrated to communicate with each other for enabling simultaneous updates of data linked across the databases, when there are any updates to the data in one of the databases.

The method and the wellness adherence tracking system 2900 exemplarily illustrated in FIG. 29, disclosed herein can be configured to work in a network environment comprising one or more computers that are in communication with one or more devices via a network. The computers may communicate with the devices directly or indirectly, via a wired medium or a wireless medium such as the Internet, a local area network (LAN), a wide area network (WAN) or the Ethernet, a token ring, or via any appropriate communications mediums or combination of communications mediums. Each of the devices comprises processors, some examples of which are disclosed above, that are adapted to communicate with the computers. In an embodiment, each of the computers is equipped with a network communication device, for example, a network interface card, a modem, or other network connection device suitable for connecting to a network. Each of the computers and the devices executes an operating system, some examples of which are disclosed above. While the operating system may differ depending on the type of computer, the operating system will continue to provide the appropriate communications protocols to establish communication links with the network. Any number and type of machines may be in communication with the computers.

The method and the wellness adherence tracking system 2900 disclosed herein are not limited to a particular computer system platform, processor, operating system, or network. One or more aspects of the method and the wellness adherence tracking system 2900 disclosed herein may be distributed among one or more computer systems, for example, servers configured to provide one or more services to one or more client computers, or to perform a complete task in a distributed system. For example, one or more aspects of the method and the wellness adherence tracking system 2900 disclosed herein may be performed on a client-server system that comprises components distributed among one or more server systems that perform multiple functions according to various embodiments. These components comprise, for example, executable, intermediate, or interpreted code, which communicate over a network using a communication protocol. The method and the wellness adherence tracking system 2900 disclosed herein are not limited to be executable on any particular system or group of systems, and are not limited to any particular distributed architecture, network, or communication protocol.

The foregoing examples have been provided merely for the purpose of explanation and are in no way to be construed as limiting of the method and the wellness adherence tracking system 2900 disclosed herein. While the method and the wellness adherence tracking system 2900 have been described with reference to various embodiments, it is understood that the words, which have been used herein, are words of description and illustration, rather than words of limitation. Further, although the method and the wellness adherence tracking system 2900 have been described herein with reference to particular means, materials, and embodiments, the method and the wellness adherence tracking system 2900 are not intended to be limited to the particulars disclosed herein; rather, the method and the wellness adherence tracking system 2900 extend to all functionally equivalent structures, methods and uses, such as are within the scope of the appended claims. Those skilled in the art, having the benefit of the teachings of this specification, may effect numerous modifications thereto and changes may be made without departing from the scope and spirit of the method and the wellness adherence tracking system 2900 disclosed herein in their aspects.

We claim:

1. A method for tracking wellness adherence of a healthcare recipient, said method comprising:
providing an identifier code configured to be positioned on a medical implement to identify said medical implement;
scanning said identifier code of said medical implement via a graphical user interface provided by a wellness adherence tracking system accessible on a user device, said wellness adherence tracking system comprising at least one processor configured to execute computer program instructions for tracking said wellness adherence of said healthcare recipient;
decoding and validating said scanned identifier code by said wellness adherence tracking system;
obtaining medical information associated with one or more of said medical implement and an activity associated with said medical implement from said decoded and validated identifier code, and wellness adherence criteria by said wellness adherence tracking system;
rendering said medical information and a plurality of wellness adherence options on said graphical user interface by said wellness adherence tracking system;
receiving inputs for one or more of said rendered wellness adherence options from said user device by said wellness adherence tracking system; and
logging said received inputs in association with said wellness adherence criteria by said wellness adherence tracking system in one or more of said user device and one or more databases to track said wellness adherence of said healthcare recipient.

2. The method of claim 1, wherein said medical implement is one of a medication bin configured to store one or more medications, a parenteral device, a fitness device, a medical identification card, a medical wellness plan, and a medication organizer tray apparatus.

3. The method of claim 1, wherein said activity associated with said medical implement is one of administration of one or more medications, an exercise activity, a diet activity, wound care, and a health checkup.

4. The method of claim 1, wherein said wellness adherence criteria comprise dosage information, a date for administering one or more medications, a time of day for administering said one or more medications, and directions to follow.

5. The method of claim 1, wherein said medical information is obtained by one or more of:
directly extracting said medical information contained in said decoded and validated identifier code by said wellness adherence tracking system;
transmitting said decoded and validated identifier code to one or more databases via a network and retrieving said medical information and said wellness adherence criteria from said one or more databases via said network by said wellness adherence tracking system; and
receiving said medical information and said wellness adherence criteria from said user device via said graphical user interface by said wellness adherence tracking system.

6. The method of claim 1, wherein said wellness adherence options comprise indicators that define administration and non-administration of one or more medications, presence and absence of medications in said medical implement, performance and non-performance of said activity, a percentage of performance of said activity, an abortion of said activity, an establishment of communication with a prescriber of said activity, and time settings for said administration of said one or more medications and said performance of said activity within preconfigured time periods.

7. The method of claim 1, wherein said identifier code comprises one or more authentication codes embedded therein for said validation with reference to authentication codes stored by said wellness adherence tracking system in said one or more of said user device and said one or more databases.

8. The method of claim 1, further comprising validating said medical information associated with said one or more of said medical implement and said activity associated with said medical implement by said wellness adherence tracking system, in communication with one or more of said user device and a backend server.

9. The method of claim 1, further comprising configuring said wellness adherence options in accordance with said wellness adherence criteria and user inputs by said wellness adherence tracking system.

10. The method of claim 1, further comprising transmitting alert notifications on said graphical user interface by said wellness adherence tracking system based on alerting criteria, wherein said alerting criteria comprise one or more of time settings configured on said user device, a validation status of said decoded identifier code, and a validation status of said medical information contained in said decoded identifier code, and wherein said alert notifications are configured to one or more of remind said healthcare recipient to perform one or more actions to meet said wellness adherence criteria and warn said healthcare recipient of one or more of an invalid identifier code and invalid medical information.

11. The method of claim 1, further comprising dynamically analyzing said medical information with historical data and trends and predicting future medical information and planned actionable tasks and outcomes by said wellness adherence tracking system.

12. The method of claim 1, further comprising dynamically assessing health, wellness, and adherence requirements of said healthcare recipient and updating said wellness adherence criteria for an associated said medical implement by said wellness adherence tracking system.

13. The method of claim 1, wherein said medical information encoded in said identifier code comprises one or more of a number of medications in said medical implement, a list of said medications in said medical implement, drug names, directions to follow, color coding of dosage times, name of a prescriber, a date of preparation, a description of contents of said medical implement, a personalized website link configured to link to a secure online interface comprising healthcare recipient information, a healthcare recipient identifier, and any combination thereof.

14. The method of claim 1, further comprising:
transmitting alerts for capturing one or more images in one or more views of a medication organizer tray apparatus, on said graphical user interface at configurable time instants by said wellness adherence tracking system; and
verifying type, number, and arrangement of medications in medication bins of said medication organizer tray apparatus in accordance with said wellness adherence criteria prescribed by a healthcare provider using said captured one or more images by said wellness adherence tracking system for said tracking of said wellness adherence of said healthcare recipient in accordance with said wellness adherence criteria.

15. A wellness adherence tracking system for tracking wellness adherence of a healthcare recipient, said wellness adherence tracking system comprising:
a non-transitory computer readable storage medium configured to store computer program instructions defined by modules of said wellness adherence tracking system;
at least said one processor communicatively coupled to said non-transitory computer readable storage medium, said at least one processor configured to execute said defined computer program instructions;
said modules of said wellness adherence tracking system comprising:
a scanner configured to scan an identifier code positioned on a medical implement via a graphical user interface, said identifier code configured to identify said medical implement;
a decoder configured to decode and validate said scanned identifier code;
a data extraction module configured to obtain medical information associated with one or more of said medical implement and an activity associated with said medical implement from said decoded and validated identifier code, and wellness adherence criteria;
a data rendering module configured to render said medical information and a plurality of wellness adherence options on said graphical user interface;
a data reception module configured to receive inputs for one or more of said rendered wellness adherence options from said user device; and
a data logger configured to log said received inputs in association with said wellness adherence criteria in one or more of said user device and one or more databases to track said wellness adherence of said healthcare recipient.

16. The wellness adherence tracking system of claim 15, wherein said medical implement is one of a medication bin configured to store one or more medications, a parenteral device, a fitness device, a medical identification card, a medical wellness plan, and a medication organizer tray apparatus, and wherein said activity associated with said medical implement is one of administration of one or more medications, an exercise activity, a diet activity, wound care, and a health checkup.

17. The wellness adherence tracking system of claim 15, wherein said wellness adherence criteria comprise dosage information, a date for administering one or more medications, a time of day for administering said one or more medications, and directions to follow.

18. The wellness adherence tracking system of claim 15, wherein said data extraction module is configured to obtain said medical information and said wellness adherence criteria by performing one or more of:
directly extracting said medical information contained in said decoded and validated identifier code;
retrieving said medical information and said wellness adherence criteria from one or more databases via a network based on said decoded and validated identifier code; and
receiving said medical information and said wellness adherence criteria from said user device via said graphical user interface.

19. The wellness adherence tracking system of claim 15, wherein said wellness adherence options comprise indicators that define administration and non-administration of one or more medications, presence and absence of medications in said medical implement, performance and non-performance of said activity, a percentage of performance of said activity, an abortion of said activity, an establishment of communication with a prescriber of said activity, and time settings for said administration of said one or more medications and said performance of said activity within preconfigured time periods.

20. The wellness adherence tracking system of claim 15, wherein said identifier code comprises one or more authentication codes embedded therein for said validation with reference to authentication codes stored by said wellness adherence tracking system in said one or more of said user device and said one or more databases.

21. The wellness adherence tracking system of claim 15, wherein said modules of said wellness adherence tracking system further comprise an analytic engine configured to validate said medical information associated with said one or more of said medical implement and said activity associated with said medical implement, in communication with one or more of said user device and a backend server.

22. The wellness adherence tracking system of claim 15, wherein said data rendering module is further configured to configure said wellness adherence options in accordance with said wellness adherence criteria and user inputs.

23. The wellness adherence tracking system of claim 15, wherein said modules of said wellness adherence tracking system further comprise an alert notification module configured to transmit alert notifications on said graphical user interface based on alerting criteria, wherein said alerting criteria comprise one or more of time settings configured on said user device, a validation status of said decoded identifier code, and a validation status of said medical information contained in said decoded identifier code, and wherein said alert notifications are configured to one or more of remind said healthcare recipient to perform one or more actions to meet said wellness adherence criteria and warn said healthcare recipient of one or more of an invalid identifier code and invalid medical information.

24. The wellness adherence tracking system of claim 15, wherein said modules of said wellness adherence tracking system further comprise an analytic engine configured to dynamically analyze said medical information with historical data and trends and predict future medical information and planned actionable tasks and outcomes.

25. The wellness adherence tracking system of claim 15, wherein said modules of said wellness adherence tracking system further comprise an analytic engine configured to dynamically assess health, wellness, and adherence requirements of said healthcare recipient and update said wellness adherence criteria for an associated said medical implement.

26. The wellness adherence tracking system of claim 15, wherein said medical information encoded in said identifier code comprises one or more of a number of medications in said medical implement, a list of said medications in said medical implement, drug names, directions to follow, color coding of dosage times, name of a prescriber, a date of preparation, a description of contents of said medical implement, a personalized website link configured to link to a secure online interface comprising healthcare recipient information, a healthcare recipient identifier, and any combination thereof.

27. The wellness adherence tracking system of claim 15, wherein said modules of said wellness adherence tracking system further comprise:
an alert notification module configured to transmit alerts for capturing one or more images in one or more views of a medication organizer tray apparatus, on said graphical user interface at configurable time instants; and
an analytic engine configured to verify type, number, and arrangement of medications in medication bins of said medication organizer tray apparatus in accordance with said wellness adherence criteria prescribed by a healthcare provider using said captured one or more images for said tracking of said wellness adherence of said healthcare recipient in accordance with said wellness adherence criteria.

28. A computer program product comprising a non-transitory computer readable storage medium having embodied thereon, computer program codes comprising instructions executable by at least one processor for tracking wellness adherence of a healthcare recipient, said computer program codes comprising:
a first computer program code for scanning an identifier code of a medical implement via a graphical user interface, said identifier code configured to identify said medical implement;
a second computer program code for decoding and validating said scanned identifier code;
a third computer program code for obtaining medical information associated with one or more of said medical implement and an activity associated with said medical implement from said decoded and validated identifier code, and wellness adherence criteria;
a fourth computer program code for rendering said medical information and a plurality of wellness adherence options on said graphical user interface, wherein said wellness adherence options comprise indicators that define administration and non-administration of one or more medications, presence and absence of said medications in said medical implement, performance and non-performance of said activity, a percentage of performance of said activity, an abortion of said activity, an establishment of communication with a prescriber of said activity, and time settings for said administration of said one or more medications and said performance of said activity within preconfigured time periods, and wherein said wellness adherence options are configured in accordance with said wellness adherence criteria;
a fifth computer program code for receiving inputs for one or more of said rendered wellness adherence options from said user device; and
a sixth computer program code for logging said received inputs in association with said wellness adherence criteria in one or more of said user device and one or more databases to track said wellness adherence of said healthcare recipient.

29. The computer program product of claim 28, further comprising a seventh computer program code for transmitting alert notifications on said graphical user interface based on alerting criteria, wherein said alerting criteria comprise one or more of time settings configured on said user device, a validation status of said decoded identifier code, and a validation status of said medical information contained in said decoded identifier code, and wherein said alert notifications are configured to one or more of remind said healthcare recipient to perform one or more actions to meet said wellness adherence criteria and warn said healthcare recipient of one or more of an invalid identifier code and invalid medical information.

30. The computer program product of claim 28, further comprising an eighth computer program code for dynamically analyzing said medical information with historical data and trends and predicting future medical information and planned actionable tasks and outcomes.
